(19) United States
(12) Patent Application Publication
(10) Pub. No.: US 2010/0100546 A1
(43) Pub. Date: Apr. 22, 2010

(54) Context-aware semantic virtual community for communication, information and knowledge management

(76) Inventor: Steven Forrest Kohler, Suwanee, GA (US)

Correspondence Address: Steven F. Kohler, 880 Riverhaven Drive, Suwanee, GA, 30024, US

(21) Appl. No.: 12/322,899

(22) Filed: Feb. 8, 2009

Related U.S. Application Data
(60) Provisional application No. 61/027,257, filed on Feb. 8, 2008.

(51) Int. Cl. G06F 17/30

(52) U.S. Cl. 707/739; 707/E17.002

(57) ABSTRACT

A method for creation of a semantic information management environment, said method comprised of steps of: providing said semantic information environment consisting of an architecture partitioned according to the classification of the use of natural language by information scale, dynamical properties, or semantic classifications; detection, classification, and storage of semantic and contextual information detected and stored by recording of observed contextual parameters associated with events in said semantic information management environment; said interactions including the use of information management or electronic communication applications embedded or linked to said architecture, or separate from said architecture; said observations including the use of natural language as parameters that have specific semantic properties; detection, classification and storage of use of natural language in said semantic information environment; representation of semantic processes containing said detected, classified, and stored contextual information and natural language use in said semantic information environment; said representations of semantic processes used to link and associate natural language use with objects, entities, facts, communication, information, and digital files in said semantic information environment; providing said users of said semantic information environment with information and knowledge management tools, reports, representations, and interfaces that utilize said semantic process representations.

### CROSS REFERENCE TO RELATED APPLICATIONS

This application claims benefit of and priority to U.S. Provisional Application Ser. No. 61/027,257, filed on Feb. 8, 2008, which is fully incorporated herein by reference and made a part hereof.

### BRIEF SUMMARY OF THE INVENTION

Embodiments according to the present invention relate to systems and methods which form a semantic virtual community, which integrates contextual information management with contextual information retrieval, for use by a plurality of persons, also referred to as users, for electronic communication and information management.

One embodiment according to the present invention's major components are integrated hierarchically to form a unitary system that provides a communications and information management environment that automatically detects and classifies consistent context descriptions for all user's communication tasks and information management activities within the system. As users perform communication tasks and information management tasks, a Context-Indexer automatically builds a context-record for each task and stores the context-record in the context-indexes. Each context-record consists of a group of explicit classifier-words, which; 1) provide a description of the context of each user's information management task, 2) have meaning common to both the system and to the users, and 3) link to the description of the user to the description of the activity of the user the information-record(s) involved in the task. The Context-Indexer provides data records that can form a semantic process network and lattice that links semantic links to all information, including communications, within the system. The largest proportion of context-records are generated by user communications created in the one embodiment according to the present invention's iBox communication component. The context-records resulting from user's communication activities and tasks exhibit dynamical systems properties and characteristics. By applying non-linear dynamical analysis, probabilistic and statistic analysis, and semantic analysis to this embodiment of the present inventorion's context-indexes, information-records can be retrieved according to linked context-records and explored in several ways that are cognitively relevant to the users. In one instance, multifaceted search component can search the context-indexes for a user's query that combines classifier-words of persons, places, time ranges, subjects, and information-records. As the search component finds matching, as well as closely associated, context-records, the information-records linked to the matching context-records are presented. In another instance, the context-indexes can generate topographic semantic spaces that the user can use to visuospatially explore information-records based on several information dimensions. Additional components can show task and process pathways, and meta information about the users and the virtual community's information, and build semantic maps and ontologies for the virtual community.

In another embodiment of the present invention, records of electronic communication and information exchanged between a plurality of persons can be imported into the semantic virtual community environment for the purpose of organizing such electronic communication and information into contextually linked and indexed electronic communication and information that can be used for analysis and reporting.

### TITLE OF THE INVENTION

The invention is a context-aware semantic virtual community which performs natural language processing and semantic classification. The invention can operate on networked computers or non-networked computers. By automatically capturing and parametizing contextual and semantic processes from electronic communication and information records, the invention provides contextual information management and contextual information retrieval and knowledge management. The invention also provides contextually grounded multidimensional knowledge representations and user interfaces.

### ABSTRACT OF THE DISCLOSURE

The present invention relates to systems and methods which form a semantic virtual community that integrates semantic, natural language computing methods with web based personal and organizational information management. The invention's major components are ordered hierarchically to form a system that autonomously observes and parameterizes dynamical natural language processes, including dynamic context, and uses context-metadata stored in context-indexes to form associative links between all entities, activities and information in the semantic virtual community. Furthermore, user's electronic communications can exhibit nonlinear dynamic properties. Using complex, probabilistic and semantic analysis, the context-indexes and related linked data form a contextual knowledgebase so that 1) information-records can be searched and explored associatively using linked context-records and data, 2) associative semantic patterns and pathways can be determined and analyzed to create grounded ontologies and other representations, and 3) semantic, associative, cognitively aligned user multidimensional interfaces can be provided using detected temporal and spatial semantic properties.

### BACKGROUND OF THE INVENTION

In the last decades, significant advances in information processing and management, information exchange, and electronic communication have resulted from progress in the current art of personal and business computing software applications and the widespread adoption of the internet. However, many of today's popular software applications are designed as tools for individuals to create specific documents (i.e. document-centric) or accomplish specific tasks, such as electronic messaging or creating electronic spreadsheets on their own personal computers (hereafter PC's). These “PC Era” software applications were designed primarily to perform discrete tasks and create and manage electronic documents. Such PC Era application are not designed for contextual communication and information management needed by today's users and organizations. Today's networked information environment is dynamic and complex and requires software applications and information management tools that support more effective information sharing and search (e.g. retrieval) capabilities than typical non-contextual communication and information management software can provide currently.

The following discussion in pars. [0005-0027] reviews the present environment of users and organizations that depend on managing dynamic information as well as some of the deficiencies of current popular software applications and information management methods used to manage dynamic information management, sharing, and retrieval requirements. An “organization” in this discussion can be for-profit businesses, nonprofit businesses, schools, emergency aid groups, or other groups of people working together to perform a series of tasks and goals. Today, organizational and individual inefficiencies result from unmet organizational information management needs. Estimates of these costs are discussed in pars. [0028-0031]. Possible solutions to the unmet needs of organizational information management may be contextual and semantically capable systems that structure and link information in new ways. Such semantically enabled systems may improve information organization, sharing, and retrieval for individuals and their organizations, and such system are an expected possible next step in the evolution of organizational information management systems. Such contextual and semantic systems are introduced in pars. [0031-0036].

Organizations are increasingly virtual and physically distributed because of technology and globalization. These “virtual organizations” employ “knowledge workers” who organize into formal and informal networks, or groups, (hereafter “virtual groups”) to perform intra-organizational and inter-organizational communication information sharing activities and tasks. The knowledge workforce is the fastest growing employment category in developed nations, and their organizational information management needs are beyond the capabilities of most traditional personal computing systems and most enterprise computing systems.

Specifically, knowledge workers need information management applications that assist them with communication, creating information, sharing information, and information retrieval for virtual groups and virtual organizations are needed to improve communication and information management compared with today's popular PC applications as well as more sophisticated natural language processing systems. Aberer supports of this perspective in from Emergent Semantics Principles and Issues (2004): “Nowadays, all major economic players have decentralized organizational structures, with multiple units [virtual groups] acting in parallel and with significant autonomy.[ . . . ] Grasping relevant information wherever it may be and exchanging information with all potential partners has become an essential challenge for enterprise survival. Shortly stated, information sharing, rather than information processing, is IT's primary goal in the 21st century.” [Aberer, 2004:1]

But currently available virtual group or virtual organization applications that improve information sharing have not been adopted by knowledge workers in significant numbers. The software tools knowledge workers commonly use are personal computing applications designed in the PC Era: the 1980's and early 1990's. A useful descriptive computer technology time line is shown in Appendix A “From PC's to Networked Computing” by Nova Spivak.

As an example, knowledge workers commonly use personal email software applications with attached files (that also are created using PC Era tools, spreadsheets, word processors, office suites, etc.) as a principal way to communicate and share information between themselves and between organizations.

Evidence suggests that using many PC Era applications can have adverse effects on knowledge workers and their organizations because these applications are not designed for today's networked environment which requires shared, secure information. For example many typical PC Era email applications are regularly vulnerable to security exploitation. And the consequences of email security vulnerabilities are experienced frequently by many knowledge workers. Surveys show that people using mostly PC Era email applications exchanged six trillion email messages in 2006 [Musgrove, 2007:56]. Many of these emails had file attachments, many emails were unwanted spam, and approximately one in 600 emails contained a potentially destructive virus. See Appendix B.

Management of potentially destructive email may be only one of many knowledge workers' responsibilities. But knowledge workers have little control over the email they receive, and they usually lack expertise in IT security and mitigation. As a result of these practices, communication security for email messages sent from PC email applications is a potential threat to both the knowledge worker's and the organization's information and operations.

Further, the common practice of using PC Era email programs to exchange information using email messages and attached files is not secure or efficient. Knowledge worker's emails with attached file(s) result in a large increase in the number of files exchanged and transferred over corporate data networks and the internet. Each time an email with an attachment is sent, a new copy of the email and the file are created on each recipient knowledge worker's computer. A consequence is that internet and organizational network bandwidth is consumed each time a file each time a file is exchanged as an attachment. These duplicated messages and files must be reconciled and synchronized by the knowledge worker so that the knowledge worker can determine meaningful organizational information from the email messages and from the attached file(s).

Many PC Era applications can create additional barriers to information sharing because these applications save data in proprietary file formats. Using a word processing document as an example, even well-known commercial programs from a single software company, and with the same product name, may save files that are incompatible with each other. These files may not open or save consistently and predictably. The result is that critical information can be garbled or even completely lost in exchange and format conversion. The possible troubling result of this type of widespread file incompatibility and information loss is described by Microsoft's UK Managing Director Gordon Frazer in July 2007 as a potentially imminent “Digital Dark Age” [BBC News, 2007:3]. See Appendix C, p. 1.

Because PC Era applications are architecturally separated into applications that are limited to perform specific tasks such as the production of documents or email. Many people describe these applications as “tools.” Consequently, Knowledge workers may have to use several tools to accomplish a single information task which may involve several types of documents and several email messages. These tools do not provide a consistent way to integrate communication and information into a searchable and analyzable knowledgebase.

The use of several tools to complete an entire information task is typically referred to as “multi-tasking.” Multi-tasking describes the concurrent use of several applications, or quickly switching between tools by knowledge workers. Multi-tasking also includes the knowledge worker's changes of cognitive “focus” as they move their attention from one software application to another.

Some studies show that the average knowledge worker is working well beyond their own productive level of multi-tasking cognitive capabilities. They are over-tasked and they are “cognitively overloaded.” (See “Cognitive Load Theory” in the definitions.) A similar related condition is known as “information overload.” When referring to email management, a similar condition is known as “email overload.” See Appendix D.

In many cases the knowledge worker's information overload also can affect the organization's IT department. The organization's IT departments can become similarly “overloaded” because the IT department may help manage the knowledge worker's duplication of PC files, file incompatibilities, disk storage, and computing capabilities needed to manage each knowledge worker's information overload. By some estimates, a typical organization's file and message storage requirements resulting from duplicated email and file attachments is about 100 times the actual space required for the same messages and files if they were centrally organized and stored.

In an attempt to move beyond PC Era applications, newer interne based Web 2.0 applications are available from computer software and services providers such as Google (e.g. Google Docs web applications). These applications do in fact help create, centralize and synchronize electronic communication and information so information can be shared more effectively. But knowledge workers and organizations have not adopted these new web based applications in significant numbers. Relatively low adoption rates of these new Web 2.0 applications by knowledge workers may be because these new Web 2.0 applications are generally designed using similar document oriented tool architecture and features of PC Era applications. Many of these new Web 2.0 applications are stand-alone and unintegrated, and require the same multi-tasking from knowledge workers as PC Era applications.

In one embodiment according to the present invention the organization's total collection of shared electronic communication and information is defined as “information inventory” regardless of the computer or media it is stored on, and whether or not is electronic communication, electronic documents or other digital records.

Today each knowledge worker may individually control a critical portion of their organization's information inventory stored in their own PC. As an analogy, if the organization's information were composed of physical items, like an inventory of consumer products for sale, each worker would in effect control a portion of the organization's inventory in their own office. Also by analogy, a physical inventory and its locations customarily are tracked and organized by an inventory control system of some kind. But organizations lack such systems to help track and catalog the locations of the organization's information inventory. Consequently the knowledge worker's and organization's information may be difficult to locate, organize and use effectively because it is distributed and fragmented in many knowledge worker's computers, and there may be no central catalog system or method to organize the information inventory and its locations. For more information see Appendix E.

Some studies show that as much as 80% of an organization's information assets, or information inventory, are contained in electronic PC Era communications and PC Era documents, and not in enterprise systems. So in addition to improved information sharing, many knowledge workers and their organizations also need improved “information search” (hereafter more formally “information retrieval” or “IR”). Unfortunately many of the PC Era applications used by knowledge workers are not well designed to organize and store information for coherent, cognitively aligned, and organizational level information retrieval, and more powerful information retrieval capabilities are needed for efficient access of the organization's information inventory. Cognitive alignment, as referred to herein, concerns the extent that community members' understandings of the state of the information in the community and the state of the community are consistent.

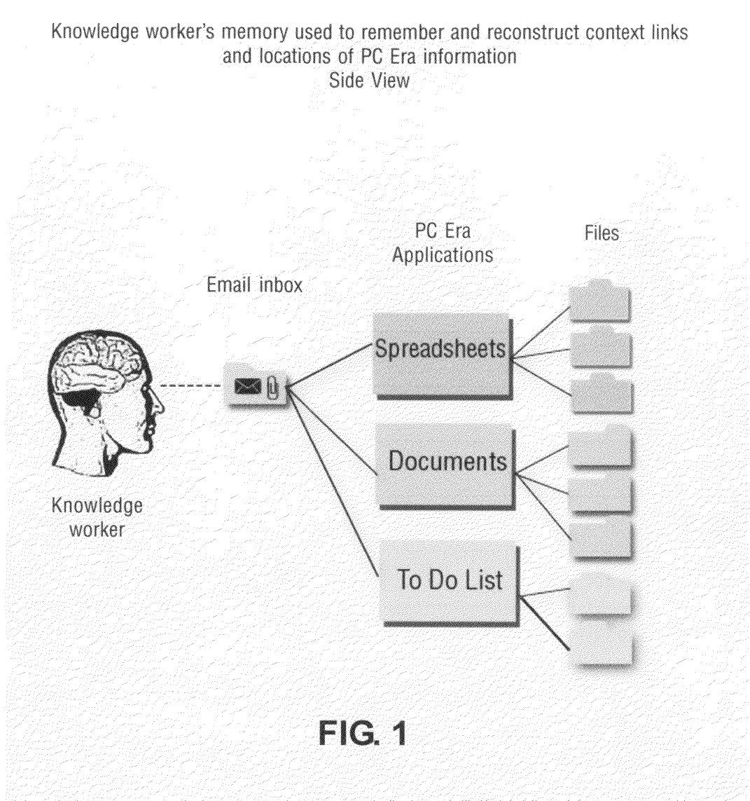

In this computing environment, individual knowledge workers commonly use their own memory to remember locations of information on their own PC. This practice can create an obstacle for information retrieval for other knowledge workers because locations of critical information may only be known by one or a few individuals. Also, using a knowledge worker's own memory to recall locations of information in a computer is an inefficient use of the knowledge worker's cognitive capacity and contributes to the knowledge worker's information overload. See FIG. 1.

Some studies show that common information search techniques used by knowledge workers to locate information such as documents and email messages often produce less than optimal results. Even though knowledge workers are considered adept at finding information on their own computers, studies show that finding information that is filed into folder systems on PC's only has a success rate of about 50%, and finding information by keyword search on PC's only has a success rate of about 70%.

Many organizations also lack consistent information deleting policies, so either a worker does not delete enough information or a worker may delete important information by mistake. The result is that information search and retrieval is potentially handicapped by useless information co-mingled with relevant information, which results in wasted effort by knowledge workers searching for information that may already be deleted.

As a practice, using PC Era information management applications to produce and store organizational level information can pose potential risks to the retrievability of an organization's valuable information inventory. Consequently improving organizational information retrieval is commonly a high priority, but an elusive goal, in most organizations. See Appendix F for recent comments from a well known technology journalist who writes that current software does not provide solutions to this important problem.

A common notion in the computer science research community is that the “context” of the organization's information could be used to organize, structure, store, and retrieve information more effectively than the current state of the art. The meaning of context is varied has several different connotations. However, more precise definitions of context and how context is used in embodiments according to the present invention are discussed in pars. [0159-0161].

At present software applications used by knowledge workers provide little practical support for context management. Many current filing systems do not organize information by context, or associate information semantically with words that are familiar to the knowledge worker. In fact, many current filing systems may remove or separate context from communication and documents, making information even harder to find. From researcher Indratmo: “Filing documents removes some contextual information of the documents. For example, saving an email attachment in a file folder removes the contextual information [ . . . ].” [Indratmo, 2005:30]

There are both direct and indirect costs caused by information disorganization and information overload that may be substantial to both knowledge workers and to their organizations.

The direct cost of managing information overload is significant, and continues to rise. Some estimates are that the average knowledge worker spends 28% of their working day managing their email. In the U.S. alone, if this time could be recovered, at an average wage of $21 per hour, it would represent a savings of $588 billion per year. And this lost time is increasing every month [Douglas, 2007:14]. These costs adversely affects many information dependent industries, organizations, and professions. For example, the U.S. National Institute for Science (“NIST”) reports that information overload has a negative effect on efficiencies in the legal profession, engineering profession, the medical profession, and government services.

Also, according to Microsoft Corporation the average knowledge worker performs twenty searches per day and spends an average of 9.5 hours per week searching for information. See Appendix G.

Another cost of information overload is attributed to lowered organizational productivity because of the negative cognitive effects of information overload on knowledge workers. According to Knight: “The relentless influx of emails, cellphone calls and instant messages received by modern workers can reduce their IQ by more than smoking marijuana, suggests UK research. [ . . . ] Wilson adds that working amid a barrage of incoming information can reduce a person's ability to focus as much as losing a night's sleep.” [Knight, 2005:35]

Further, in Kirsh's “A Few Thoughts on Cognitive Overload,” he describes the negative emotional effects of cognitive overload as a result of the knowledge worker's environment, which he refers to as a “workspace.” Kirsch writes: “The upshot is a workspace of increased complexity, saturated with multi-tasking, interruption, and profound information overload. The effect of this cognitive overload at a social level is tension with colleagues, loss of job satisfaction, and strained personal relationships. (IFTF/Gallup study of Fortune 1000 workers. 1997)” [Kirsh, 2001:34]

Some researchers have written that recently developed World Wide Web technologies have promise to reduce knowledge worker information overload, improve organizational information management, and systematize storage of an organization's information. In the past few years, a type of web site described as a “social networking site,” or simply a “social network” has been widely adopted in personal computing and for consumers. These web sites are used by people with similar interests to collaborate and perform tasks together. (Using “social network” to describe a web site is an informal use of that term. In this document these types of web sites are referred to as “virtual communities.”)

At present millions users of popular virtual communities communicate and centrally share files, videos, and information. Examples are YouTube.com for sharing video files, MySpace.com for sharing personal interests, and Wikipedia.com, which is a web based encyclopedia created by a virtual community. Even though these virtual communities are not designed for business purposes, they show that large scale, deep collaboration between large diverse populations of users is both possible and self-organizing using virtual community web systems.

There are differences between a consumer virtual community and a virtual community designed for organizations with specific goals which may be time sensitive and complicated. One major difference is information retrieval capabilities. Virtual communities designed for organizations usually lack fast, accurate, and sophisticated information retrieval capabilities. Current common technologies such as keyword search and page ranking do not consistently provide information retrieval that makes semantic sense, or is cognitively aligned with the way that knowledge workers remember and recall information. However, new techniques using natural language processing and semantics are being explored to improve information retrieval and to improve alignment with the knowledge worker's cognitive processes.

Sir Tim Berners-Lee, popularly credited as the inventor of the world wide web, is a proponent of a way to link information referred to as the “Semantic Web.” The Semantic Web is “an extension to the current web in which information is given well-defined meaning, better enabling computers and people to work in cooperation.” [Berners-Lee, et al., 2001:87] For the purposes of this discussion, the Semantic Web uses words and defined word meanings, understood by users, to associate and connect information stored in computer systems. The goal is that these words would have the “same” meaning (i.e. semantic meaning) to the computer and the user. Therefore information could be semantically linked and indexed, and users could retrieve and explore information by semantic association and natural language queries. These semantic search techniques are viewed by many researchers as an improvement over current common search techniques.

A virtual community system designed to integrate electronic communication and information management, which semantically organizes all of the entities, activities, and information of the virtual community may moderate current problems of organization information sharing and retrieval.

However, even though virtual communities show promise in providing significant improvements in information sharing and application integration, present virtual communities do not yet provide contextual, cognitively aligned, organizational level information semantic search and retrieval and knowledge representation capabilities.

To provide semantic organizational level semantic search and information retrieval, in current art, “semantic links,” or word associations and meanings, are usually required to link information and create a semantic web. “Word association” is defined as the dictionary definition of “stimulation of an associative pattern by a word” in one embodiment according to the present invention.

Semantic links are commonly organized into a data file named an “ontology.”

An ontology file contains descriptions of relationships between words and their meanings with respect to an information collection, in many cases, a collection of documents. Ontologies can be created using many methods, and these methods are typically referred to as “annotation.” Current annotation methods present challenges for widespread adoption and practical use by businesses and organizations, so improved annotation methods are a popular topic of research surrounding the Semantic Web at this time.

One annotation method, referred to in this document as formal annotation, is usually performed by persons who are domain experts who organize and create a formal ontology file. To create a formal ontology file, domain experts analyze large groups of documents and the terms used in a group of documents. The domain experts “annotate” the documents by placing word relationships and meanings into an ontology file. These ontology files are usually in a standard ontology file format. The standard ontology file formats are commonly known by acronyms such as “RDF,” or “OWL,” or a variant of one of these formats. This approach is limited practically in many knowledge domains because word relationships and meanings change frequently. So a domain expert (or experts) may be challenged to maintain a dynamic and accurate ontology using this formal and somewhat manual process.

There are other informal methods to semantically annotate information or a group of documents with a word or a set of words called a “tag” or “tags.” The “tag” may be used to reference and associate the information for retrieval at a later time. Ontologies based on “tags” are described popularly as “folksonomies.” Folksonomies may be too flexible to produce consistent annotation because folksonomies directly reflect individual language variability. According to Indratamo “ . . . the probability of two persons choosing the same word to describe the same concept is less than 0.20[20% probability]. In other words, it is unlikely that people will use the same vocabulary to describe the same things” [Indratmo, 2005:30]. Therefore both these formal and the informal annotation methods may be too inefficient or too inconsistent for creating and maintaining ontologies and semantic links that would be effective for many organizations.

At present there is not an accepted standard method or process to automatically annotate and create semantic links for a body of information. The problem of creating and maintaining the ontologies required to semantically link information is described popularly as the semantic web “bootstrapping” problem. The difficulty of overcoming this problem using current art is described by a Yahoo! researcher in May 2007. See Appendix I.

In academic research in late 2006, the notion of combining a virtual community system with semantic web capabilities was proposed as a promising new approach to organizational level information management and retrieval. In the research, such a system is typically classified as a “Semantic Social Network” (“SSN”). However, the semantic “bootstrapping” problem is commonly considered an outstanding challenge to overcome before such a system can be built and used successfully. According to Reeve: “Semantic Social Networks (“SSN”) [Semantic Virtual Communities] merge the Semantic Web with [virtual communities] so that resources and people related to the resources are linked together (Downes, 2004).[ . . . ] An ongoing problem with any content creation on the Semantic Web is the semantic annotation [or tagging] of information of the new content.” [Reeve, 2006:67]

One embodiment according to the present invention is comprised of a particularly ordered hierarchical component architecture and specific executing programs designed to produce a Semantic Social Network, which hereafter is referred to as a “semantic virtual community.” One embodiment according to the present invention is implemented with this particularly ordered hierarchical architecture to facilitate detection of the natural dynamical complexity of interactions of knowledge worders (users) and context within the semantic virtual community. One embodiment according to the present invention automatically store semantic and extralingual contexts of the semantic virtual community. This semantic and extralingual context is used to link all entities, activities, and information into coherent semantic abstract structures using word associations and several forms of analysis. By detecting complex and dynamic contextual characteristics of language used by knowledge workers in the semantic virtual community, techniques for analyzing self-organizing and emergent systems are employed to automatically build semantic links, without any additional user intervention. In one embodiment according to the present invention, this process of detecting and storing context information is defined as “automatic annotation.” Automatic annotation overcomes the “bootstrapping” problem described in par. [0040]. Compared with current art, use of such a semantic virtual community by knowledge workers for organizational information management may provide improved organizational information sharing, search, retrieval, knowledge representation and analysis.

### BRIEF SUMMARY OF THE INVENTION

In the following detailed description of embodiments according to the present invention, reference is made to the accompanying drawings and figures, which form a part hereof, and within which are shown by way of illustration specific embodiments by which the invention may be practiced. It is to be understood that other embodiments may be utilized and structural changes may be made without departing from the scope according to the present invention.

One embodiment according to the present invention is an internet based software system that forms a Semantic Virtual Community system (hereafter “semantic virtual community”) for use by a plurality of knowledge workers and a plurality of organizations.

In one embodiment according to the present invention the semantic virtual community web site is located on one or more computer servers comprised of a at least one processor, computer memory, and data storage device either connected to the world wide web or not connected to the worldwide web.

One purpose of one embodiment according to the present invention is to provide knowledge workers and their organizations with improved communication management, information management, and knowledge management through the use of contextual, semantic, and natural language processing based information management techniques and methods.

In order to provide contextual, semantic, and natural language processing techniques, one embodiment according to the present invention continually builds information structures which contains direct representations of the process, frequency, dynamical patterns, and history of the use of words and symbols by the knowledge workers within the domain of the semantic virtual community.

The natural process based approach to determine word and symbol semantics patterns which is used for semantic analysis in one embodiment according to the present invention contrasts with current art, in which word and symbol patterns are usually derived statistically from static documents. Because current art does not directly measure the processes and histories (i.e. the dynamics) of word and symbol use, current art may not detect important characteristics in the patterns of word use within a community of users (such as the knowledge workers in one embodiment according to the present invention).

The natural process approach used in one embodiment according to the present invention is sometimes referred to as a “biological” approach. The biological approach potentially gathers more information about the use and the semantics of words than a document based approach. In document based approaches, words are captured and related as static strings of letters on a page, without the breadth of measurements that a dynamic, natural process based system and method can provide.

One embodiment according to the present invention is architecturally and functionally designed to autonomously detect and store the processes and histories of word and symbol use in order to improve semantic analysis and access to collective information and knowledge within the semantic virtual community. The program design and mechanisms used to accomplish this task are described in the balance of this document.

Furthermore, data structures, program components, and the overall design of one embodiment according to the present invention uses hierarchies, layers, scale, emergent properties, and self-organization to provide an information system that is designed for information processes, in contrast to current art which commonly used for document centric analysis with little or no association to the natural processes used to create electronic communication and information.

In one embodiment according to the present invention, the semantic virtual community contains four upper level classifications of data: 1) entities, 2) activities, 3) information, and 4) knowledge. Each of these classifications is considered information that belongs to its own “information scale” in one embodiment according to the present invention. Entities are physical things such as knowledge workers, computers, organization offices, and information management software. Activities are events that occur, or happen, in time. And examples of information are electronic messages, electronic documents, spreadsheets, and digital images, etc. Knowledge is defined as linked and organized information that can be accessed by knowledge workers in cognitively relevant ways.

Each classification of data is managed by a specific hierarchical program main component in the functional architecture of one embodiment according to the present invention. These components are listed in hierarchical order starting at the lowest or base level of the hierarchy: iControl for managing entities, iBox for managing electronic communication and user activities, iFolio for managing information, and iFind for managing knowledgebase analysis, information retrieval, and representations. Each of these main components is located in at its own component level in the main component hierarchy of one embodiment according to the present invention.

Therefore, a principal aspect of the hierarchical architecture of one embodiment according to the present invention is that each component level manages data at a specific information scale.

In one embodiment according to the present invention, these four main components are linked together by subcomponents of the main components in a way to automatically detect and store the dynamical contexts that occur within the semantic virtual community. The main subcomponent that detects and stores context information is named the “Context-Indexer” in one embodiment according to the present invention. The “Context-Indexer” is a subcomponent of the first main component, iControl. The Context-Indexer is integrated into the other component levels so that it can detect and store context information from each information scale that is involved with a knowledge worker interaction with the semantic virtual community.

The context information detected and stored by the Context-Indexer is referred to as “context-metadata” in one embodiment according to the present invention. Knowledge worker interactions with the semantic virtual community are referred to as knowledge worker “activities.” For each information-activity performed by a knowledge worker, the Context-Indexer detects and sequentially adds a context-record to the context-indexes according to the Context-Model of one embodiment according to the present invention.

The context-metadata detected and added to the context-indexes is composed of words and facts that describe direct observations of each of the knowledge worker's activities in the semantic virtual community system according to the Context-Model in one embodiment according to the present invention. These descriptions are composed of named entities and factual information about conditions surrounding each activity.

These named entities are entered into the semantic virtual community and given meaning (semantic descriptions) by the knowledge workers themselves as they are performing activities. The context-indexes are built automatically without any direct action required by the knowledge workers, and therefore provide automatic annotation in one embodiment according to the present invention. These named entities are automatically grounded (for a definition of grounding see par. 0059) and have a defined semantics that are specific to the knowledge workers and specific to the domain of the semantic virtual community.

Because the process of building the context-indexes is automatic and continual, the semantic virtual community gnity can be said to be “context-aware” in one embodiment according to the present invention. Also, the context-indexes are composed of context-records which contain semantically defined and grounded words, and automatically incorporate semantic associations and temporal dynamics as they are built by the Context-Indexer in one embodiment according to the present invention.

The Context-Indexer uses context-metadata from the different information scales in order to link and associate words and concepts into grounded relationships. Semantic grounding is described by Jakulin and Mladenic: “The notion of grounding is an old question, which has been elaborated in the context of artificial intelligence by S. Harnad [1], but the concepts have been around in philosophy already in the times of C. S. Peirce [3]. The fundamental notion is that the higher-level abstract concepts are grounded in lower-level concrete concepts, which, in turn, are grounded in perceptions.” [Jakulin and Mladenic, 2005: 95]

The context-indexes can form type of explicit, grounded multidimensional semantic network in one embodiment according to the present invention. The semantic network connects named entities, perceived and entered by the knowledge workers, and facts, with higher-level abstracted information such as electronic messages and electronic documents in one embodiment according to the present invention.

The context-metadata detected and stored for electronic messages sent between knowledge workers can exhibit dynamical properties of nonlinear systems. Similar properties can be found in many natural communication systems. These dynamical properties can be measured in one embodiment according to the present invention and used to determine otherwise hidden semantic and organizational relationships within the semantic network.

This contextual semantic network can be used as a foundation to automatically and dynamically link all data that describes entities, activities, information in the semantic virtual community into a “contextual knowledgebase” in one embodiment according to the present invention. The contextual knowledgebase can then be used by subcomponents of iFind for contextual semantic information retrieval, visuospatial knowledge representations, building ontologies, and producing and maintaining an organizational memory.

The automatically linked contextual knowledgebase and the iFind subcomponent tools reduces or eliminates the need for knowledge workers to organize electronic documents and email messages for search and retrieval since they are automatically linked and associated in one embodiment according to the present invention.

The semantically grounded, explicit semantic network, which incorporates dynamical properties of context and semantics of the semantic virtual community can also be used to build rational, cognitively aligned 3D conceptual knowledge representations in one embodiment according to the present invention. Furthermore complex system and physics based semantic and artificial intelligence techniques may be used to create more natural knowledge terrain maps, natural language user interfaces such as talking heads, speech driven natural language interfaces, and other anthropomorphic representations and user interfaces.

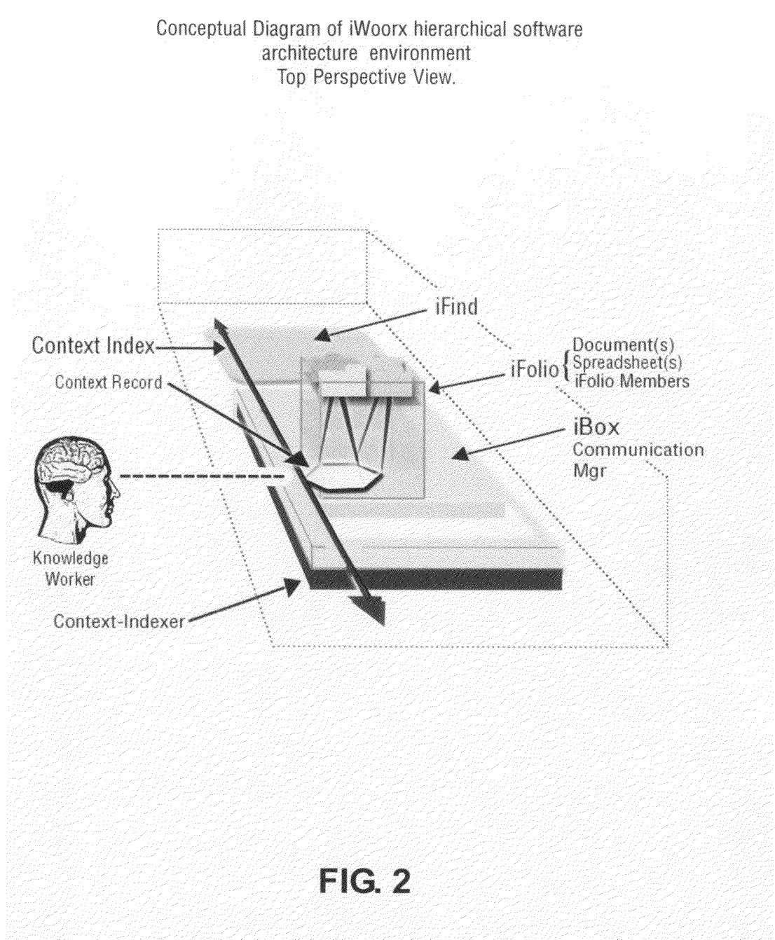

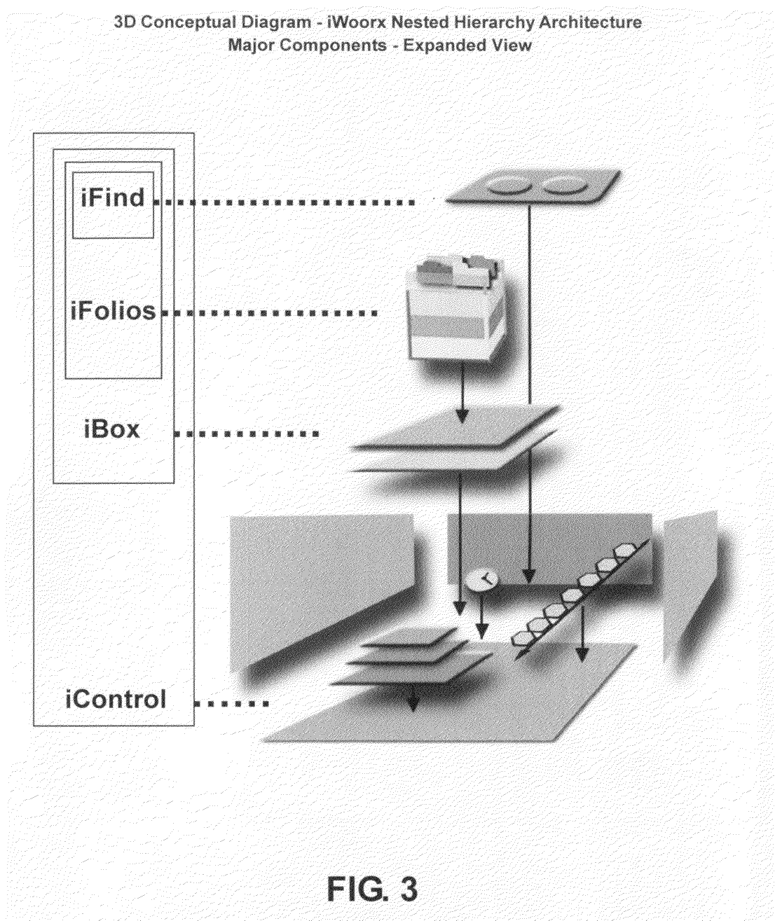

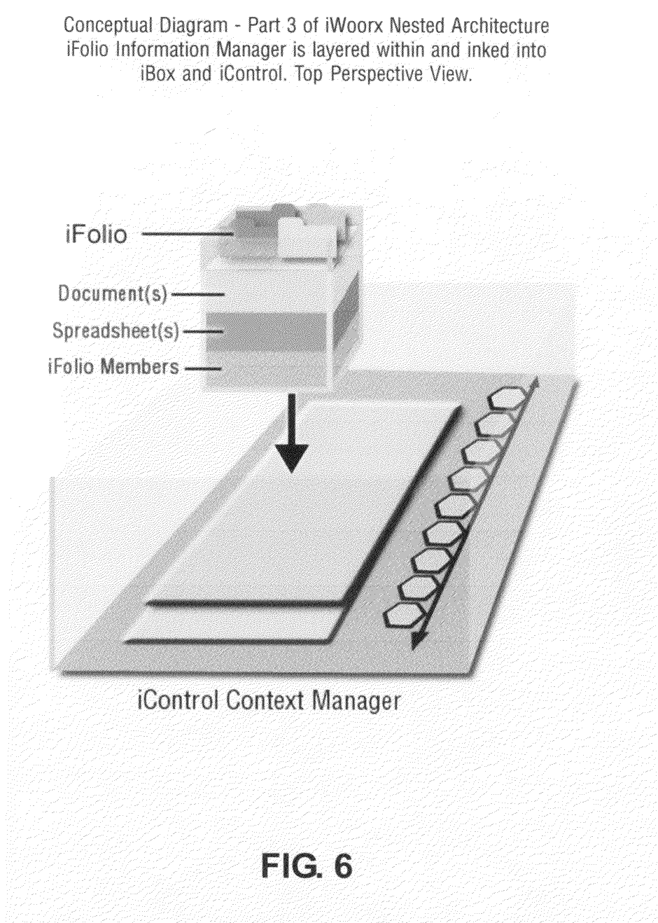

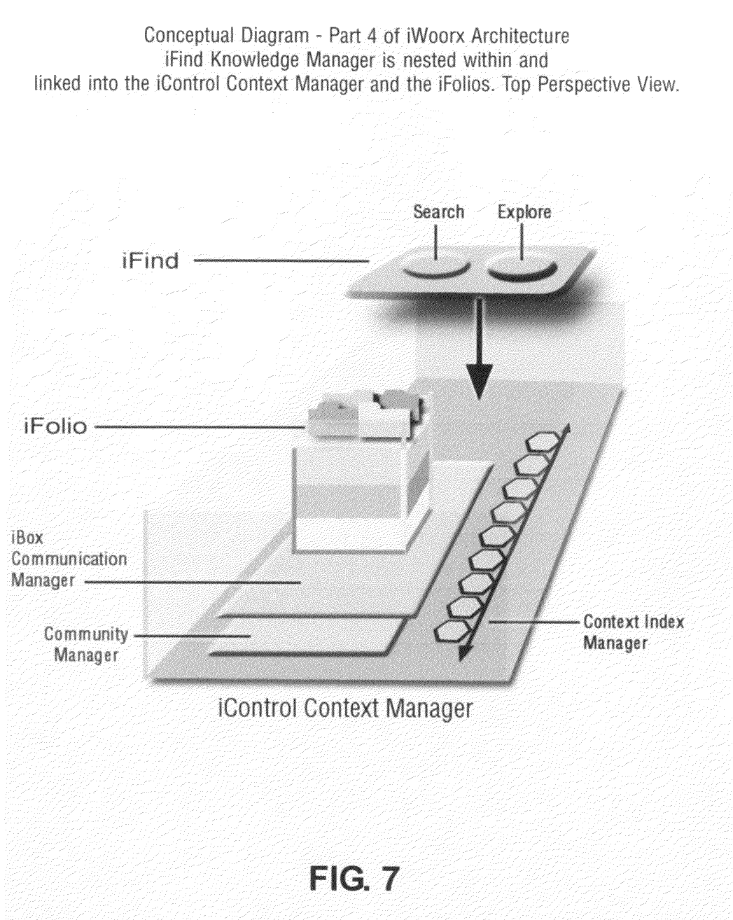

The following detailed description of one embodiment according to the present invention includes descriptions of the four main component levels, as well as their principal subcomponents for one embodiment according to the present invention. The first functional component level is named “iControl Context Manager” (hereafter “iControl”—see pars. [0075-0122, 0156-0200]). The second functional component level is named “iBox Communication Manager” (hereafter “iBox”—see pars. [0139-0155]). The third functional component level is named “iFolio Information Manager.” (hereafter “iFolio”—see pars. [0140-0155]). An “iFolio” is an organized collection of information-records, related electronic messages, information-artifacts, and other information relevant to a specific topic of interest to the knowledge workers. The fourth functional component level is named the “iFind Knowledge Manager” (hereafter “iFind”—see pars. [0200-0335]). See FIGS. 2, 3, 4, 5, 6 and 7.

### DETAILED DESCRIPTION OF THE INVENTION

A description of the hierarchical conceptual architecture of the main component levels in one embodiment according to the present invention follows in pars. [0070-0074].

All four main functional component levels in one embodiment according to the present invention each contain information, and the component levels are designed so that the information each level manages is of different character and relationship to information managed by the other functional component levels. The partition of information contained in the functional component levels is defined herein as information at different information scales. In one embodiment according to the present invention, different component levels contain and manage different information scales. Context, semantic rules, and context-metadata may vary based on the information scale in one embodiment according to the present invention.

In one embodiment of the current invention, the information is classified in this order: entities, activities, information and knowledge. Each of these information classes is information at a different information scale, starting from concrete entities and progressing through information involved in communication, and finally to abstract information contained in electronic documents other electronic records and knowledge representations

One embodiment according to the present invention uses different methods to detect and store context-metadata for each component level according to the differing attributes of the data in each information scale. Because one embodiment according to the present invention uses different processes and techniques to analyze context-metadata at each information scale, contextual and semantic properties can be uncovered which may otherwise may be hidden. One embodiment according to the present invention can provide additional insight into the context and semantics of the semantic virtual community by using rules according to the Context-Model. The Context Model provide rules for automatic annotation by the Context-Indexer which are appropriate for each type of context-metadata for each information scale.

In one embodiment according to the present invention, the main functional component levels which correspond to the information classifications already described in par. [0071] are: the first component level) iControl, which manages the information scale that includes all entities and all types of data about entities that comprise knowledge workers, the semantic virtual community as well as community context-metadata; the second component level, iBox, which manages information sharing and communication activities such as electronic message, and communication context-metadata; the third component level, iFolio, which manages the information scale that includes information and information context-metadata; and the fourth component level, iFind, which manages the information scale that includes knowledge linked and represented in cognitively relevant ways, as well as provides knowledge context-metadata.

One embodiment according to the present invention's hierarchical component level architecture also provides knowledge workers with a choice of four separate but integrated paths that lead to all entities, activities, information, and knowledge within the semantic virtual community. The knowledge worker can perform their activities without switching from one embodiment according to the present invention's integrated, hierarchical functional environment. Consequently, by use of one embodiment according to the present invention, multi-tasking and information overload may be reduced for the knowledge worker compared with use of separate PC Era applications used to perform similar tasks.

iControl Context Manager Component

A description of iControl Context Manager main component level and its subcomponents in one embodiment according to the present invention follows in pars. [0076-0122].

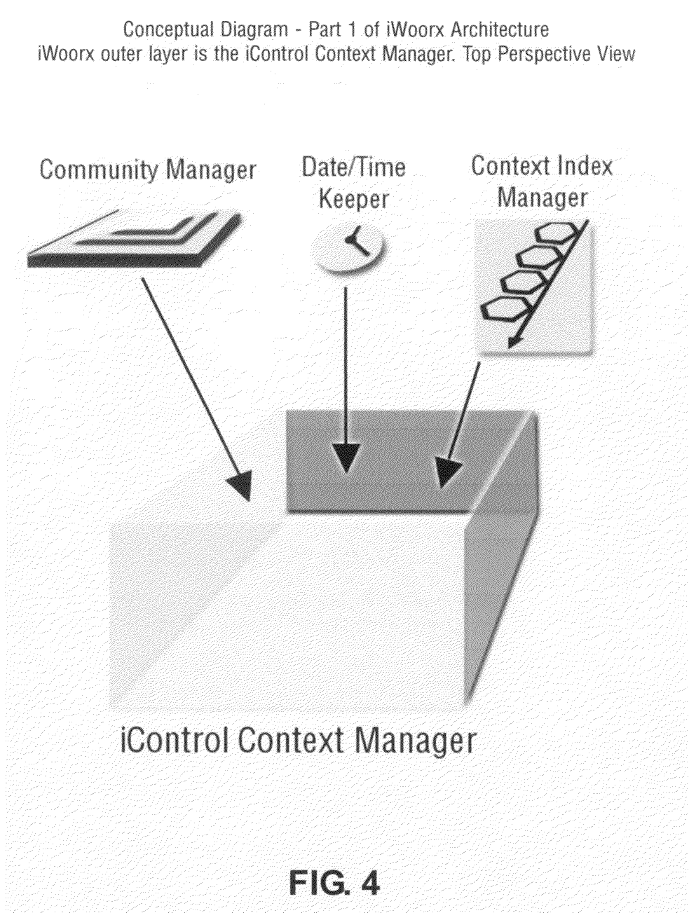

In the following description of one embodiment according to the present invention, the first component level in the conceptual architecture is named the “iControl Context Manager.” iControl has three major subcomponents in one embodiment according to the present invention. The first subcomponent is the “Community Manager” the second subcomponent is the “Community Clock” and the third subcomponent is the “Context-Indexer.” These subcomponents are shown hierarchically layered in the iControl main component as shown in conceptual diagram FIG. 4.

The iControl Community Manager subcomponent (hereafter Community Manager) in one embodiment according to the present invention is described in pars. [0086-0096].

One purpose of the Community Manager subcomponent is to provide security, manage all knowledge worker data and virtual group data, and monitors knowledge worker activities and interactions within the semantic virtual community.

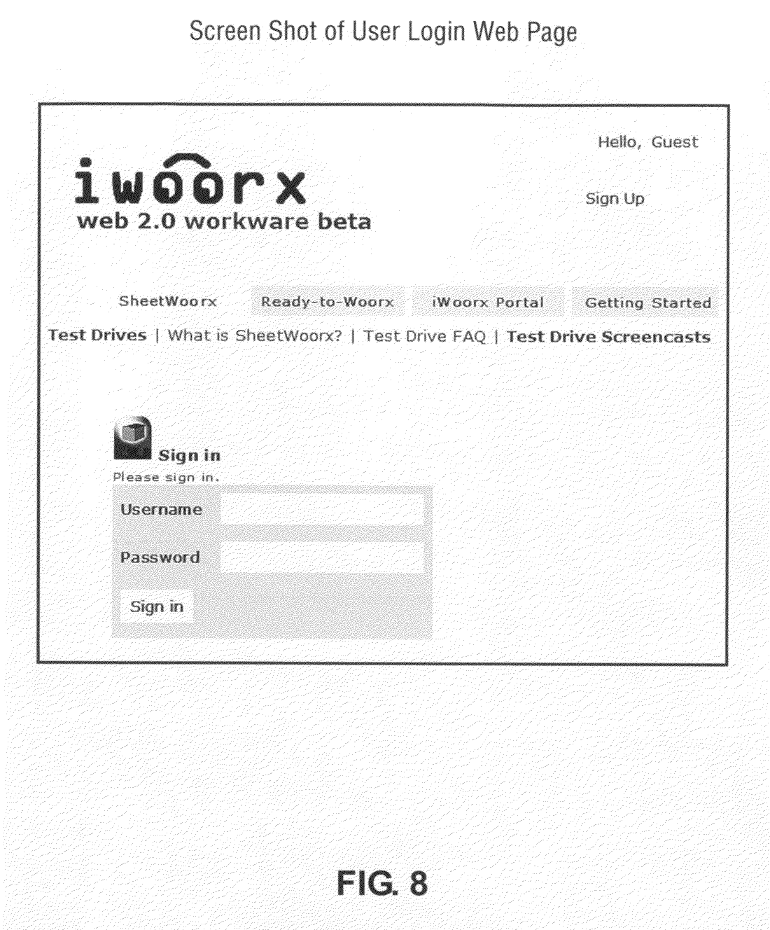

Knowledge workers access embodiments according to the present invention's semantic virtual community on the World Wide Web by entering a valid username and password into the Community Manager login web page. See FIG. 8.

Knowledge workers access this form on a web page on the internet, or by an intranet, by using a conventional web browser on their PC, by using an internet enabled mobile phone, or by any other web browser enabled device. See FIG. 8.

In one embodiment according to the present invention, after a knowledge worker enters a valid username and password, the Community Manager calculates and assigns one or more unique session codes to that knowledge worker for their activities in the semantic virtual community. These codes are valid for a specific time limit. These codes are transferred to the knowledge worker's computer in browser cookie files in one embodiment according to the present invention.

Each time the knowledge worker executes a function in any component level or subcomponent of the semantic virtual community the session codes are checked by the Community Manager subcomponent programs according to various rules in one embodiment according to the present invention. If the session codes are not valid, beyond their time limit, or do not conform to Community Manager rules, the Community Manager prevents use of any part of the semantic virtual community requested by that knowledge worker.

In one embodiment according to the present invention, if a knowledge worker has a valid user session code, they are considered to be “inside” or “within” the semantic virtual community. If a knowledge worker does not have a valid session code and cannot access the semantic virtual community, a knowledge worker is considered to be “outside” the semantic virtual community.

In one embodiment according to the present invention, the user session codes maintained by the Community Manager also provide an index to important context information, context parameters, and context linkages within the semantic virtual community. The context-metadata provided by the Community Manager is detected specifically by the Context-Indexer as is described in detail in Context-Indexer section See pars. [0075-0122, 0156-0200].

The community structure of the knowledge workers, virtual groups, and organizations represented in one embodiment according to the present invention emulate real world community social structures and relationships. The Community Manager provides for a hierarchy of knowledge workers, virtual groups, and organizations that parallels common inter-organization and intra-organization social structures.

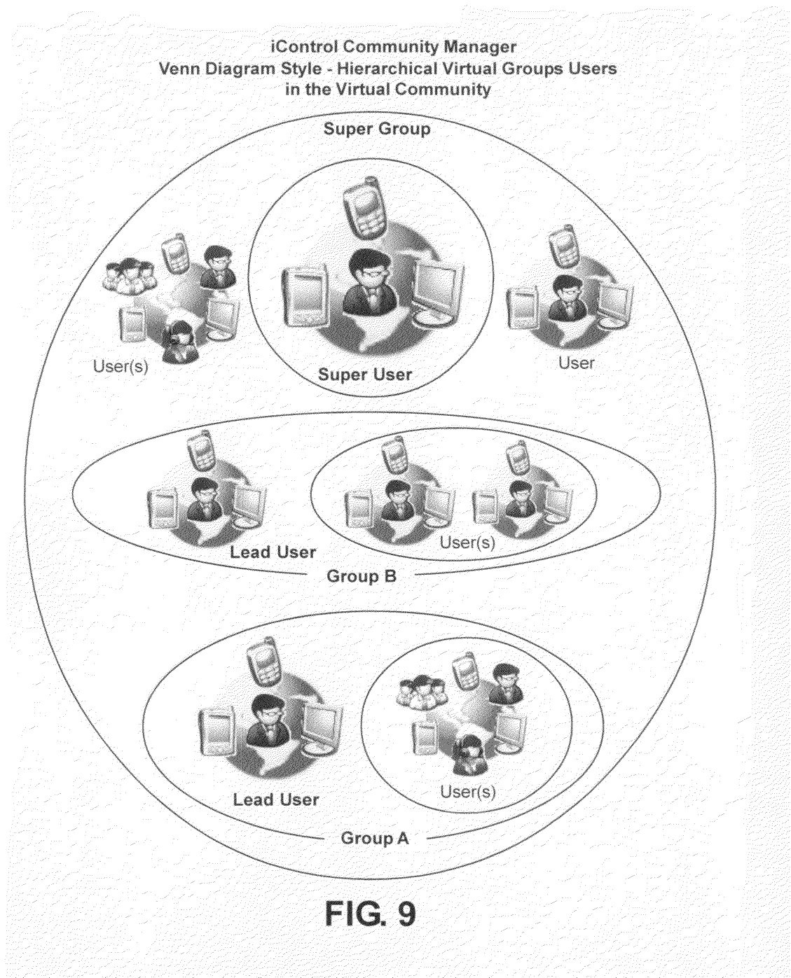

In one embodiment according to the present invention, the Community Manager further maintains databases of knowledge worker's roles and titles that correspond to the knowledge workers's real-world organization position or social position. See FIG. 9.

In many cases, knowledge workers naturally self-organize into virtual groups, to perform work more efficiently, so embodiments according to the present invention provide for hierarchical knowledge worker and virtual group management. According to Indramato “[ . . . ] Groups are important organizational entities, because groups are more efficient than individuals in tackling most tasks.” [Indratmo, 2005:38] And these virtual groups form an important parameter in the semantic virtual community's context-metadata.

As shown in FIG. 9, in one embodiment according to the present invention a semantic virtual community consists of a structured hierarchy of three (3) social levels managed by the Community Manager subcomponent. The first stratum is the super group. The super group contains virtual groups of knowledge workers, which are the second social stratum, and then all of the individual knowledge workers, which comprise the third social stratum.

There can be many virtual groups within the super group in one embodiment according to the present invention.

Each virtual group, including the super group, can have one or more knowledge worker leaders in one embodiment according to the present invention.

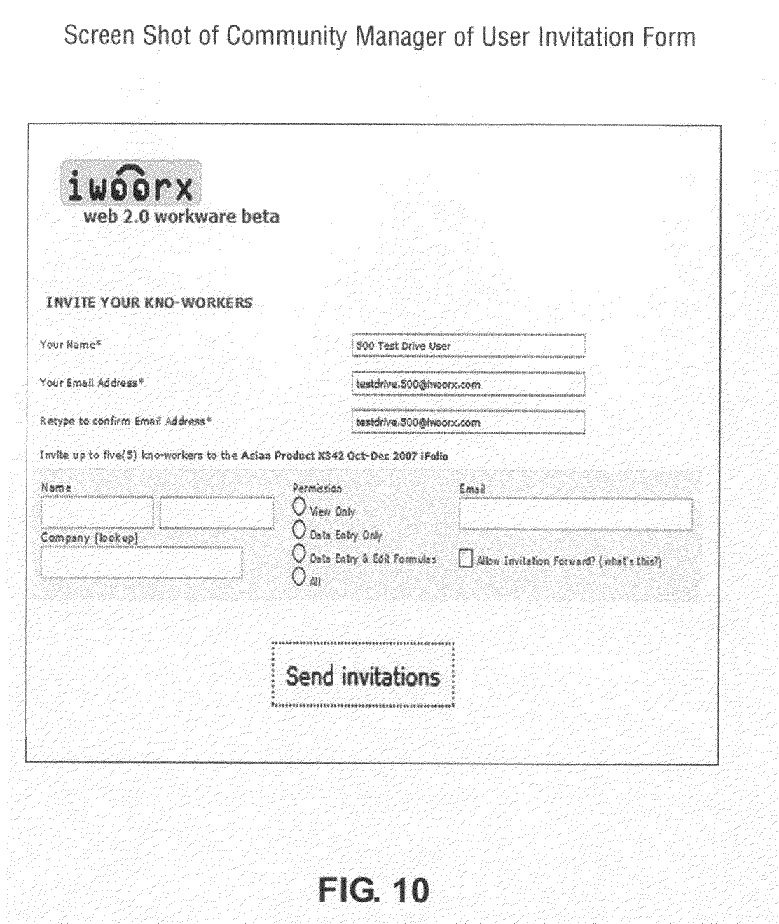

Embodiments according to the present invention can enable super group leaders and virtual group leaders to set access permissions to components, subcomponents, communications, and information for a knowledge worker, based on the virtual group that a knowledge worker is a member of. When a new knowledge worker joins a virtual group, that knowledge worker is assigned permissions for the knowledge worker's virtual group's information management applications and information in the semantic virtual community in one embodiment according to the present invention. Additionally, each knowledge worker in a virtual group can be individually assigned specific information management application permissions and information access permissions in one embodiment according to the present invention. See FIG. 10.

By setting virtual group access permissions knowledge workers can be given visibility to, and interact with group communication, group information-records, and group iFolios for the virtual groups they are a member of in one embodiment according to the present invention. Virtual group access permits knowledge workers belonging to the same virtual group to substitute for another knowledge worker in the virtual group whenever required to maintain the virtual group's workflow, communication or information management activities in one embodiment according to the present invention.

Many current enterprise software systems may require a system administrator to add new knowledge workers to a collaborative system such as the semantic virtual community in one embodiment according to the present invention. In contrast, knowledge workers can self-organize into a socially aligned hierarchical, stratified, and clustered semantic virtual community in one embodiment according to the present invention without centralized administration.

In order for a group of knowledge workers to self-organize, the Community Manager permits knowledge worker to invite other knowledge workers into the semantic virtual community in one embodiment according to the present invention. The Community Manager sends the invited knowledge worker a conventional email message which contain codes that allow the invited knowledge workers to setup their own username and password to the semantic virtual community.

In one embodiment according to the present invention, a knowledge worker who sends an invitation to invite a new knowledge worker into the semantic virtual community can permit the newly invited knowledge worker in turn to invite additional knowledge workers. Allowing new invitees to invite other new knowledge workers allows for additional self-organization and a natural increase in the number of knowledge workers in the semantic virtual community in one embodiment according to the present invention.

In one embodiment according to the present invention, all knowledge workers also can remove, or permanently delete, themselves from the semantic virtual community by canceling their own username and password. However, all of the knowledge worker's previous interactions with the semantic virtual community remain stored and linked in the semantic virtual community.

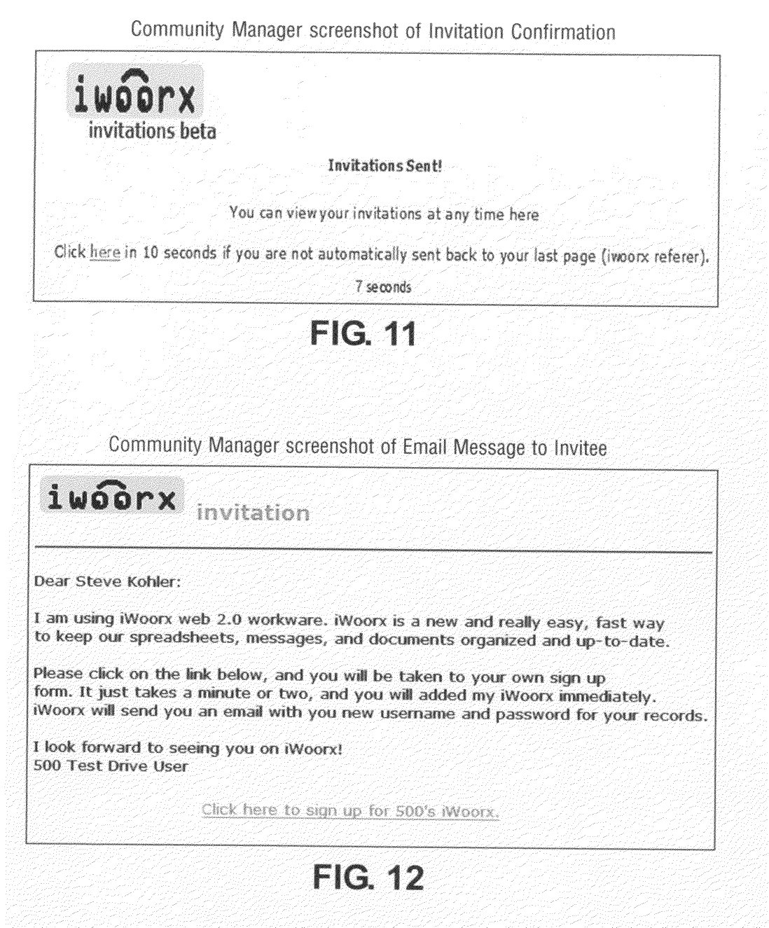

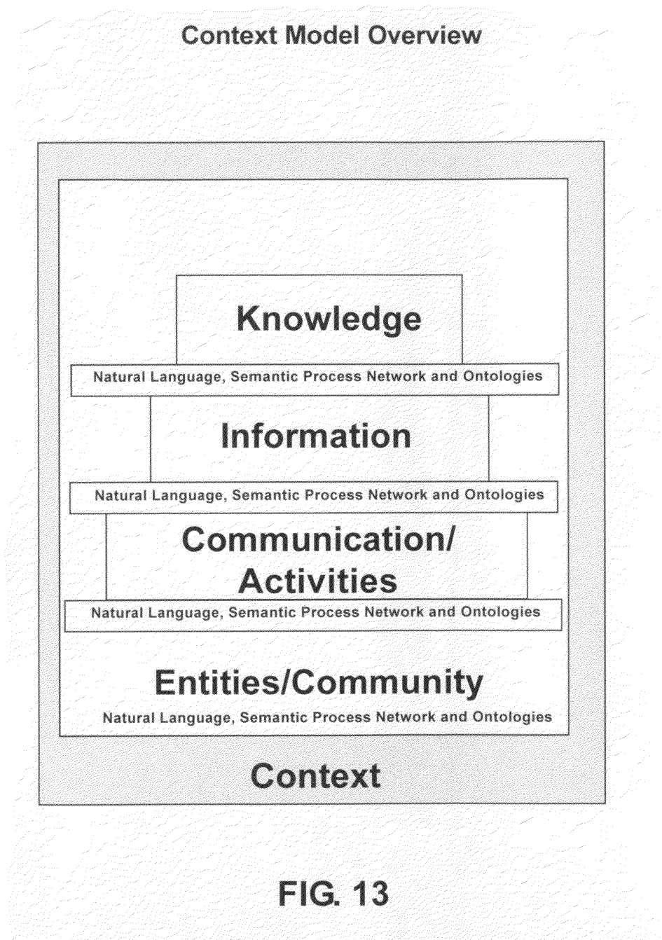

The self-organizing semantic virtual community can provide reliable context-metadata and measurable emergent properties associated with knowledge worker's social interactions in one embodiment according to the present invention. In one embodiment according to the present invention, this context-metadata as well as the databases of knowledge workers, roles, social hierarchies and virtual groups is used for analysis by subcomponents of the iFind Knowledge Manager main component level. See FIGS. 11, 12 and 13.

The second subcomponent of the iControl component level is named the Community Clock (hereafter “Community Clock”) in one embodiment according to the present invention. The Community Clock provides standardized dates and times as a utility to other components and subcomponents of one embodiment according to the present invention. The Community Clock is synchronized with an accepted global time standard.

The Community Clock provides accurate absolute dates and times as well as accurate relative dates and times are required to sequentially and chronologically detect and store context-metadata and other data in one embodiments according to the present invention. Accurate time measurements and relative times are needed to analyze the dynamic, complex characteristics of context, semantics, word associations, group communications and knowledge worker activities. Without a standard source of dates and times, events and their associated context-metadata, context-records and context-indexes could not be reconciled (e.g. normalized) with each other. This role of time in automatic annotation and the context-indexes in one embodiment according to the present invention is described more specifically in the detailed description of the Context-Indexer subcomponent in section pars. [0156-0200].

An introductory description of the iControl Context-Indexer subcomponent in one embodiment according to the present invention follows in pars. [0101-0122].

iControl Context-Indexer Introduction

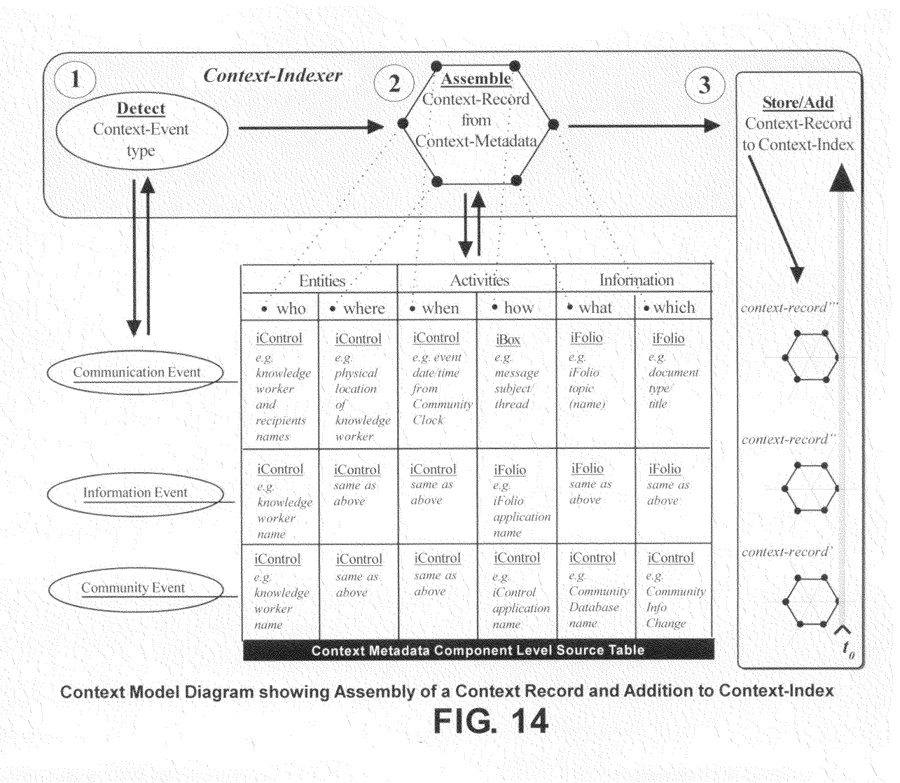

The Context-Indexer is the third subcomponent of iControl in one embodiment according to the present invention. The Context-Indexer performs the functions needed to make the semantic virtual community “context-aware” in one embodiment according to the present invention. Basic terms and concepts applicable to the Context-Indexer are described in this section pars. [0101-0122]. The specification of the data and the processes used by the Context-Indexer is specified in the Context-Model in one embodiment according to the present invention. The Context-Model used by the Context-Indexer of one embodiment according to the present invention is described in additional detail in FIG. 14.

A simple definition of “context” in one embodiment according to the present invention is: “a description of the situation of the knowledge worker, the knowledge worker's virtual group, and the semantic virtual community whenever there is a perceivable change in entities, activities, or information in the semantic virtual community.” Any addition, deletion or change in entities, activities, electronic communication or information is defined as a context-event.

The Context-Indexer detects and stores context-metadata when context-events take place in one embodiment according to the present invention. A context-event results from an information change in the semantic virtual community in one embodiment according to the present invention.

There are several types of context-events: community-events, communication-events, information-events and other context-events in one embodiment according to the present invention. In pseudocode:

context-event=community-event OR communication-event OR information-event OR other-event

An example of an community-event is to add new, delete, or change a knowledge worker, virtual group or organization in one embodiment of the present invention.

A example of a communication-event occurs when a knowledge worker either sends or receives a communication from another knowledge worker in the semantic virtual community, usually through the iBox main component. In one embodiment according to the present invention communication events can also occur by communication activity made directly by the semantic virtual community without any activity by the knowledge worker.

An example of an information-event is to add new, delete, or change a spreadsheet or electronic document in the iFolio component of the semantic virtual community in one embodiment of the present invention.

The Context-Indexer creates standard context-records using words, symbols, and facts according to the Context-Model in one embodiment according to the present invention. The words, symbols, and facts used as context-metadata are referred to as “context-words.”

Context-words are generatively introduced into the semantic virtual community during the ordinary context-events resulting from knowledge workers' activities and interactions of in one embodiment according to the present invention. See FIG. 14.

As specified by the Context Model, the Context-Indexer forms context-records from context-metadata using context-words at the time of a context-event in one embodiment according to the present invention. The Context-Indexer therefore detects and stores the use of context-words over time in order to create a history of the context-events and the context-words associated with specific context-events, and this history can be viewed as an representation of the process of the uses of context words in the semantic virtual community in one embodiment according to the present invention.

As specified by the Context-Model, the context-words are words that answer the wh-questions that can be formed from natural language wh-words (who, what, when, where, why, and how) in this one embodiment according to the present invention. The wh-words are also popularly referred to as the “5W1H” words in some linguistics reference materials.

Context-words answer wh-word questions and that both describe and classify situations surrounding context-event within the semantic virtual community in one embodiment of the present invention. The Context words are commonly observable named entities, symbols and facts in one embodiment according to the present invention.

A context-record, which is composed of wh-words, is a representation of direct observations of the situations surrounding a context-events in one embodiment according to the present invention. Context-records are mostly composed of commonly observable named entities and facts in one embodiment according to the present invention. The context-record is a representation composed from within and grounded in the semantic virtual community in one embodiment according to the present invention.

These “observations” of context-words are made from the points of view of both the knowledge workers individually and from the point of view of the semantic virtual community as a whole in one embodiment according to the present invention.

The instances of context-words (words, phrases, symbols, or images) used in context-records are known as “referents” to the wh-words in one embodiment according to the present invention. A referent may be a string composed of several words in one embodiment according to the present invention. (In linguistics, a referent is the concrete object or concept that is designated by a word or expression [Loos, 2004:47A]. A referent is also referred to as a definite descriptor and in computer science it is known as a named entity.)

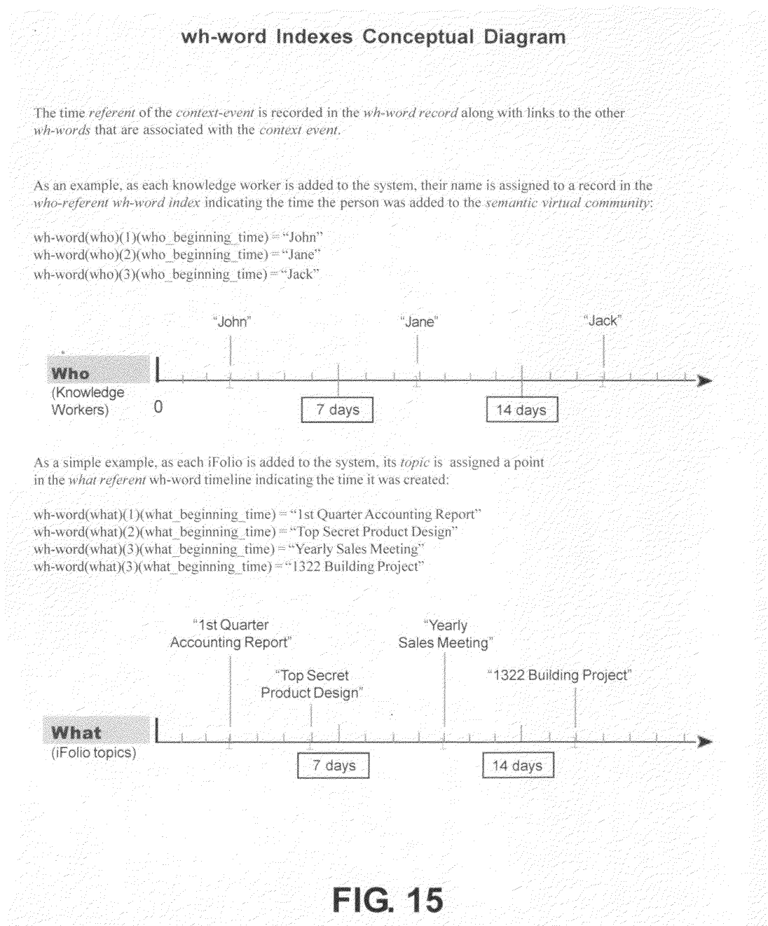

Several referents may be required to describe a situation surrounding a context-event in one embodiment according to the present invention. For example to describe a situation surrounding a communication-event may require several referents: a “who-referent,” a “when-referent,” etc.: one or more referents for each of the wh-words. See FIG. 15.

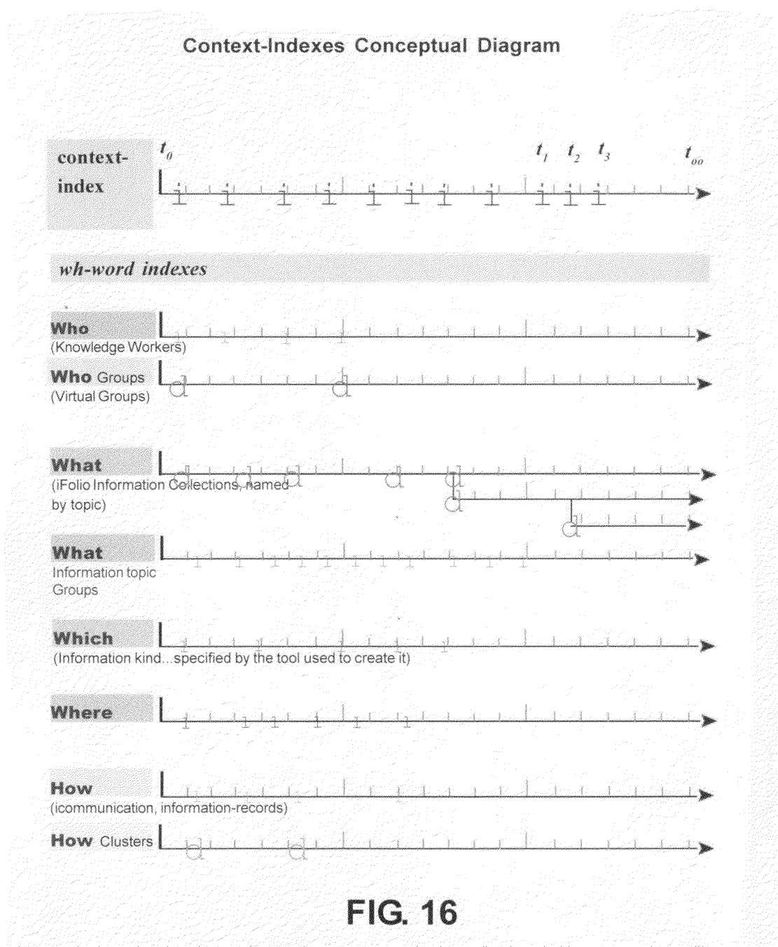

Once the referents are added to the context-indexes, the referents can be referred to as context-parameters in this one embodiment according to the present invention. A consistent semantic process that describes and parameterize the context of situations is effected by the Context-Indexer by using referents to the wh-words according to the Context-Model, that are detected and stored into context-records that are then added to context-indexes in one embodiment according to the present invention. See FIG. 16.

The Context-Indexer continually produces two principal classes of context-indexes in embodiments according to the present invention The first kind are “wh-word indexes,” which store and link individual instances of context-words, (i.e. “referents”) as they are introduced into and used in the semantic virtual community. The second kind of indexes are context-record indexes, which store and link context-records.

When a new context-word is used by a knowledge worker in the semantic virtual community, the context-word is added to the wh-word indexes in one embodiment according to the present invention. The wh-word indexes are data storage structures that contain the context-words and the date and time that word is first used in the semantic virtual community. The dates and times of subsequent uses of the context-words in the semantic virtual community are also stored in the wh-word indexes.

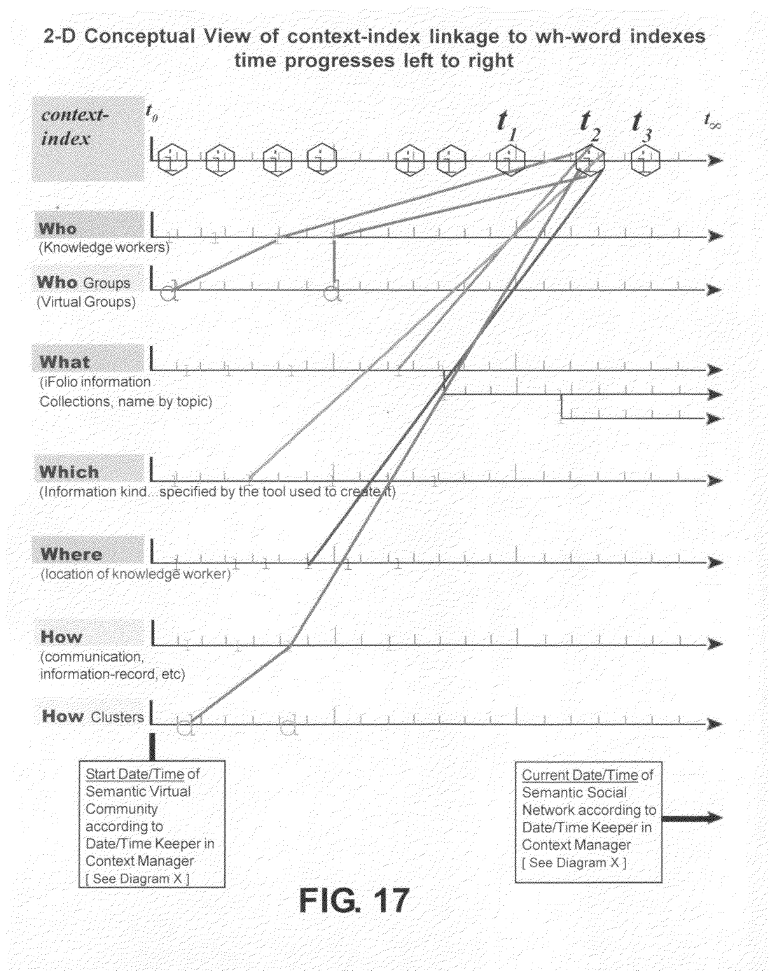

The Context-Indexer performs a process which includes detection and storage context-metadata and resulting context-records from context-events in one embodiments according to the present invention. Each context-record is stored into a context-index at the date and time each information-event occurs within the semantic virtual community, forming a time series. So, in one embodiment according to the present invention, the context-indexes are a direct representation of the time dynamics of the context of knowledge worker activities for these reasons; a) the context-records include the date and time of the context-events b) the context-records are a direct observation of the context-metadata which is composed of context-words introduced into the semantic virtual community by the knowledge workers, and c) the context-records and context-record indexes are created automatically for all context-events using commonly observable data and without direct knowledge worker action. See FIG. 17.

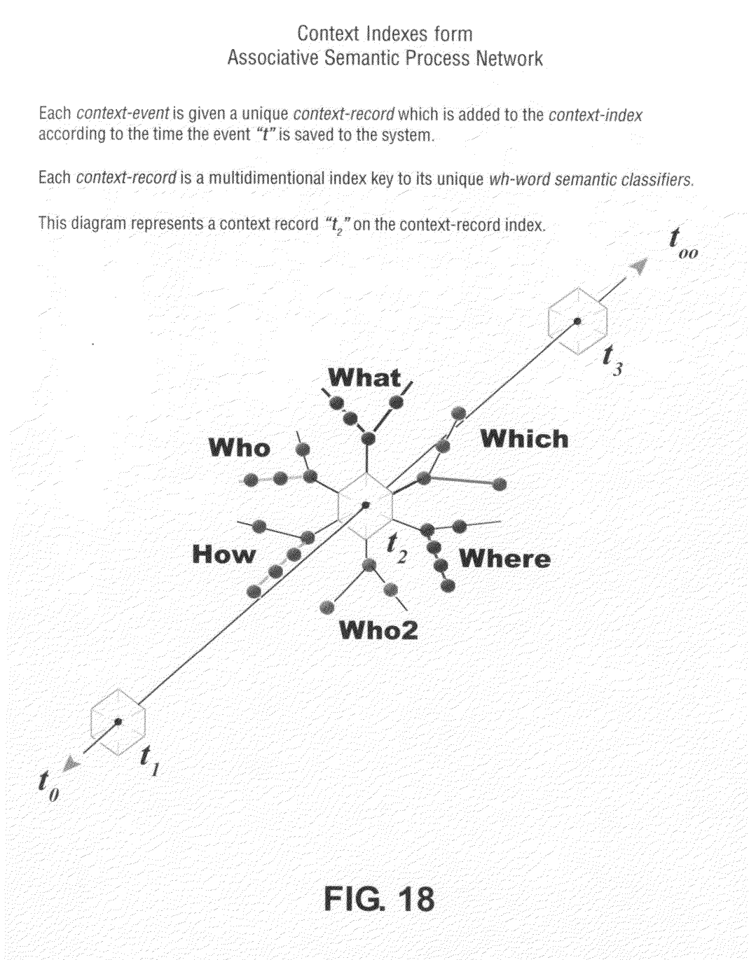

The method of context indexing used by the Context-Indexer subcomponent of one embodiment according to the present invention may also be referred to as a type of “dynamic context indexing.” Dynamic context indexing captures an important part semantic processes used by the knowledge workers in the semantic virtual community into a sequential, historical record in one embodiment according to the present invention. The history of this semantic processes chronicle the drifting and emerging properties of context and semantics within the semantic virtual community. See [Asher and Lascarides, 2003:2A]. See FIG. 18.

A more detailed description of the Context-Indexer subcomponent and the construction of the various context-indexes follows the iBox and the iFolio component level descriptions in pars [0156-0200].

A description of the iBox Communication Manager main component level

of one embodiment according to the present invention follows in pars. [0124-0138].

The iBox Communications Manager is the second main component, located at the second level of the main component hierarchy, in one embodiment according to the present invention. iBox is the second level component in the component architecture because communication is usually the knowledge worker's most frequent activity in the semantic virtual community. iBox, which is the second level is above the iFolio Knowledge Manager, which is the third component level of the component hierarchy in one embodiment according to the present invention. iFolio Knowledge Manager contains, but is not limited to, information applications, information-records, and information-artifacts. Therefore iBox communication-events are also at a higher level and information scale than iFolio information-events in one embodiment according to the present invention.

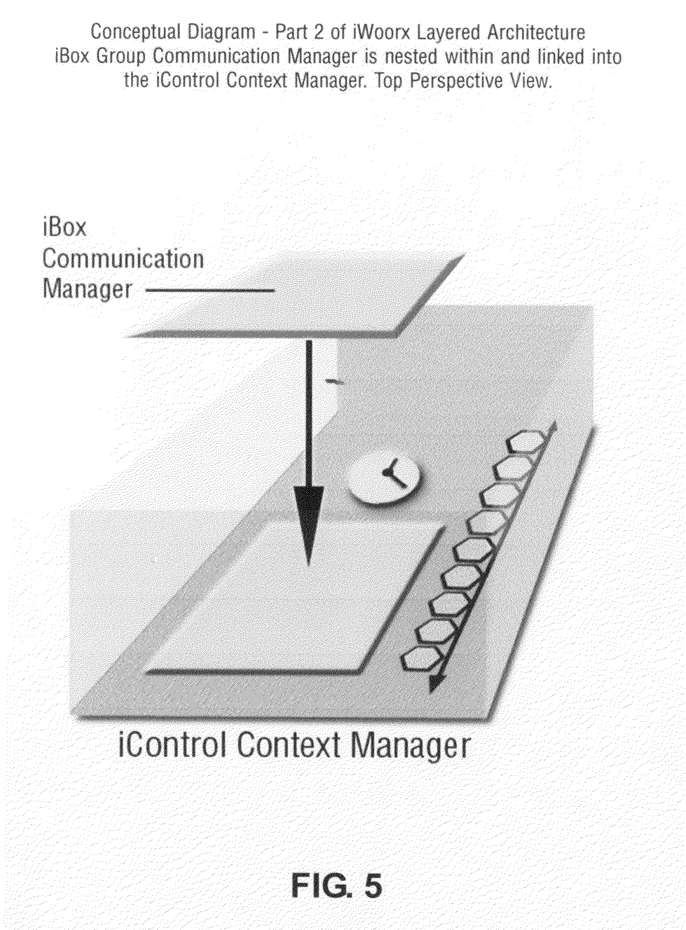

iBox provides individual knowledge worker and virtual group messaging and communication for the semantic virtual community in one embodiment according to the present invention. It also provides communication-event context-metadata for the Context-Indexer as specified by the Context-Model. See FIG. 5.

When knowledge workers use iBox to create, store, or manage electronic communications and electronic messages, the Context-Indexer detects and stores context-metadata from iBox context sources the into context-records in one embodiment according to the present invention. See the Context-Indexer section for additional details of this process in pars. [0156-0200].

iBox provides for two main types of electronic messages in one embodiment according to the present invention. One type is explicitly linked to an iFolio, and the other type is a “multi-topic” message, which can refer to several iFolios or several knowledge worker activities within a single message in one embodiment according to the present invention.

iBox provides group messaging functions that enable group views of subjects and message traffic, and other message activities of virtual groups in one embodiment according to the present invention. Traditional PC based email software application do not fully support group or threaded messaging functionality even though the average knowledge worker interacts with at least six (6) people in a typical email message thread [Bellotti, et al. 2005:5]. Group views of messaging and communication activities provide members of the group with information and group context that the knowledge workers need to perform virtual group activities efficiently.

iBox utilizes the Community Manager to provide the filtered visibility and controls for all electronic messages for all three social strata of the semantic virtual community in one embodiment according to the present invention: the entire community as the super group, virtual groups, and individual knowledge workers.

In one embodiment according to the present invention, knowledge workers assigned to the same virtual group can interact with all messaging for that virtual group. Examples of such interaction would be 1) checking whether a message has been read by its primary recipient, 2) checking whether the user is the main recipient of a message or has just been copied, and 3) if the aging or the content of the message indicates that intervention by other knowledge workers in the virtual group is needed.

Knowledge workers' messages are threaded by subject to maintain context through a group of messages that may be sent over a period of time and between many knowledge workers in one embodiment according to the current invention. The subject of a group of threaded messages is detected and stored by the Context-Indexer, and therefore the subject is searchable and linked to other group communications and information-records or iFolios that the threaded messages refer to.

In one embodiment according to the present invention, if a message thread is associated with an iFolio, the name of the iFolio is a context-metadata parameter that is contained in any context-records made for communication-events that involve that iFolio. The iFolio name (hereafter “topic”) may be composed of several words. In one embodiment according to the present invention may consider the iFolio's label as a single string in associated context-records, but can also evaluate a multiword iFolio topic by parsing the iFolio's topic into separate words and word groups for linking and analysis.

Messages associated with iFolios are each displayed to the knowledge worker in both the iBox interface and in the iFolio they are linked to. Associating messages along with the iFolio preserves context between the iFolio information-records and related messaging between the knowledge workers.

Message subjects may be modified over time, and iBox links prior message subjects to new message subjects to maintain the associations and links of the electronic message communication, even if the knowledge worker changes the subject of the message thread, in one embodiment according to the present invention.

iBox provides knowledge workers with time and action alerts in the form of iBox messages from the Time and Action Calendar subcomponent in one embodiment according to the present invention. The time and action alert message also links all information relevant to the alert, and can determine knowledge worker's current context for timing and presenting the alert to the knowledge worker.

Today email messages often have file “attachments,” which are information files (e.g. electronic documents, spreadsheets, etc.) that are complementary to, or the subject of, the written message of the knowledge worker's email. One embodiment according to the present invention iBox provides knowledge workers with a way to exchange files that is visibly analogous to the “email-attachment” process. One embodiment according to the present invention stores attachment files centrally with version control in a “File Library.”

In one embodiment according to the present invention, each time an information file is updated or added to the “File Library,” through an iBox communication, a context-record is created by the Context-Indexer that associates the file with the context of the communication-event.

iBox provides context-metadata in a fractal sequence that is used to determine dynamical properties of the semantic virtual community in one embodiment according to the present invention. The dynamical properties of electronic messaging between humans are similar to other dynamic, nonlinear, natural or biological communication phenomena and processes. Research by Eckmann, et al. has confirmed these complex properties are found in electronic messaging, and shown that analytical methods for the study of complex systems can yield meaningful meta-information about important properties of a virtual community. See [Eckmann 2004: 15]. In embodiments according to the present invention, the Context-Indexer detects and stores context-metadata for communication-events in a way that captures the communication's dynamic system behavior according to the Context-Model. The iFind Knowledge Manager component utilizes analysis of this dynamic behavior to provides reports, representations, and information retrieval. See pars. [0202-0330].

A description of the iFolio Information Manager main component level

of one embodiment according to the present invention follows in pars. [0140-0155].

In one embodiment according to the present invention, the third main component level is named the iFolio Information Manager iFolio is integrated with the iBox Communication Manager, which is the second component level in the main component hierarchy, and iFolio is also integrated with the iControl Context Manager, which is the first component level in the main component hierarchy.

In one embodiment according to the present invention, the purpose of the iFolio Information Manager is to enable knowledge workers to organize information into consolidated information collections, and to label these collection with the topic of the information contained in the iFolio. iFolio information collections resemble other current patterns and methods to organize information referred to as “information-collections” or “information-clusters” in one embodiment according to the present invention. A similar approach is described as “flexible collections” by Indratmo and Vassileva [Indratmo and Vassileva, 2005:30].

One embodiment of the current invention an iFolio, assigned a topic name, contains and one or more of the following types of information-records: 1) communication-records: defined as the threaded group communications related to that iFolio; 2) information-records, defined as information files of various formats that are modified or updated by knowledge workers in order to share information with other knowledge workers; 3) information-artifacts; 4) file libraries; 5) time and action calendars and 6) applications and tools: information management application subcomponents, known as iFolio hyperapplications. Hyperapplications are integrated with the information-records so that knowledge workers do not need to switch applications, or change their focus in order to make changes in information-records or communicate about any of the above listed types of information contained in the iFolio in one embodiment according to the present invention.

In one embodiment according to the present invention, all information management applications that manage information-records are contained at the iFolio Information Manager level. Information management applications, some of which are defined as hyperapplications, include word processors, spreadsheets, wikis, and other applications that manage information shared in the semantic virtual community. In one embodiment according to the present invention, iFolios link the information-records they contain directly with subcomponent web based applications that can add, modify, or delete information in the information-record.

In one embodiment according to the present invention, because the iFolio components executes all information management applications subcomponents with each iFolio, the focus of the knowledge worker's cognitive attention can remain within the gist of the iFolio. (The “focus” is the state of mind that corresponds to the current information-activity that the knowledge worker is working on and thinking about.)

In one embodiment according to the present invention, hyperapplications integrated in the iFolios can also update information in central or distributed data stores that eliminate the need to unsecurely exchange documents and messages through asynchronous, unsecured methods such as email. Using iFolios can increases information security, decreases data storage requirements, and decreases data network bandwidth required for knowledge workers and organizations to interact on knowledge worker activities in one embodiment of the present invention. Using centralized iFolios that are accessible to knowledge workers eliminates the need to exchange files in email and the resulting email delays, and email messages that cross each other in transit.

To start a new iFolio, a knowledge worker combines information-records, information-artifacts, and group communications into a new iFolio. The knowledge worker that sets up the new iFolio is the “owner” of that iFolio. The owner labels (i.e. names) the iFolio based on the topic that describes the collection of information contained in the iFolio in one embodiment of the present invention.

Each iFolio's topic is unique and is a named entity that represents both the iFolio, and its contents. The Context-Indexer uses the iFolio's topic as a context-metadata parameter to represent a link to the iFolio's and any association with any communication-events or any information-events that include a particular iFolio in one embodiment according to the present invention.

The iFolio topic is the name of the parent entity in a hierarchy containing the other information constituents of the iFolio. The information constituents are treated as child entities in one embodiment according to the present invention.

Additional context-indexing and context-linking capabilities are enabled using iFolio information collections in one embodiment according to the present invention. The Context-Indexer can link and extend the iFolio's topic and information to data that describes related and associated entities, activities and separate information in one embodiment according to the present invention. Unlike PC Era folders and files, iFolios can be relabeled (i.e. given a new topic name) only by their creator or by the Super User. Any change in the name of the iFolio is tracked to maintain the contextual associations and links with the previous iFolio topic.

In embodiments according to the present invention, the knowledge worker who setup the iFolio can assign access permissions for that iFolio by using the Community Manager subcomponent.

iFolios are flexible and extensible in one embodiment according to the present invention. New messages, documents, working group members, can be added or removed from an iFolio at any time by any knowledge worker with access permission for that iFolio. In one embodiment according to the present invention, when iFolios are expanded context-records are detected and indexed by the Context-Indexer using the iFolio's topic to represent a parameter in the context-record for that information-event. For detailed information about this process, see the Context-Indexer detail section in pars. [0156-0200].

The messages related to the knowledge worker activities and information-records encompassed by an iFolio are contained in the iFolio itself in addition to the iBox In one embodiment according to the present invention. So the user does not have to reconstruct or regroup communications or messages from separate applications in order to review the context and meaning of an information activity, its group communications, and its associated information-record—as knowledge workers frequently have to do now using PC Era email applications.

The iFolio component also includes a Time and Action Calendar subcomponent. This subcomponent provides in context reminders to the knowledge worker. It functions by checking due dates for tasks and document updates, and creates messages that are then sent to the knowledge worker's iBox, and included in the applicable iFolio.

In one embodiment according to the present invention, the iFolio topic label is independent of its physical computer media storage location on the server or the network. So information can be located anywhere in the semantic virtual community in one embodiment according to the present invention.

To summarize to this point in this description of one embodiment according to the present invention, the three main component levels provide contextual scaling and functionality for building and maintaining the semantic virtual community, provide communications between knowledge workers and virtual groups, and provide information management for all information managed by the knowledge workers within the semantic virtual community. The three component levels contain the data within the semantic virtual community that describes knowledge workers, roles, titles, virtual groups, electronic messages, electronic communications, and all information-records such as electronic documents, images, and spreadsheets and other digital records. In one embodiment according to the present invention, because these three component levels are linked through a specifically ordered and scaled hierarchical architecture, the Context-Indexer can automatically and continually detect natural language based context-metadata and store context-records for the process of knowledge worker's activities that occur in the semantic virtual community. A more detailed description of the processes and methods used by the Context-Indexer to build context-word histories and use patterns in one embodiment according to the present invention now follows.

A detailed description of the iControl Context-Indexer subcomponent

in one embodiment according to the present invention follows in pars. [0157-0200].
iControl Context Model and Context Indexer Expanded Description

This section expands the description of the methods, and the processes used by the Context-Indexer subcomponent to detect, store, and link context-metadata into context-indexes according to the Context-Model introduced in pars. [0075-0122] in one embodiment according to the present invention. This expanded section supplements the prior introductory section with additional detail describing the Context-Indexer and the Context-Model in one embodiment of the present invention. The Context-Indexer subcomponent monitors the knowledge worker's activities within the first three component levels of the semantic virtual community: iControl, iBox, and iFolios which have now all been described in previous section for one embodiment according to the present invention.

In the first part of this section, context is defined more specifically to include some of the situations that apply to virtual organizations which work through computer-mediated-communication and distributed virtual communities. Then a definition for context-aware computing is defined for one embodiment according to the present invention. Then the specifics of context information, referred to as context-metadata that the Context-Indexer detects in embodiments according to the present invention is then described. The Context-Indexer creates context-indexes that can link data that describes all entities, activities, and information within the semantic virtual community in one embodiment according to the present invention is described in pars. [0159-0200].

### Context Definition

“Context” can have many different definitions and connotations in different disciplines. But most people have a general understanding of what context means. In fact, in human cognitive development learning context may precede learning language [Klein, 34B:2007].

A more specific definition of context is given by Searle. According to Searle, context is a separate and identifiable part of human communication. The purpose of context is to provide specific meaning to words used within specific human communication. In what Searle describes as a “speech act,” he writes “X counts as Y in context C” where “C” is context. Therefore, in communication of all types, understanding information, “X” and information, “Y” is dependent on knowing the context, “C” [Searle, 2004:68A]. Based on this definition of context, a group understanding of the context of a communication is necessary for that communication to have a common meaning for a group or for a community.

Another popular definition of context is given by Dey, in this case, one the applies to context-aware computing: “Context is any information that can be used to characterize the situation of an entity.” Dey also gives examples: “Location, identity, time, and activity are the primary context types for characterizing the situation of a particular entity.” [Dey, et al. 1999:13]

The purpose of the Context-Indexer in one embodiment according to the present invention is to automatically and systematically collect context information, according to the Context-Model, in order to link knowledge workers with all of the information within the semantic virtual community. As described by Dey, “context simplifies human-computer-interaction by unifying the real world of the user with the logical, electronic world of computers.[ . . . ] Contextual information is the glue that integrates the physical and electronic worlds.” [Dey, et al. 1999:13]

In embodiments according to the present invention, the “situation of an entity” referred to by Dey above is defined as “the perception of the world in which the people who are communicating agree on.” To satisfy this definition, a situation would be described with objective, commonly observable, factual data that facilitates “people who are communicating” to agree on a particular description of the situation.

In one embodiment according to the present invention, “context” is defined as a description of the situation of the knowledge worker, their group, and the semantic virtual community at the time of a context-event, or any other significant change in information of any type that takes place in the semantic virtual community.

The “Context-Model” specifies how context is detected, structured and stored by the Context-Indexer to provide the context information needed to “glue and integrate the physical [world of the organization and the knowledge workers] and electronic worlds [of the computer]” in one embodiment according to the present invention. See FIG. 14 for a diagram of the Context-Model used in one embodiment according to the present invention.

Method to Build Context Records and Context Indexes from Context Events

The Context-Indexer constructs context-indexes from context-records which are representation of the process and the histories of instances of context-word (referents) use within dynamic contexts in one embodiment according to the present invention. This history captures the evolution of the context-words and their associations and relationships that treat the evolution of each word in the semantic virtual community as if its means develops over time, and within it environment in biological-like process in one embodiment according to the present invention. If you compare a word to a biological entity, it is influenced by its environment, which is context, and the word's meaning, its reason for being, may be evolve or shift in response to context just as a biological entity evolves due to environmental pressures. See FIGS. 15, 16.

Semantic associations and patterns between context-words are captured from the process representations reflected in the context-indexes in one embodiment according to the present invention. These associations can be determined by a number of types of correlation measurements that can be applied at several information scales in one embodiment according to the present invention. As described by Duch: “Biological systems may be viewed as associative machines . . . . Real brains constantly learn to pay attention to relevant features and use correlations between selected feature values and correct decisions. People may learn to act appropriately without explicitly realizing the rules behind their actions, showing that this process may proceed intuitively, without conscious control. Associative machines should learn from observations correlation of subsets of features and apply many such correlations in decision making processes.” [Duch, 2007:104]

The Context-Indexer subcomponent in one embodiment according to the present invention detects and stores context-metadata, as parameters into context-records. A similar approach to parameterizing context into an index is described by Glanzberg: “[ . . . ] the basic function of context is to set parameters. The most direct way to explain this is to see contexts as bundles of parameter values. According to this view a context is an index: a tuple of features that are the values of specific parameters. Each index looks something like a tuple:

{speaker, hearer, location, demonstrated object, quantifier domain, . . . }.

Let us call the theory which says contexts are indexes the index theory of context.”
[Glanzberg, 2002:24] Each “index” in Glanzberg's description above is equivalent to a single context-record in one embodiment according to the present invention.

Although this description of the function of context is given for spoken communication, the function of context is essentially the same for written communication as defined in one embodiment according to the present invention.

One embodiment according to the present invention, defines communication-events as the result of an active exchange of information in a message between knowledge workers. So even though knowledge worker and group communication are communication-events, they are also defined herein as a type of information-event, as well as a context-event in one embodiment according to the present invention. So for a message, in one embodiment according to the present invention the context-events surrounding a message in pseudocode is:

context-event=messaging context event=communication event+information event

In one embodiment according to the present invention, an context-event has two parts that are detected and used by the Context-Indexer.

In one embodiment according to the present invention, one part of the information detected by the Context-Indexer is the change of data contained in the semantic virtual community. This type of change is defined as an change in “information-content” in the semantic virtual community in one embodiment according to the present invention. An information-content change includes but is not limited to additions, deletions or changes in the data that describe entities, activities, or information in the semantic virtual community in one embodiment according to the present invention. With respect to each context-event, the corresponding change in information-content is referred to as “event-content” in one embodiment according to the present invention.

The second part detected by the Context-Indexer is the “event-context” in one embodiment according to the present invention. Each event-context is described using context-metadata. In one embodiment according to the present invention, the “context-metadata” is defined as the referents to the wh-words that describe the situation surrounding a particular context-event. In pseudocode:

context-event=event-content+event-context

By using language constituted from context-words, richer, cognitively aligned associations between data in the physical world and the semantic virtual community are possible.

In one embodiment according to the present invention, a knowledge worker can find a needed electronic document file by associating the names of knowledge workers involved in the activities associated with the iFolio which contains the document file. The association of the names of the knowledge workers working with the searched for information-record is an example of how embodiments of the invention use context-records and context-indexes to associate information-records with knowledge workers who may need quick access to the information.

The context-records contained in the context-indexes are linked to the information that the knowledge worker in the example is seeking, so the information-record is located using word association with context-words, the name of a knowledge worker linked to the topic label given to the iFolio, which are both contained in the context-records.

An important property of context is that it is dynamic much like language is dynamic. As described by Greenberg: “Although some contextual situations are fairly stable, discernible, and predictable, there are many others that are not. The result is that similar looking contextual situations may actually differ dramatically.” [Greenberg, S, 2001:24A.2] The Context-Indexer detects and stores direct, observable dynamic characteristics of context and related semantics in the semantic virtual community by 1) using date and time context-metadata parameters for each context-event, which are stored in the context-records and 2) adding the context-record to the context indexes at the time of the context-event in one embodiment according to the present invention. Therefore the dynamics of context is represented as the date and time of context-events in the context-indexes in one embodiment according to the present invention.

Several context extraction methods in current art do not extract the detailed dynamics of context. According to Rao and Howard, “Computational models for automatic extraction of semantic content from naturally-occurring text, such as latent semantic analysis [11], and probabilistic topic models [1, 7], exploit the temporal [in the sense that the words are in the same document] co-occurrence structure of naturally-occurring text to estimate a semantic representation of words. Their success relies to some degree on their ability to not only learn relationships between words that occur in the same context, but also to infer relationships between words that occur in similar contexts. However, these models operate on an entire corpus of text, such that they do not describe the process of learning per se.[ . . . ] Recent mathematical modeling of episodic memory argues that episodic recall relies on retrieval of a gradually-changing representation of temporal context. We show that retrieved context enables the development of a global memory space that reflects relationships between all items that have been previously learned.” [Rao and Howard, 2007:66]

In one embodiment according to the present invention, communication-based context-metadata which has dynamic properties, which reflect the “gradually-changing representation of temporal context,” is detected from situations surrounding knowledge workers' communication-events. This context-metadata includes the relative timing of the communication-events which is needed to determine the explicit dynamics of context in the semantic virtual community in one embodiment according to the present invention. Additional reasons for using communication-events as a basis for detecting dynamic properties of context is discussed later in this document.

In one embodiment according to the present invention, the Context-Indexer detects the dynamics of the context-words for all context-records that a context-word is used in. There is evidence that the dynamics of context within which a word is used has significant impact on determining the importance of a word in a particular lexicon, or vocabulary. In one embodiment according to the present invention, dynamic properties such as context distribution and distribution consistency are used for quantitative analysis of word relationships, which may be superior to current word frequency analysis used in some current art. According to Adelman “In the case of simply the arithmetic frequency or sparsity of a word in a corpuses of information is not may not be a good indicator of word importance in a lexicon. Word importance, at least in human memory, seems to be linked with the number of contexts the word is used in.” [Adelman et al., 2006:1A]

In one embodiment according to the present invention, the process performed by the Context-Indexer to create context-records and context-indexes is the same for communication-events, information-events, and community-events, and all context-events. For simplicity's sake, the description of this process will frequently only use context-event in an example or explanation.

In one embodiment according to the present invention an context-event (e) is parsed into two parts used by the Context-Indexer: the event-content (iₑ) and the event-context (cₑ), (where d represents delta, which represents addition, change, or deletion of information):

context-event(e)=d(event-content)(iₑ)+event-context(cₑ)

In one embodiment according to the present invention, the context-metadata for an context-event is detected and stored into a context-record. A context-record is therefore comprised of “referents” (also referred to as context-words) that describe the situation of the context-event (scr1ₑ, scr2ₑ, scr3ₑ, . . . ). In one embodiment according to the present invention, the context-record also includes a pointer to the changed (i.e. delta, d) information-content and date and time (t) of the communication-event or of the information-event:

context-record(CRₑ)={diₑ,scr1ₑ,scr2ₑ,scr3ₑ, . . . tₑ}

This form of the context-record is also known as an array or as a tuple.

### Wh-Words and Referents Describe Context

One embodiment according to the present invention automatically assigns semantic context values (scv*ₑ) using referents that answer wh-word questions (“who”, “what,” “where” “which,” “why*” and “how”) that describe the situation of the context-event. These specific referents are defined as “wh-word referents” (hereafter just “referents”). These referents are named entities or facts, and activities (who, what, when, which . . . ) associated with the situation surrounding context-event. (In one embodiment according to the present invention, the “why” wh-word referent is not included in the context-record; “why” is derived in a separate process outside the scope of one embodiment according to the present invention.)

One embodiment according to the present invention uses wh-word referents to create context-records and dynamic context-indexes because of special linguistic properties of the wh-words when used as situational classifiers and also the special relationships wh-words have to their referents. Some of these special linguistic properties are described in the following pars. [0186-0189].

The wh-words have a distinct place in linguistic theory. The wh-words correspond with types of entities (i.e. things) and activities humans perceive a in both physical world situations and virtual world situations. Using the referents to wh-words, or the right combination of them can describe most situations. [Glanzberg, 2002:24]

The wh-words and their use is widely understood and translingual; some version of the wh-words is present in many languages. This property of the wh-words may indicate that they occupy a fundamental place in the lexicon.

The wh-words and their referents may also help provide context descriptions which exhibit properties of semantic closure in one embodiment according to the present invention. Semantic closure is theorized to be required for an autonomous communication system. Semantic closure is described by Rocha: “In ‘Evolving Self-Reference: Matter, Symbols, and Semantic Closure’, Howard Pattee presents in detail his Semantic Closure Principle as a required self-referential relation between the physical and symbolic aspects of material organizations with open-ended evolutionary potential: only material organizations capable of performing autonomous classifications in a self-referential closure, where matter assumes both physical and symbolic attributes, can maintain functional value required for evolution.” [Rocha, 1995:96]

The wh-words act as orthogonal classifiers, and in one embodiment according to the present invention, mutual exclusivity of the referents is enforced by use of the wh-word indexes. Because wh-words are orthogonal classifiers, their referents can be assigned to semantically and mathematically independent wh-word dimensions for analysis.

In general language use, the meaning of many words are not definite and not indivisible. However, in one embodiment according to the present invention also enforces that the referents to the wh-words are definite and are indivisible by the use of rules enforced by the Context-Indexer. The referent's values are unambiguous and can consequently be used in one embodiment according to the present invention as algebraic independent variables [Grossi, 2005:24B]. So in one embodiment according to the present invention, a context-record for a single information-event is expressed as:

context-record(CRₑ)={diₑ, who_refₑ, what_refₑ, when_refₑ, where_refₑ, how_refₑ, . . . tₑ}

In this case we are transforming a word into a property of another entity.

In one embodiment according to the present invention, wh-abstraction is used to turn a proposition about the current context, into a property of the current context. Some computer languages name the operator that makes such a transformation the “lambda operator.”

Wh-word classifications by referents can be used as independent, semantically and mathematically, dimensions that can be metricized in a number of ways to model and to analyze the semantics and associative structures (such as clusters) in the semantic virtual community in one embodiment according to the present invention. See FIG. 15.

Caponigro performed a survey of wh-word semantic behavior in several languages and published his findings in 2004. He reviewed wh-word semantic characteristic across more than twenty languages from three language families. Caponigro concludes that, wh-words are set-restrictors: they apply to a set and returns a subset (e.g. who applies to a set of entities and returns just the animate ones). [Caponigro 2004:12A]. A set-restrictor is similar to a computer language operator that examines sets of named entities (in one embodiment according to the present invention—referent(s)) and selects the appropriate referent(s) based on programming rules. One embodiment according to the present invention uses this linguistic property as a semantic operator analogous to a computer programming operator which can reference and de-reference referents in context-records or in context-indexes. See FIG. 16.

Another reason for using wh-word referents as context-metadata in one embodiment according to the present invention is that the referents are self-organizing because they originate from the knowledge workers. The referents are added into the semantic virtual community's stored information structures and databases (its information-content), characterized, and classified by the knowledge workers while the knowledge workers are performing their normal information management activities in one embodiment according to the present invention.

Because the referents are self-organizing and they represent perceivable objects and facts, the referent form a dynamic “grounded” vocabulary of named entities and facts for the semantic virtual community in one embodiment according to the present invention. (As described previously, semantic grounding is the process of referencing a concept described on the conceptual level to concepts from which is assumed that their meaning is common to the user and thus needs no further definition.)

One embodiment according to the present invention also detects, adds and links context-records to the context-indexes for other context-events in the semantic virtual community. These other context-events include, but are not limited to: information-record changes (spreadsheets, word processing documents), new information-records, file uploads to file libraries in iFolios, RSS feeds, and VOIP sessions and other modes of communication. See FIG. 18.

Knowledge workers can also interact with the semantic virtual community from many internet enabled device including PC's, servers, mobile phones, PDA's, laptops and other devices. One embodiment according to the present invention, the Context-Indexer adds the physical locations of knowledge workers to the context-record for each context-event performed from a remote device.

As stated before, the label for an iFolio is also known as the topic of the iFolio. Even though a topic may consist of several words, together these words form a single named entity for the iFolio and it contents. Each named entity is also given a specific numeric identifier, which is used by embodiments according to the present invention to determine relationships between words based on their introduction into the semantic virtual community. See “Wh-word Indexes” diagram, FIG. 15. In pseudocode, the construction of a wh-word index could be written:

wh-word index+=Whw1₍ₜ₁₎+=Whw2₍ₜ₂₎+=Whw3₍ₜ₃₎+=Whw4₍ₜ₄₎+=Whw5₍ₜ₅₎+= . . . .

Context-records are stored and linked to the context-indexes in one embodiment according to the present invention. For each occurrence of a new context-event (e), referents that describe the current situation surrounding the event are detected by the Context-Indexer and assembled into context-record for that specific context-event (e), along with the date and time (t) from the Community Clock, and a pointer to the information change (di).

context-index+=CR₍ₜ₁₎+=CR₍ₜ₂₎CR₍ₜ₂₎+=CR₍ₜ₄₎+=CR₍ₜ₅₎+= . . . .

In one embodiment according to the present invention, each context-index is also a time series, because each context-record contains the date and time of the context event, and each context-record is added in chronological order to the context-indexes. Using the context-indexes as times series enables one embodiment according to the present invention to determine characteristics of the dynamics of the contexts, the vocabulary, and the semantics of the semantic virtual community.

A description of the iFind Knowledge Manager main component level

in one embodiment according to the present invention follows in pars. [0202-0297].

The iFind Knowledge Manager is the fourth, and final, main component level of one embodiment according to the present invention. iFind contains two subcomponents in one embodiment according to the present invention: 1) the Knowledgebase Manager, and 2) Knowledge Management Tools which include Contextual Search Engine, Knowledge Representations, and the Associative Directories. iFind and its subcomponents are described in the following pars. [0203-0316].

A primary function of the iFind component and its subcomponents is to create an “contextual knowledgebase” by extending in the context-indexes to associate data that describes all entities, activities, and information in the semantic virtual community in one embodiment according to the present invention. Knowledge workers can use the contextual knowledgebase with contextual knowledge retrieval tools and contextual knowledge representation tools in one embodiment according to the present invention. These tools are referred to as Knowledge Management Tools in one embodiment according to the present invention.

This section is organized as follows: First, the legacy of the notion that associational processes may be effective for information retrieval as described by Vannevar Bush is presented. Then contextual association and contextual retrieval are defined and described, for one embodiment according to the present invention, including some possible parallels in theoretical human memory and recall processes in pars. [0220-0228]. Next pars. [0233-0237] describe creating a context-network from the context indexes. The context-network is used as a foundation for the contextual knowledgebase in one embodiment according to the present invention. Next, pars. [0238-0269] describe the design and processes used in one embodiment according to the present invention to build a contextual knowledgebase. Some Knowledge Management Tools, such as the Contextual Search Engine, in one embodiment according to the present invention, require extending and incorporating dynamical meta-information into the contextual knowledgebase which is discussed in pars. [0274-0286]. Additional techniques are also used to expand the contextual knowledgebase and determine additional semantic relationships, patterns, similarities, correlations, clustering to build directly observed ontologies as well as seeded derived ontologies (as defined hereafter) in one embodiment according to the present invention. The resulting ontologies can be used by the Knowledge Management Tools as described in pars. [0287-0302]. Finally, creating cognitively aligned, and grounded, knowledge representations and 3D user interfaces from contextual knowledgebase, and from an organizational memory are described for one embodiment according to the present invention in pars. [0303-0316].

The idea that associative processes are important in information retrieval is not new. In 1945, Vannevar Bush highlighted how awkward retrieval of records from customary information collections is when compared with associative recall processes used in human memory. In “As We May Think” in Atlantic Monthly, Vannevar Bush points out “Our ineptitude in getting at the record is largely caused by the artificiality of systems of indexing . . . . The human mind does not work that way. It operates by association. With one item in its grasp, it snaps instantly to the next that is suggested by the association of thoughts, in accordance with some intricate web of trails carried by the cells of the brain . . . . ”

Methods for filing and indexing information used prior to the advent of the personal computer consisted of a system of typed documents, carbon copies, files, bound reports, filing cabinets, index card indexes, etc. These physical information records, mostly documents, were adapted to the electronic documents and are the basis of document-centric filing systems used in most PC's today. The knowledge worker's “ineptitude in getting at the record[s]” that Vannevar Bush described in 1945 has been transformed from a physical challenge to a digital challenge. And with the explosion of information and communication since 1945, retrieving information is now more important and more challenging than ever.

Vannevar Bush purports that the human brain uses a “intricate web of trails” as a mechanism which enables association. In order for associative retrieval and recall techniques to be available in today's computer systems, cognitively aligned and dynamic associative semantic indexes and/or networks that connect collections of natural language based information are needed. These indexes should provide an analog to the “intricate web of trails” for use by associative search engines, knowledge extraction tools and other semantic interfaces. To date, most digital computer information management systems use Boolean, logical, statistical, or probabilistic techniques to organize information using numerical representations instead of associations that consider the dynamical processes involved in communication and information exchange. Although associations can be approximated with these numerical and logical methods, these methods may not be optimal for finding and using associative patterns in natural language based information. Fortunately recently developed (in the last 30-40 years) modeling and analysis techniques may prove more effective for building and analyzing associative representations of natural language as well as other natural phenomena.

In most PC and (as well as web documents) the words in the documents that are used as a basis to build search indexes and determine association patterns do not include enough information by themselves to determine semantic meaning and relevance, and therefore determine cognitively aligned word associations. As a result, a practical semantic associative model and system that automatically organizes natural language based information has not yet been implemented on a commercial scale.

It turns out that Bush's explanation of a “trail of webs” within human memory relates well with recent neurobiological findings and theories based on observed brain activity patterns. A kind of “trail of webs,” in the human brain is connected by learned associations and memories which do seem to be represented and stored by complex patterns distributed throughout the brain. In the design of one embodiment according to the present invention, the context-indexes and other associative data structures are automatically created and provide a “trail” of word, symbols and facts, and are organized in a web or network topology which is explicit and can be searched and represented using associative, semantic techniques.

There are several types of association described in human memory process and cognition research and theories. These types of association, e.g. word association, concept association, and time association, are believed by some philosophers of mind and neuroscientists to be involved in organizing memory, and facilitating memory and cognition. These types of association are referred to hereafter as semantic associations.

Semantic associations are dynamical and complex just as context and languages are dynamical and complex. In one embodiment according to the present invention, the dynamical properties of the data that describes entities, activities, and information are linked to dynamical, associative contexts represented in the context-indexes. The specific Context Model (see FIG. 18) in one embodiment according to the present invention directly reflects complex word, symbol, and fact linkages and relationships which can be analyzed and used to represent the semantic associations between the words, symbols that describe entities, activities, and information in the semantic virtual community. Following are some expanded definitions of concepts needed to specify the methods used build a semantic associative information system in one embodiment according to the present invention.

“Contextual association” is defined in one embodiment according to the present invention as a process that uses context-parameters contained in context-records as junctures that semantically link, organize, and associate information stored in a memory system. Contextual association uses associations of words, symbols and facts with meanings that are defined within the domain of the semantic virtual community. Contextual association can be considered a type of semantic association in one embodiment according to the present invention.

Contextual association is the result of a process that includes linking a representation of the context of information, in a context-record which is detected and stored at the time of a context-event, with a representation of the information-record(s) involved in the context-event in one embodiment according to the present invention. The representation of an information-record contained in the context-record in one embodiment according to the present invention is the wh-what referent which can be an iFolio topic or other name or title of the information-record(s) associated with the context-event. (The definition of contextual association used in one embodiment according to the present invention may differ from another common definition in research literature. Another popular definition of contextual association is that information and entities that occur in the same context are “contextually associated.” This popular definition is subsumed by the definition of contextual association used in one embodiment according to the present invention.) See FIG. 18.

A “contextual knowledgebase” is defined in one embodiment according to the present invention as an information structure constructed by linking all of the context-records, context-indexes, and data that represents entities, activities, information produced by the knowledge workers from all component levels and all information scales. Further, the “contextual knowledgebase” incorporates meta-information derived from pattern, object, statistical, probabilistic, complexity, and dynamical analysis of context-records and their linkages to each other and to other information in one embodiment according to the present invention. As a result of context linkages and incorporated meta-information, the “contextual knowledgebase” forms a unified information structure designed to support associative search, exploration, and analysis of all information in the semantic virtual community.

Knowledge Management Tools are defined as software applications located within the iFind main component and used by knowledge workers to access organized information and meta-information in the contextual knowledgebase in one embodiment according to the present invention.

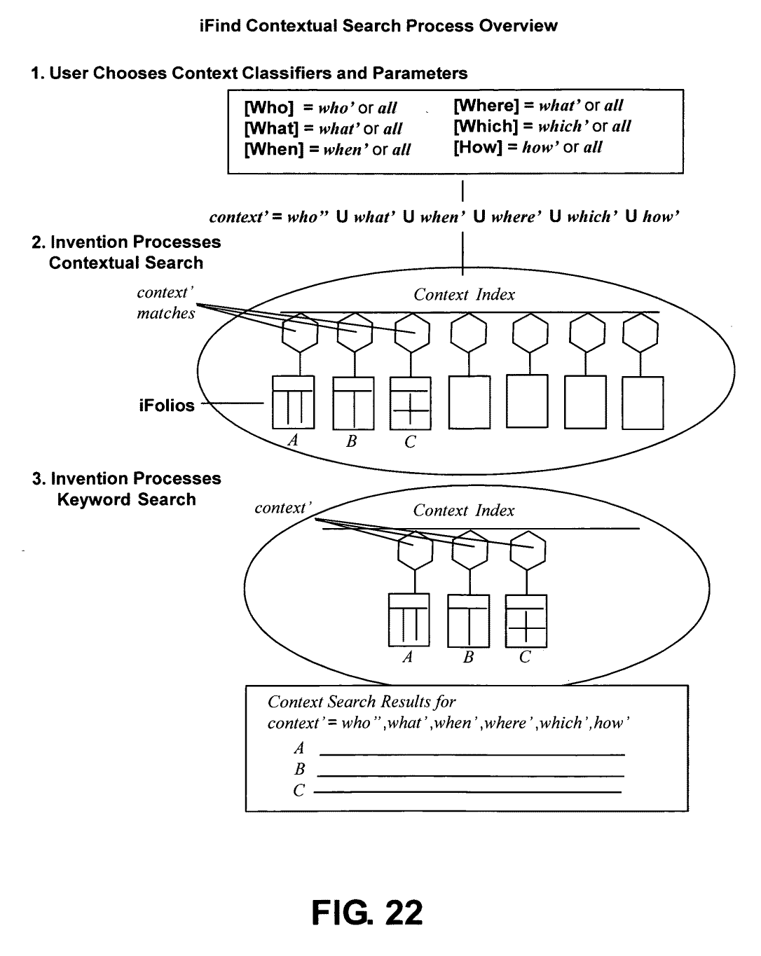

“Contextual retrieval” is defined in one embodiment according to the present invention as a process used to retrieve information that is organized and stored using contextual association. The definition of contextual information retrieval (CIR) used in one embodiment according to the present invention corresponds approximately with the definition of the process “contextual retrieval” found in computer science research papers. However the process of CIR used in one embodiment according to the present invention is a more specific process than the process(es) described as contextual retrieval in current art. For the purpose of simplicity though, contextual information retrieval (CIR) and contextual retrieval may be used interchangeably in the following discussion of one embodiment according to the present invention. See FIG. 22.

A general definition of contextual retrieval is given by Allan, et al. Allan describes contextual retrieval as of as form of information retrieval (IR) that is extended and augmented using context: “Contextual retrieval: Combine search technologies and knowledge about query and user context into a single framework in order to provide the most ‘appropriate’ answer for a user's information needs.[ . . . ] Future search engines should be able to use context and query features to infer characteristics of the information needed such as query type, answer type, and answer level, and use these characteristics in retrieval models to rank potential answers such as sentences, passages, documents, or combinations of documents.” [Allan, et al., 2002:2]

In computer science research, current interest in contextual retrieval, in the general sense of the term, is that contextual retrieval that employs context may provide significant retrieval improvements over established information retrieval (IR) techniques which only use textual context. As examples, here are two recent statements from (IR) researchers. As described by Cai in May 2007 at the WWW2007 conference: “It has been argued that context-based information retrieval is promising to achieve considerable improvements on retrieval performance.” [Cai, et al., 2007:12] Also in a similar description: “Semantic associative search [which may be provided by contextual retrieval] is recognized as a promising and important function for obtaining appropriate and significant information resources in multimedia database and knowledge base environments . . . . ” [Kiyoki and Kawamoto, 2007:34A]

Semantic associative search in one embodiment according to the present invention is implemented using contextual retrieval. Contextual retrieval (i.e. contextual information retrieval in one embodiment according to the present invention) is a method to search through computerized natural language based information such as electronic documents, spreadsheets, messages, etc. The meaning, or semantics, of this natural language based information is dependent on its context, and so all information is linked explicitly to its context in one embodiment according to the present invention. Because of these linkages, semantic associative search first searches a for an appropriate representation of context which is then associated by links to the information that is the target of the knowledge worker's search in one embodiment according to the present invention.

Many people are intuitively familiar with using associations of words and context to recall memories. CIR may improve cognitive alignment with each knowledge worker's personal experience in retrieving information from their own memory since CIR provides search by semantic association Some possible parallels between CIR in one embodiment according to the present invention and the neurobiology of human memory process theories and models are presented here for the purpose of comparison only.

Neurobiological theories and models of human memory have been unsettled over the last several decades, so it has been difficult to compare processes of information retrieval from large volumes of information located in computers (or networks of computers) with neurobiological models of memory and recall in humans. The use of context and dynamics proposed in neurobiological models of memory processes are described here because they may help rationalize why computer science researchers may believe CIR may be an improvement over traditional IR techniques, particularly for searching large collections of computerized information comprised of natural language.

Although the processes and designs of the contextual knowledgebase and the Knowledge Management Tools in one embodiment according to the present invention are based on computer program design solutions to known problems in current organizational computing tools and systems, the design also may parallel some current neuroscientific findings and theories and models of how human memory may use context in its own memory, language and cognition processes. Although still theoretical, these neuroscientific models may be useful as design metaphors for information systems that involve natural language processing (NLP). Along these lines, Dr. Gerd Binnig, Nobel prize laureate in physics, describes a generalized approach to build “natural thinking machines” that also may leverage the use of neurobiological models as reference for the design of NLP based systems: “In order for machines to be capable of intelligently predigesting information, they should perform in a way similar to the way humans think. First, this is a necessary prerequisite in order that people can communicate naturally with these machines. Second, humans have developed sophisticated methods for dealing with the world's complexity, and it is worthwhile to adapt to some of them. Such ‘natural thinking machines’ (NTM) with their additional conventional mathematical skills can leverage our intellectual capabilities.” [Binnig, et al., 2002:90]

In the last few years neuroimaging technologies and techniques have become more sophisticated and have been used to investigate neurobiological theories and models of human memory processes. Newer neurobiological studies and experiments potentially confirm aspects of some existing neurobiological theories and models that involve context in human memory processes. These new findings may help clarify why CIR for computerized information retrieval may be perceived as more cognitively aligned with human memory processes than current IR techniques. A simplified description of current theories that discuss how context may be involved in human episodic memory to create and recall memories of experiences and the words and concepts that describe them follows in pars. [0224-0228].

Recent neuroscience research findings show that episodic memories associate a memory of context of an experience with a separate memory of the details of the experience, in a process that parallels “contextual association” as it is defined in one embodiment according to the present invention. An article from Current Opinion in Neurobiology in late 2006 may help explain recent neurobiological findings about episodic memory processes and related associative memory processes: “The evidence reviewed here suggests that an episodic-semantic distinction can be applied to both spatial and nonspatial memory, and thus provides a unified framework for conceptualizing hippocampal-neocortical interactions [3,4,23]. In this framework, detailed representations of remote events (episodic, autobiographical memory in humans [3,4] and context-dependent memory in animals [23]), including rich spatial representations of environments, are hippocampus-dependent. [ . . . ] Hippocampal traces provide an index to regions of neocortex where the details of one's life experiences are stored. Each hippocampal trace, that is, each index, binds [associates] an appropriate set of neocortical traces into a representation that enables one to re-experience a particular event with many of its details, including the environment in which it occurred.” [Moscovitch, et al., 2006:51]

Such studies of encoding and recall of events in human episodic memory suggest that encoding episodic memories can be viewed as a multistep process. Human episodic memories encode the context of an experience, and then use the encoded context as an “index” to a separately encoded and located memory of the details of the experience. Based on such a model, a simplified explanation of the episodic memory encoding process is; step 1) the human memory first encodes and commits the context of an experience to memory; and step 2) the human memory then binds (i.e. associates) the initial memory of the context of the experience with the detailed information of the experience; and then step 3) detailed information about this experience is encoded and committed to long term memory. In these same theories, the memory of context is processed by one part of the human brain, and “bound” (i.e. associated) to the memory trace of the details of the experience, which may be located in one or more other regions of the human brain.

These neurobiological findings also suggest that human episodic memories are stored as a network of connected memories resulting from the encoding and storage process. It has been observed that the human brain appears to encode several neocortical memory traces for the details of the same experience, and that these traces may overlap with memory traces for other experiences. These traces have been found distributed in different regions of the neocortex, which among other advantages, may allow a human to remember an experience by multiple associative pathways. The theory of overlapping memory traces is referred to as Multiple Trace Theory. This theory infers that episodic memories in the human brain are a network of overlapping memory traces, indexed using context from memory traces of experiences organized by the Hippocampus and related brain regions. As a model, the memory traces of the details of an experience, taken together, may be viewed abstractly to form an associative memory space with an overlapping network of links and locations of memories. There is also recent neurobiological evidence that learning and retrieval of an episodic memory both activate the same neurons in the mammalian brain. [Reijmers, et. al., 2007:67A]

According to other recent theories of human memory processes, another important parameter incorporated by human episodic memory is the relative time (e.g. before, after) of an experience. The relative time of an experience is also known as the “temporal context.” The relative time seems to be a factor in human episodic memory that is used to order and associate context when encoding memories, and it may also be used to retrieve the detailed memory of an experience. One of the theories that discusses this temporal context phenomenon in human memory recall is the Temporal Context Model (TCM). [Howard and Kahana, 2002:29A]

Additional neuroscientific research indicates that human episodic memory involves encoding temporal context (i.e. the time dynamics of an experience) as a way to organize experiences into memory, and thereby into learning. From Rao and Howard, “Recent mathematical modeling of episodic memory argues that episodic recall relies on retrieval of a gradually-changing representation of temporal context. We show that retrieved context enables the development of a global memory space that reflects relationships between all items that have been previously learned. When newly-learned information is integrated into this structure, it is placed in some relationship to all other items, even if that relationship has not been explicitly learned.[ . . . ] This illustrates the ability of contextual retrieval to organize isolated experiences, or episodes, into a coherent whole based on the temporal structure of experience [ . . . ]” [Rao and Howard, 2007:66]. From Wiltgen and Silva, “ . . . episodic memory retrieval in humans includes a detailed reexperiencing of the original time and place where the event occurred (i.e., recollection).[ . . . ]” [Wiltgen and Silva, 2007:77A]

In one embodiment according to the present invention, the date and time of a context-event is a key context parameter, the wh-when referent, which is detected by the Community Clock subcomponent (see pars. [0098-0099]) and stored in each context-record. Based on the Context Model in one embodiment according to the present invention, the date and time of the context-events is contained in all context-records and context-indexes which provide the time series data for dynamical analyses of the information associated with that event, as well as finding important temporal patterns in the context information. (The notion of that time is important for organizing human memory corresponds with the observation that many knowledge workers' information searches carried out on their own PC's and laptops use time as a primary search parameter. For example, a knowledge worker might search for all the email messages from the last week from his colleague named John.)

The current models of human memory and recall in the preceding paragraphs theorize two particular processes involving context that may be useful to consider in the design of a contextual information retrieval (CIR) system as well as the design of computerized group information management systems. These same processes also seem to be reflected in some linguistic definitions of context discussed in earlier sections of this document. According to the human memory models of the memory process, one process uses the context of the experience to associate and organize memories, details, timing, and meanings of an individual's experience. And then another process may use the dynamics of context (i.e. temporal context) to determine the relative timing of experiences, and also may use the timing of contextual situations to further organize experiences into learning.

As a comparison to the human memory models, in one embodiment according to the present invention, the “experiences” of a person in the real world can be compared to the context-events resulting from knowledge workers' activities in the semantic virtual community. The human memory models suggest that the context of an experience is used to form an “index” bound to (i.e. associated with) the “details of that experience.” In one embodiment according to the present

invention, a comparable process is that the context of an information worker's activity is detected as a context-event and stored in a context-record by the Context-Indexer. The “details of that experience” in human memory can be compared to the detailed information contained in the iFolio, or any other information which is linked to the context-record at the time of the context-event.

Further, the notion of “temporal context” and its possible role in human memory processes could be compared to the use of time and the Community Clock by the Context Indexer to detect and store wh-when referents into the context-records and then add these context records into the context-indexes at the time of context-events in one embodiment according to the present invention.

As an example, just as context is theorized to play a central role in using in human memory recall, semantic associative search can use context to provide a search engine with searchable, associative indexes of semantically associated information which directly associates information to the people, or in this case knowledge workers, who need to find information. This method may be widely applicable to many types of natural language based information system because of the inherent relationship of context to semantics of words, symbols, and facts located in electronic forms of natural language based information.

Currently, direct representations of context and context meta-information are missing from most information management systems and so these associative contextual information structures are missing as well. As a result, established IR techniques generally apply probabilistic and statistical analysis of an entire collection of information treated as an agglomeration of words. This agglomeration of words is often referred to by IR experts as the “bag of words.” Using the “bag of words” IR techniques, all words start as meaningless collections of letters and spaces, then they are matched and associated in letter and word patterns using probabilistic and statistical analysis along with various assumptions. Context is extracted from the actual text, and is popularly referred to as textual context. This statistical representation of context is then used for further probabilistic, statistical or machine learning analysis along with the various assumptions. Some of these assumptions are based on the “distributional hypothesis,” and then modified by ad hoc “parameter tweaking” to attempt to more accurately portray word associations and relationships.

There are known weaknesses in these current approaches to semantic extraction and mapping. that are based on the distributional hypothesis. The distributional hypothesis holds that words that are close together in the text of a document are probably close together in meaning. This is a reasonable but broad assumption, and as discussed before, results of information retrieval using these methods can be of limited accuracy due to numerous exceptions in such assumptions when they are used to create a model of natural language use and meaning in specific, and dynamic information. In August 2007, in the preface to the Proceedings of the 2007 Workshop on Contextual Information in Semantic Space Models, Baroni, et al. express possible concerns about the widespread use of the distributional hypothesis, semantic spaces and assumptions made by researchers: “Some variation of the so-called distributional hypothesis—i.e. that words with similar distributional properties have similar semantic properties—lies at the heart of a number of computational approaches that share the assumption that it is possible to build semantic space models through the statistical analysis of the contexts in which words occur. [ . . . ] the very notion of context on which semantic spaces rely on gives rise to various crucial issues both at the theoretical and at the computational level, which in turn determine a large space of parametric variations [ . . . ].” [Baroni, et al., 2007:86]

In contrast to statistical and probabilistically derived semantic relationships based on the distributional hypothesis used in current art, contextual information retrieval uses semantic relationships from explicit, observed, dynamically linked words used in context and words used in various forms of information in one embodiment according to the present invention.

The context-words contained and linked sequentially in the context-network are detected by direct empirical observation by the Context-Indexer of the processes of the knowledge worker's activities in one embodiment according to the present invention. The relationships, patterns, and shifting of these words, symbols, and facts are direct representations in one embodiment according to the present invention.

The contextual knowledgebase is an process network-like data structure which links and associates all data about all entities, activities, and information in one embodiment according to the present invention. Its purpose is to provide a representation of the process of emergent contextually linked and associated information from the semantic virtual community suited for contextual information retrieval (CIR), contextual knowledge representations, and analysis in one embodiment according to the present invention. “Knowledge” is defined and the design of the contextual knowledgebase is described for one embodiment according to the present invention in the next pars. [0239-0241].

The term “knowledge” is commonly found along with the terms “information” and “data” in computing and information science discussions. However “knowledge,” “information,” and “data” are typically used without an accepted definition that delineates the exact differences between these terms.

“Knowledge” as it applies to this description of one embodiment according to the present invention, is defined as an organized form of information combined with its context—and this information has the key wh-questions about the information answered and associated with the combined information and context. The answers the wh-questions (who, what, when . . . ) pertaining to the linked information are represented by the context-metadata referents that comprise the context-record in one embodiment according to the present invention.

Some educational psychologists define the first levels of knowledge in human learning with a definition similar to the definition for knowledge used in one embodiment according to the present invention. In some learning models, the lowest and first level of learning is “knowledge.” Bloom describes “knowledge” as learning (remembering, memorizing, recognizing, recalling identification, recalling information) about who, what, when, where, how, and the description of a subject. See [Bloom, 1956:7]. In one embodiment according to the present invention, the contextual knowledgebase is a knowledge representation because information is linked to its topic, which is linked to the context of the information which contain referents that answer wh-questions associated with that topic.

“Information” consists of the information-records and information artifacts and other types of information collected in the iFolios and also any extended related information generated or stored in various components and subcomponents of one embodiment according to the present invention.

“Data” is the text, numbers, images, symbols, time measurements, etc. that are organized into various types of information in one embodiment according to the present invention.

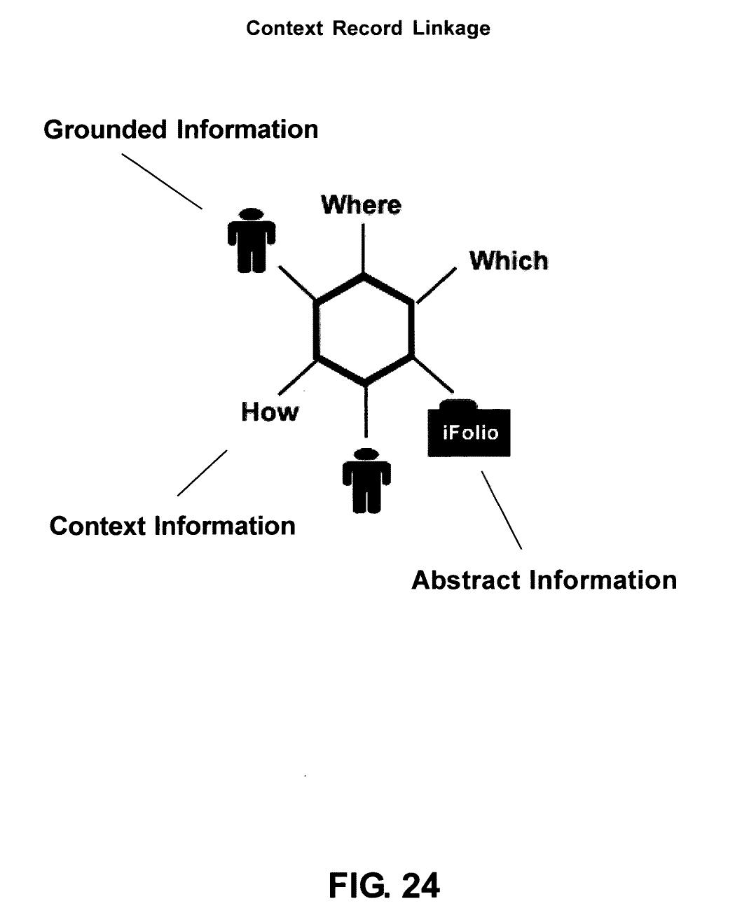

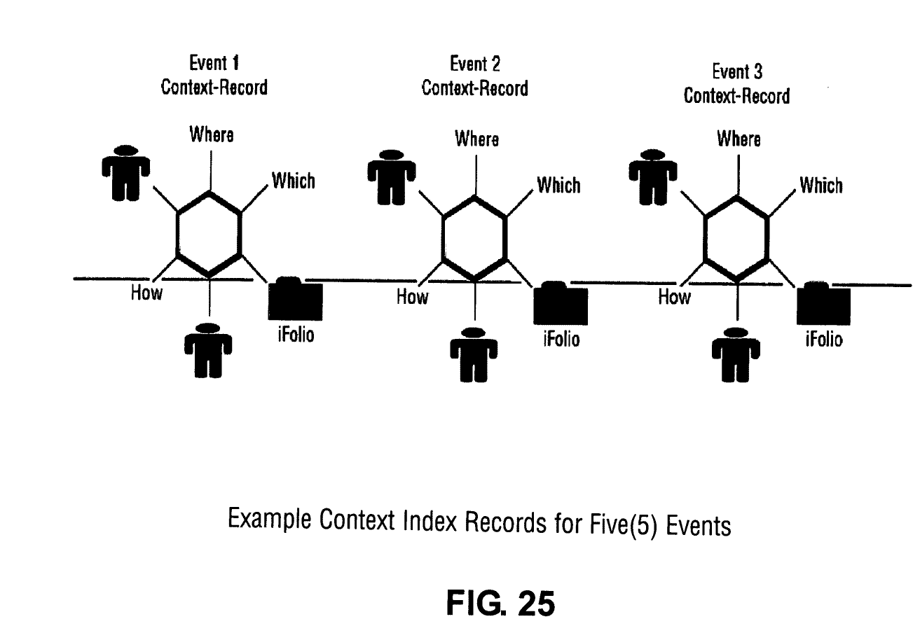

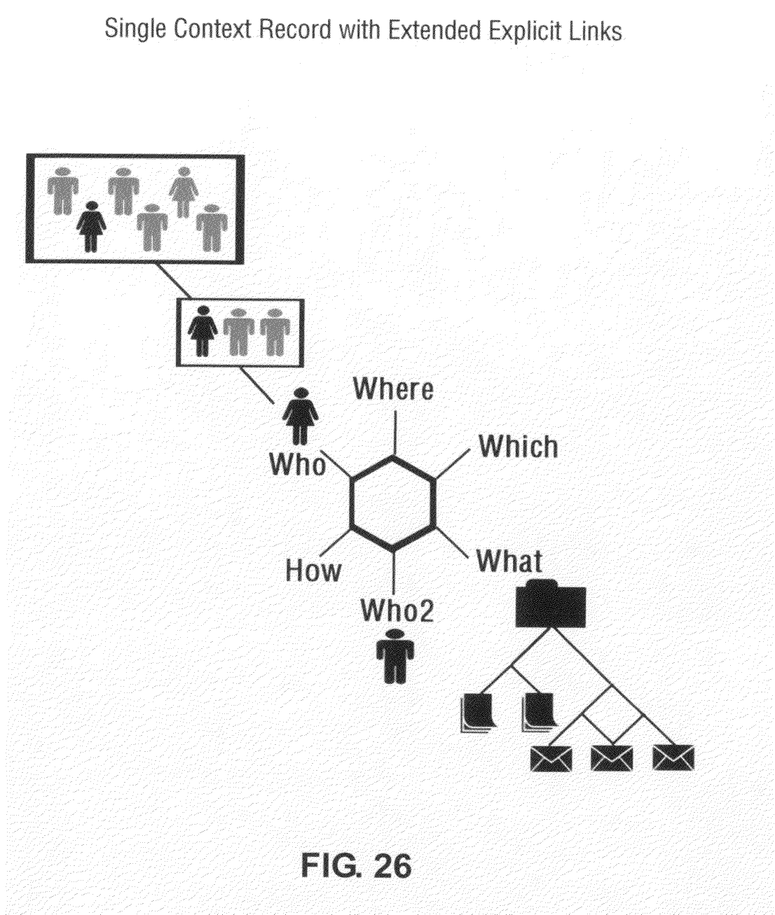

The way that knowledge, information, and data are linked and associated using context to and between entities, activities and information in one embodiment according to the present invention is referred to as the “Contextual Knowledge Model.” The Contextual Knowledge Model is a hierarchy of linked information: context-metadata, context-records, context-indexes, word-indexes, information-records, iFolios and iFolio topics, information-artifacts, electronic documents and messages of all forms, semantic networks, and semantic spaces in one embodiment according to the present invention. See FIGS. 24, 25, 26, 27 and 28.

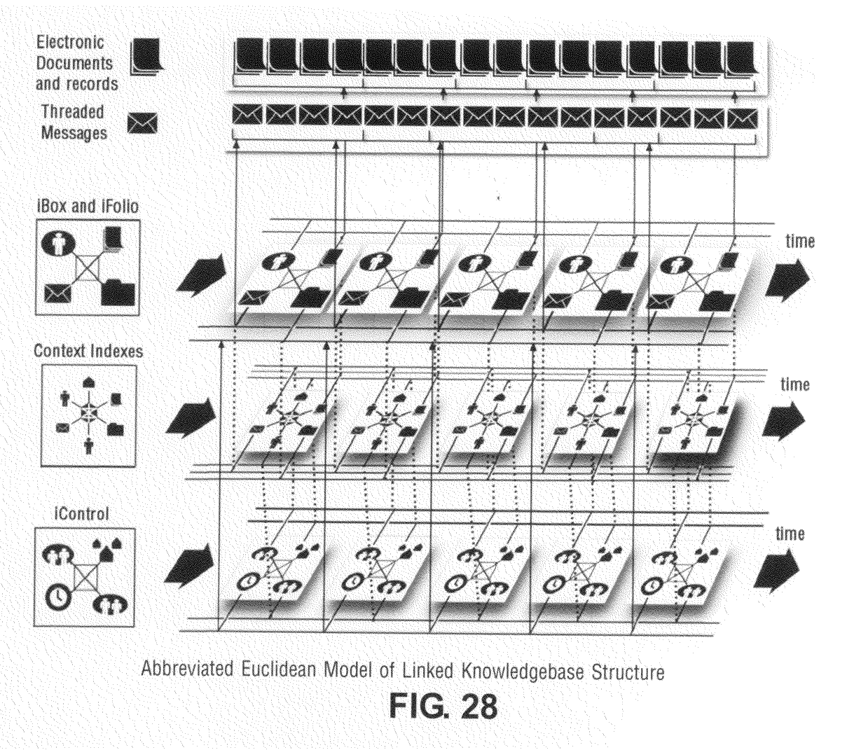

The foundation of the contextual knowledgebase is the “context-network” which is formed by explicitly linking context-records and context-indexes in one embodiment according to the present invention. The context-network provides a self-organized seed network structure to add links associate additional information and data and for all entities, activities, and information contained in the contextual knowledgebase in one embodiment according to the present invention. By using the context-network as the seed network for the contextual knowledgebase, the information in the contextual knowledgebase can be associated with its context. The explicitly linked context-network is diagrammed in FIG. 28.

The context-network and its role in the contextual knowledgebase is described in further detail in the following pars. [0247-0262].

The purpose of the context-network is to provide a dynamical representation of the relations and patterns that uses directly observed context-parameters as a semantic foundation for the contextual knowledgebase and other semantic information structures in one embodiment according to the present invention.

The context-network grows and evolves by the addition of context-records and context-indexes in real time along with growth in entities, activities, and information in the semantic virtual community in one embodiment according to the present invention. The context-index linkages reflect the process of temporal-historical use of words, sequences of words, and shifts of word use within the semantic network.

Since the context-indexes are ordered sets of context-records, the confidence levels of word correlations (e.g. associations) may be higher than current art in one embodiment according to the present invention. These correlations are a mathematical measure for word association, and they can be calculated across and between wh-word indexes to contribute to word association measurements.

The contextual knowledgebase has three primary types of links between data and data structures in one embodiment according to the present invention: “explicit links,” “extended explicit links,” and “derived links.” These links are created separately, by separate rules and have different properties which are employed to organize and use the contextual knowledgebase for analysis and representations in one embodiment according to the present invention.

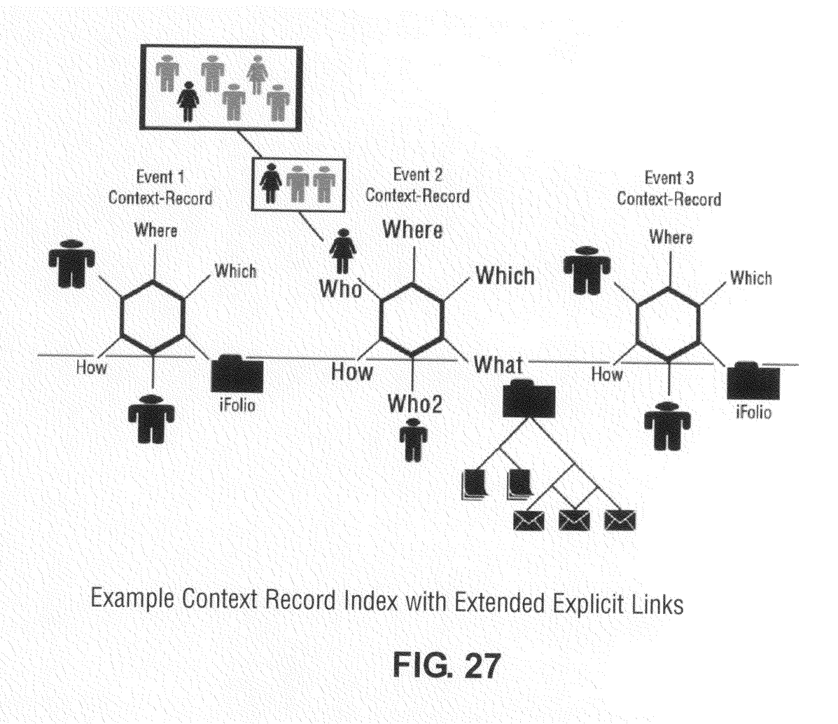

First, the explicit links are links made by the Context-Indexer and directly link words. symbols or facts as they are use by the knowledge worker within each context-record in one embodiment according to the present invention. The explicit links directly link the wh-referents in the context-records and between the context-records. These explicitly linked words directly represent word associations and the dynamic pattern of use of these words in the semantic virtual community in one embodiment according to the present invention. See FIG. 27.

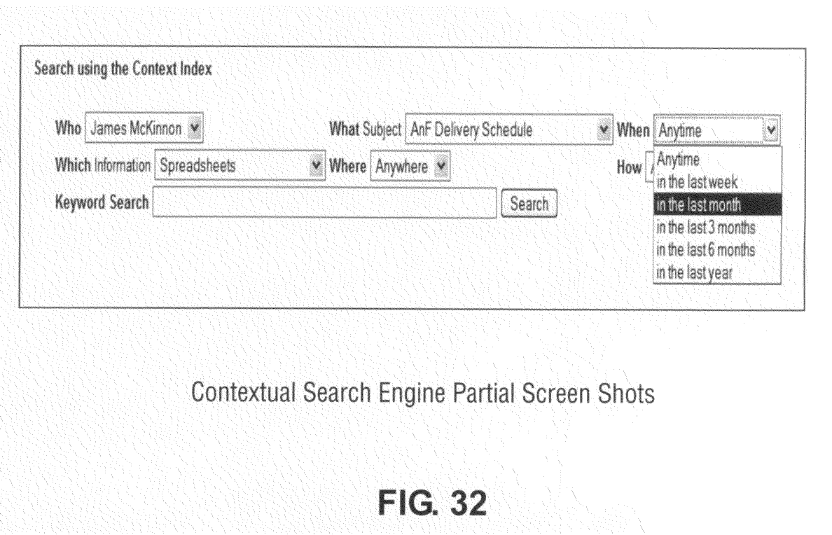

Second, the “extended explicit links” in the contextual knowledgebase connect explicitly linked information to other related information contained in the databases, documents, and other information records and other information sources in one embodiment according to the present invention. Similar to explicit links, the extended explicitly linked referents and words directly represent word associations and the dynamical pattern of use of these words in the semantic virtual community in one embodiment according to the present invention. These links are formed as needed by queries and analysis in one embodiment according to the present invention. See FIG. 32.

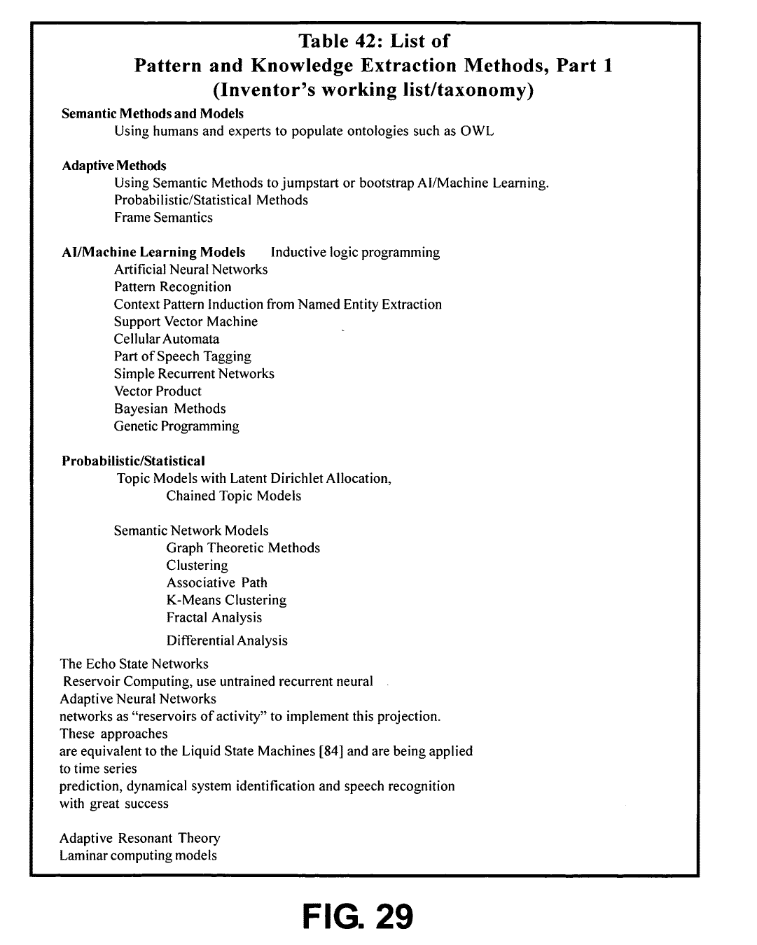

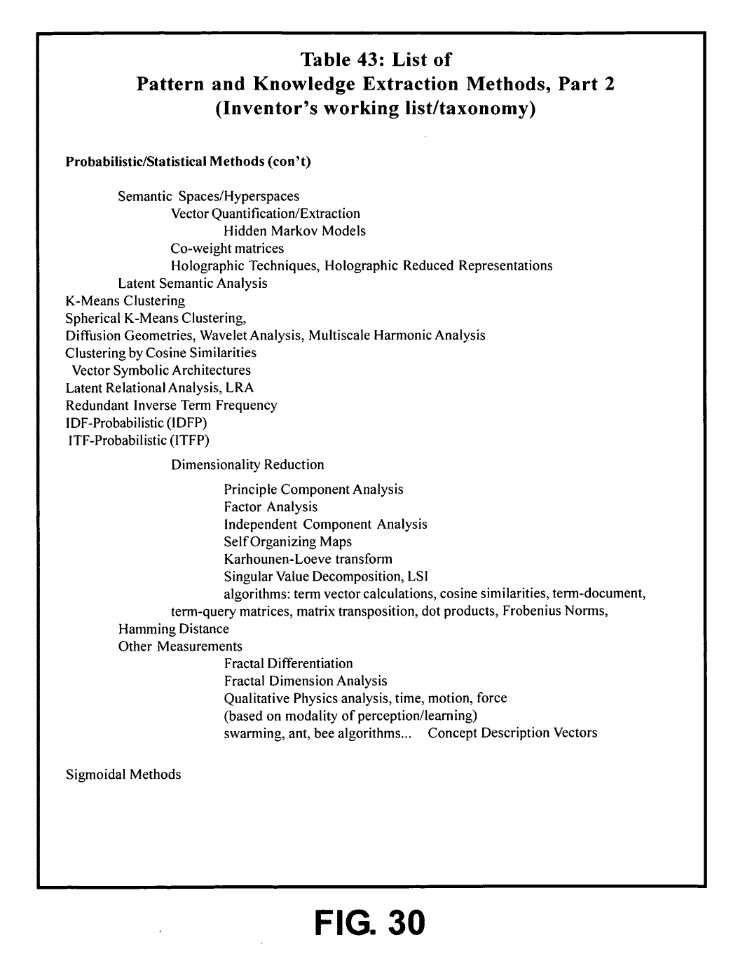

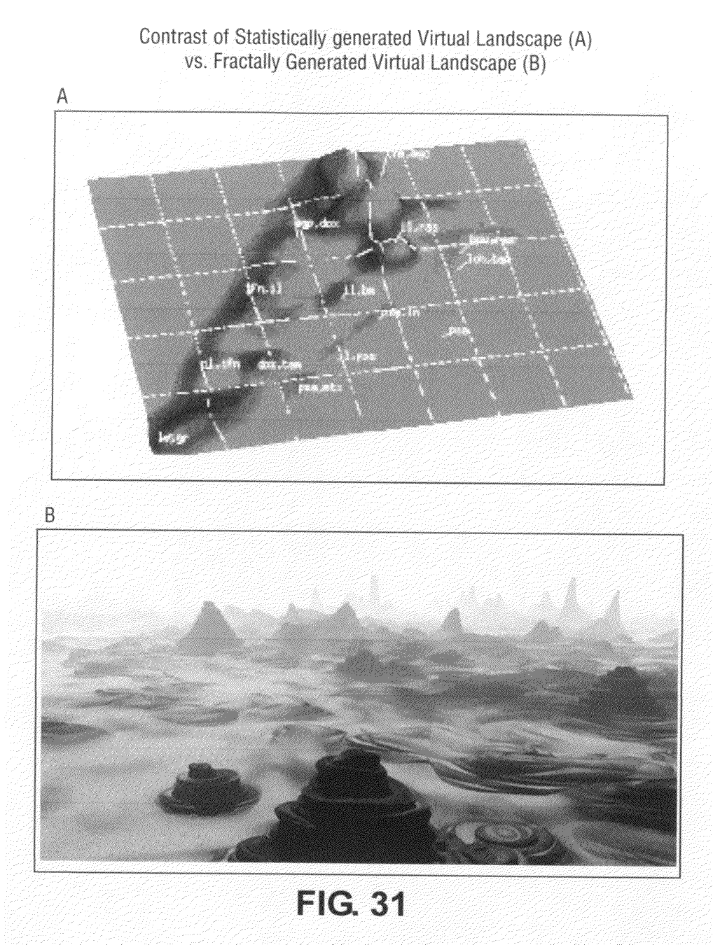

Third, the “derived links” semantically associate words through analysis of contextual information, meta-information and other types of information in the semantic virtual community. The analysis can be done by any appropriate mathematical techniques, alone or in combination, including, but not limited to analytic methods listed in FIG. 29 and FIG. 30. The derived links are created as needed for analysis and for generation of knowledge representations in one embodiment according to the present invention.

### Nonlinear Dynamics in the Contextual Knowledgebase

The contextual knowledgebase inherits dynamics of context from the context-network in one embodiment according to the present invention. The possible importance of including such dynamical properties of language in semantic representation are increasingly being recognized by linguistic researchers. Here is an example from a recent publication “ . . . languages are complex dynamic systems within which different types of structures act as organizers in order to make it possible for cognition to handle the immense amount of information involved in the communicative process. Within this view, in which words act at the same time as cues of mental representations, triggers of ad hoc conceptual constructions, and anchors which prevent meanings from verging on the border of chaos . . . ” [Papi et al., 2007:91]. And from artificial intelligence researcher Joachim De Beule: “ . . . compositionality, hierarchy and recursion, generally acknowledged to be universal features of human languages, can be explained as being emergent properties of the complex dynamics governing the establishment and evolution of a language in a population of language users . . . ”

### [De Beule, 2008:92].

The dynamics of context and language are accessible in one embodiment according to the present invention because, as previously described, the context-network contains context-indexes that are time series which preserve date and times of context-events as a direct result knowledge worker activities. These time series contain context-records which contains the actual observed words that describe the situations of context-events. The context-records result from a goal oriented, biologically initiated communication process, in one embodiment according to the present invention.

The context-records are multidimensional, these several of these dimensions are orthogonal, and because they are organized into a time series they reflect both the dynamics of language growth and the dynamics of context growth of the semantic virtual community. These sequences can be viewed, one dimension at a time, as similar to fractal sequences of words that are similar to Cantor sets. They can also be combined into multifractal like representations for additional dynamical analysis under certain conditions.

Similar nonlinear dynamical system and time series analysis techniques have been used successfully in medical analysis and other biological sciences to analyze complex systems. Complex systems exhibit emergent patterns, behaviors and relationships which are measured using such techniques. Measurements, associations and relationships can be found that provide further knowledge into the behavior of the semantic virtual community, its constituent entities, activities, and information in one embodiment according to the present invention.

In particular, goal oriented electronic communication, along with other forms of human communication, have been shown to exhibit nonlinear dynamical system properties common to complex systems. Complex system properties can also be observed at several levels in one embodiment according to the present invention when a plurality of knowledge workers have used the semantic virtual community to exchange and manage information.

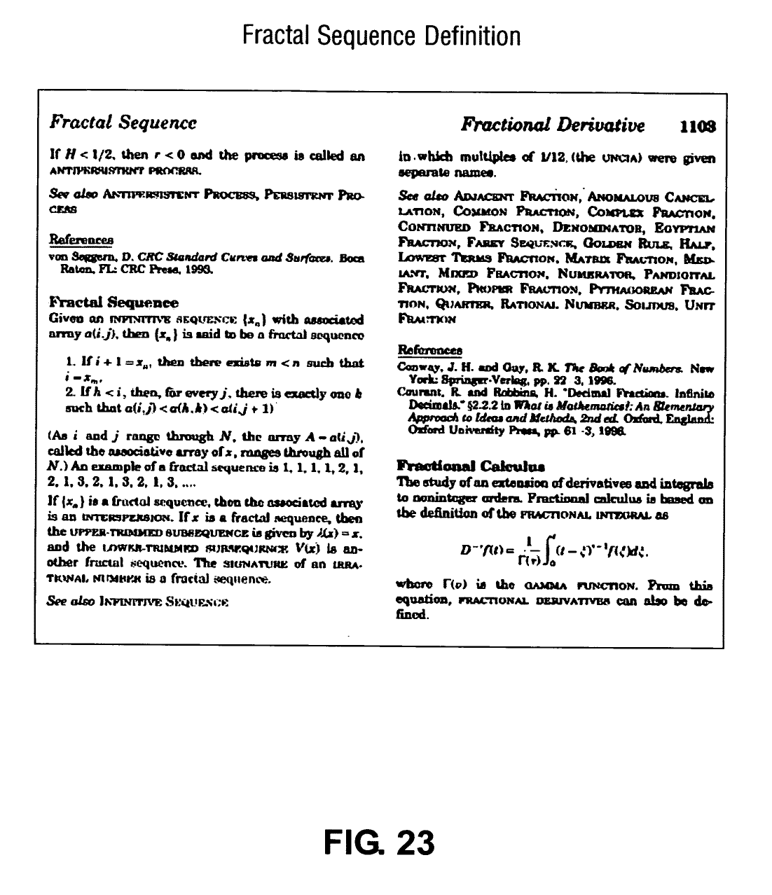

One embodiment according to the present invention detects and stores a large proportion of context-records from communication-events between knowledge workers and groups of knowledge workers (also referred to as group communications in this document). These communications when viewed in a time series can exhibit complex structures, patterns and relationships. From Eckmann in 2004, “We study the dynamic network of e-mail traffic and find that it develops self-organized coherent structures similar to those appearing in many nonlinear dynamic systems. These temporally linked structures turn out to be functional, goal-oriented aggregates that must react in real time to changing objectives and challenges” [Eckmann, et al. 2004:15]. These complex characteristics are detected and stored in the context-indexes by the Context-Indexer for analysis that can provide important emergent patterns, measurements and trends in the semantic virtual community. The context-indexes based on communication-events are reflect patterns that are similar to fractal sequences in one embodiment according to the present invention. So the context-metadata for communication-events are detected and stored in a way that preserves nonlinear dynamical properties in one embodiment according to the present invention. See Fractal Sequences FIG. 23.

The measurements, dimensions, patterns, and relationships derived from various methods of complexity analysis and nonlinear dynamical analysis used in one embodiment according to the present invention may help produce knowledge representations which are more cognitively aligned with both the knowledge workers and within the semantic virtual community. For example, some mapping researchers argue that complex, non-Euclidean dimensions are needed to build cognitively aligned conceptual maps, knowledge maps, and knowledge representations. According to Montello: “Commonly, semantic similarity is mapped metaphorically onto distance (relative location) in the graphic information space, usually metric distance of the straight-line or direct Euclidean type. The widespread and uncritical application of this metaphor may be problematic when information spaces resemble geographic spaces, such as landscapes [14], natural terrain [15], or urban spaces [16]. Geometry in geographic space is not just Euclidean, and in fact, it is not just metric. In other words, similarity can be graphically suggested in terms of several types of ‘distance,’ especially when distance is understood broadly to include a variety of expressions of separation (temporal, topological, etc.). Information spaces will be more usable if they are based on a sound theoretical and empirical framework, including those concerning cognitive aspects of space and place.” [Montello, 2003:54]

Using the context-network, measurements of nonlinear dynamics can be extracted and analyzed in one embodiment according to the present invention. An example of an important measurement is the correlation dimension, which is also used as an approximation for the Hausdorff dimension of a fractal. The characteristics of this dimension are described by Chin, et al.: “The correlation dimension of an attractor is a fundamental dynamical invariant that can be computed from a time series[ . . . ] Fractal dimension is a measure of how ‘complicated’ a self-similar figure is. In a rough sense, it measures ‘how many points’ lie in a given set. A plane is ‘larger’ than a line, while S [i.e. self-similar figure, e.g. fractal] sits somewhere in between these two sets.” [Chin, et al., 1997:12A2]

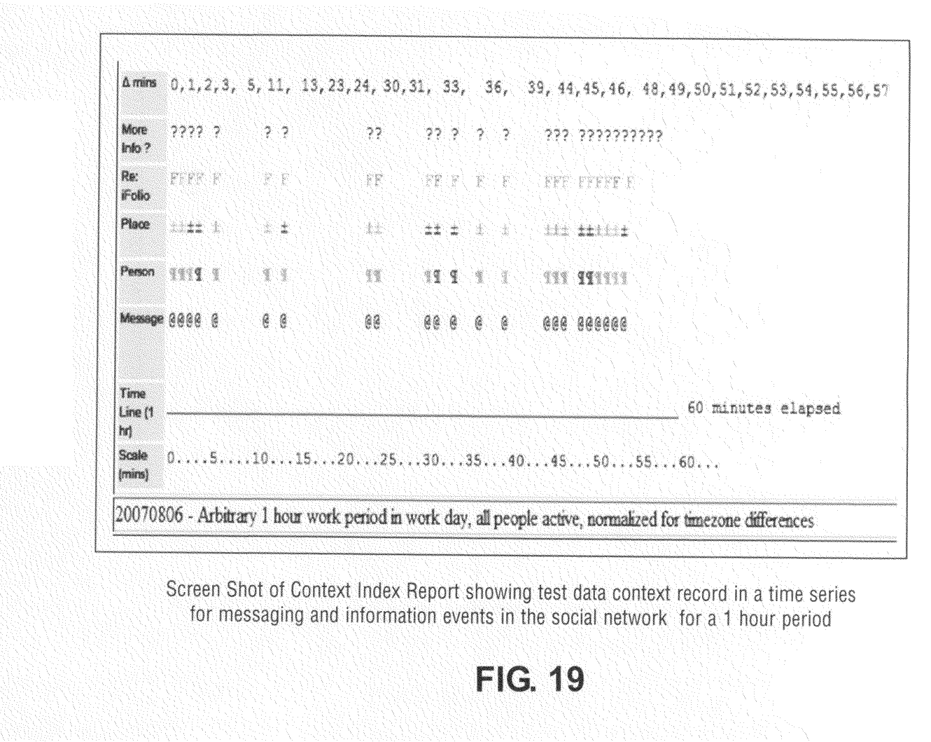

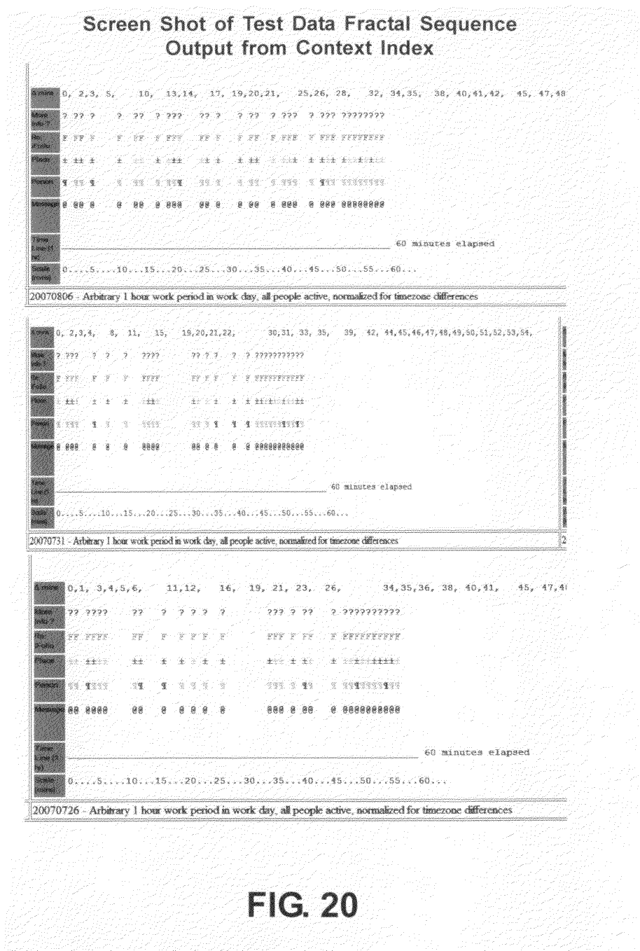

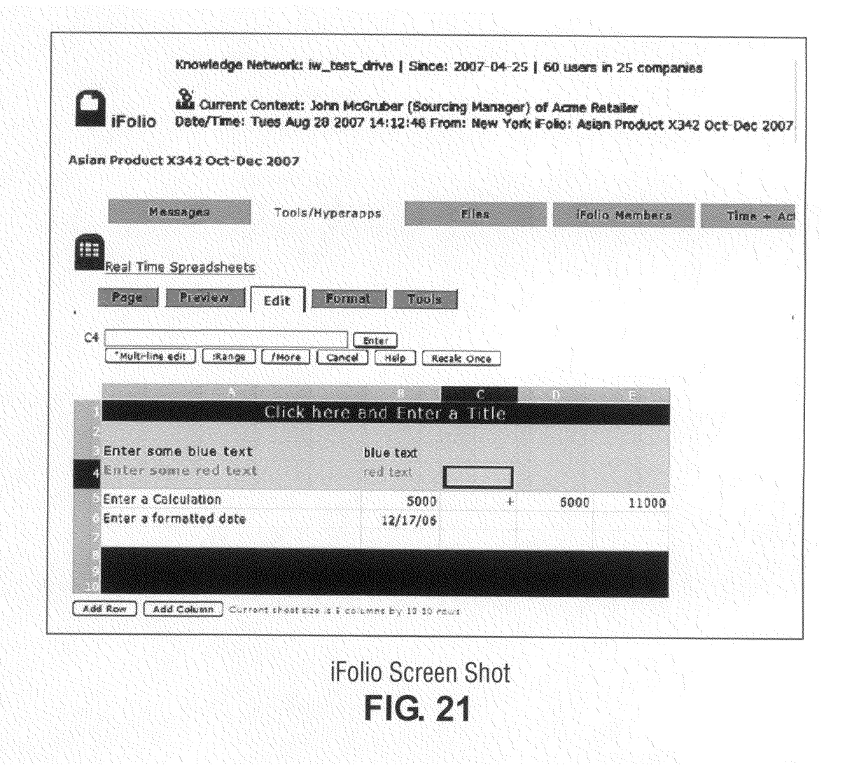

By calculating fractal dimensions, for example by calculating the correlation dimension of the wh-word referent fractal sequences in the context-indexes, one embodiment according to the present invention can determine important information about patterns, dynamics and relationships of word and concept meanings, interactions, patterns, and temporal dynamics in the semantic virtual community. In one embodiment according to the present invention, fractal and other nonlinear dynamical analyses can also be used to create associative maps, meta-information, and representations that incorporate measurement of emergent properties of the entities, activities, and information in the contextual knowledgebase. See FIGS. 19 and 20.

Fractal geometry and fractal analysis is one technique used to visualize and analyze complex and dynamical systems. Fractal geometry is used for two purposes in one embodiment according to the present invention. First, the context-network is a network that contains connected limited fractal sequences that can be analyzed to find emergent patterns and word associations, and can be used to analyze and model semantic relationships and language used in the semantic virtual community. Second, fractal and multifractal displays can be used in knowledge representations, and incorporate the results of fractal analysis in one embodiment according to the present invention. Fractal based information and knowledge displays can be used for viewing large datasets like those found in an semantic virtual community. See pars. [0309-0316].

Fractal and nonlinear dynamical analysis can also be performed on information contained within the other component levels of one embodiment according to the present invention.

One result of using the contextual knowledgebase as a multidimensional associative index for associative search is that the iFind subcomponents can search associatively across all data formats (images, communications, spreadsheets, etc.) linked to the contextual knowledgebase in one embodiment according to the present invention. This capability is popularly referred to as “unified search,” which makes the search, retrieval processes faster and easier for the knowledge worker than searching through file formats and information sources separately.

Another result of using the contextual knowledgebase in one embodiment according to the present invention, is that knowledge workers are provided with many associative paths through the linked data in the contextual knowledgebase in one embodiment according to the present invention. These paths and links in the contextual knowledgebase automatically provide associative access to data about entities, activities and information in the semantic virtual community. So knowledge workers do not have to manually categorize or file information in one embodiment according to the present invention.

Using multiple semantic pathways may to find information also may be more intuitive to knowledge workers than current art because multiple semantic pathways enables knowledge workers to interact with the information in the semantic virtual community using word association from any starting point of words, times, people, places, or topics. The organization and pathways of embodiments according to the present invention's may mimic theorized memory pathways in the human brain such as those described in Multiple Memory Trace theory current in neuroscience [Moscovitch, 2006:51].

An “Organizational Memory System (OMS)” can be created from the contextual knowledgebase in one embodiment according to the present invention. The Organizational Memory System self-organizes along with the growth of entities, activities and information in the semantic virtual community and the words, symbols and facts that describe them in one embodiment according to the present invention. Like the contextual knowledgebase, the Organizational Memory System is semantic and associative in one embodiment according to the present invention.

Specifically the organizational memory can lead to knowledge representations that are spatializations of word use and semantic relationship that are cognitively aligned, cognitively plausible, and cognitively adequate. In one embodiment according to the present invention uses a definition for “spatialization” as defined by Fabrikant and Skupin: “Spatialization is defined here as a data transformation method based on spatial metaphors, with the aim of generating a cognitively adequate graphic representation (e.g., a depiction that matches human's internal visualization capabilities) for data exploration and knowledge discovery . . . ” [Fabrikant and Skupin, 2005:103] In one embodiment according to the present invention uses a definition for cognitive adequacy, again from Fabrikant and Skupin: “Cognitive adequacy extends the concept of cognitive plausibility, a term used by psychologists to assess the accuracy with which models are believed to represent human cognition (Edwards, 2001). We define cognitively plausible Information Visualization as a graphic display designed such that it matches human's internal visualization capabilities well. A cognitively adequate depiction is understood here as graphic display that not only supports humans' internal visualization capabilities optimally, but is able to augment people's mental visualization capabilities for complex reasoning and problem solving in abstract domains (Hegarty, 2002).” [Fabrikant and Skupin, 2005:103]

One use of a OMS is to build cognitively plausible and aligned knowledge representations in an organization is to provide knowledge workers with a way to form distributed cognition in the semantic virtual community in one embodiment according to the present invention. As a result of distributed plausible cognition among the knowledge workers, which is referred to as cognitive alignment in one embodiment according to the present invention. Cognitive alignment among the knowledge workers and between the individual knowledge worker and the semantic virtual community may be improved in one embodiment according to the present invention. According to some psychological research, when cognitive alignment is improved, behavioral alignment can also be improved and improved behavioral alignment can lead to improved task performance by all members of a group working toward a commons goal. In one embodiment according to the present invention, the OMS may help provide cognitive alignment which may facilitate behavioral alignment in the semantic virtual community: knowledge workers, their virtual groups, and consequently, their organizations. [Gundlach, et al., 2006:24C]

Another use of an OMS is to provide a semantic memory system for an artificial mind. Some Artificial Intelligences researchers argue that an semantic memory system must be the foundation of a functional AI system which utilize anthropomorphic or speech driven interaction with the human user: “The first step towards creating avatars with human-like artificial minds is to give them human like memory structures with an access to general knowledge about [their] world. This type of knowledge is stored in semantic memory. Although many approaches to modeling of semantic memories have been proposed they are not very useful in real life applications because they lack knowledge comparable to the common sense that humans have . . . ” [Szymanski, et al., 2007:105]

### Contextual Search Engine

The next paragraphs discuss the some uses of the contextual knowledgebase represented as an organizational memory, as well as knowledge representations and Knowledge Management Tools in one embodiment according to the present invention. The first Knowledge Management Tool discussed is the Contextual Search Engine.

The Contextual Search Engine is the first contextual information retrieval subcomponent of the iFind main component in one embodiment according to the present invention. The Contextual Search Engine searches through the associatively linked contextual knowledgebase to retrieve information that is the target or is relevant to the knowledge worker's search in one embodiment according to the present invention.

Limitations of the current statistical based retrieval methods used in current art are emphasized by Li in 2007: “Statistics-based methods and keyword-based input have been prevalent in IR research such as vector space model [7], latent semantic analysis [8], language modeling [9], and probabilistic model [10]. They can be viewed as sophisticated stochastic techniques for matching terms from queries with terms in documents under the assumption of term independence. They try to derive the meaning of the text from the observable syntactic and statistical behavior of its units without any attempt to represent the meaning directly. However, words alone cannot capture the semantics or meanings of the document and query intent. To put it differently, the search results should satisfy the users, who are looking for something that matches their understanding of pertinent text—an understanding that includes, among other things, the relations among the terms and the ability to disambiguate and to infer. This is where the statistical keyword-based techniques fail the users and defeat their purposes.” [Li, et al., 2007:94]

The user interface for the Contextual Search Engine in one embodiment according to the present invention is similar to typical search engine interfaces, but the retrieval processes used by the Contextual Search Engine differs from typical search engines. The Contextual Search Engine primarily use contextual association and word association from the contextual knowledgebase in one embodiment according to the present invention, instead of the “bag of words” keyword matching search methods, statistical methods, probabilistic methods, and document link analysis methods used in many typical search engines today. See FIG. 32.

The Contextual Search Engine has a multifaceted interface (see FIG. 32) for search and information retrieval, so a knowledge worker can retrieve communication, information, and other information types based on directly linked and associated referents to the wh-words (who, what, where, which, and how) autonomously entered by the knowledge workers in one embodiment according to the present invention.

When a query is performed by the Contextual Search Engine using contextual information retrieval in one embodiment according to the present invention, the retrieval process starts by searching the explicitly linked context-network portion of the contextual knowledgebase. The explicitly linked context-network is a set of multidimensional associative arrays in one embodiment according to the present invention. Using the context-network provides associative semantic search through directly represented and explicitly linked data that describes all entities, activities and information in one embodiment according to the present invention. The search results returned to the knowledge worker are 1) matches on referents along with 2) the most contextually relevant results in one embodiment according to the present invention

Relevant search results are determined by contextual association by Contextual Search Engine in one embodiment according to the present invention. Relevance is determined from closest, or most correlated, linked word associations in the patterns of sequential context-records in the context-network in one embodiment according to the present invention. Contextual association is related to semantics by Jones and Mewhort in 2007: “A word's meaning is defined not only by its context but also by its temporal position in that context relative to other words.” [Jones & Mewhort, 2007:31A] See FIG. 22.

In contrast, IR in current art typically uses “bag of words” statistical techniques to provide relevance measures, knowledge workers have only a probability of finding relevant information. The probability that a knowledge worker finds all the relevant documents and information that apply to their search query and the query context using current art may be limited.

The Contextual Search Engine traverses the context-network contains the context-records which are comprised of the referents to wh-words (names of the knowledge workers, the times, the place, the information collections, etc.) in one embodiment according to the present invention. These referent words, symbols, and facts are grounded in the domain of the semantic virtual community in one embodiment according to the present invention because these words and symbols are entered directly by the knowledge workers themselves into the semantic virtual community. The wh-referents entered by the knowledge workers represent perceived, real and definite descriptions

of entities, activities, and information in the semantic virtual community in one embodiment according to the present invention. For example, the meaning of each word specified is the same to the computer program as it is to the knowledge workers. For example, a context-record with the referents {John, 2007:12:03:10:56:26, New York Office, 2008 Projections, etc.} could represent that a person named John made a change or communication related to the “2008 Projections” on December 12 at 10:56 and 26 seconds.

As an example of the potential effectiveness of the contextual retrieval used in a search, a group of IR researchers extracted words similar to subset of wh-word referents from web documents and then used these words to search web documents in the TREC database. This research was performed in a web search investigation in 2003. As described by researcher Yang: “We propose a novel way to investigate the QA problem and find the solution, which we called Event-based Question Answering. The world consists of two basic types of things: entities (‘anything having existence (living or nonliving)’) and events (‘something that happens at a given place and time’) and people often ask questions about them. If we apply this taxonomy to TREC-style QA task, questions can be considered as ‘enquiries about either entities or events’.” [Yang et al, 2003:82] The results of searches using this technique significantly outperformed searches of document collections searched by the Google search engine: “The Simple Web-based query formulation (method b) improves the baseline performance by 25.1% in Precision and 31.5% in CWS (Confidence Weighted Score) vs. Google on the TREC database.” [Yang, et al., 2003:82]

Summaries of electronic documents also can be automatically created and explicitly linked to the context network portion of the contextual knowledgebase to provide a look-ahead function for the knowledge worker's information search in one embodiment according to the present invention. Summaries of electronic documents content can be created using several methods current in the art, including but not limited to fractal summarization (see [Yang and Wang, 2003:79]) in one embodiment according to the present invention.

In one embodiment according to the present invention, knowledge workers can also add their own additional annotations and notes to the electronic document summaries, or add annotations that are separately associated with the electronic documents, either of which then can be explicitly linked to the context-network. The annotations can be made public or private by the knowledge worker.

Searches performed by the Contextual Search Engine can be expanded from the directly linked context-network by using extended explicit linking from the context-network portion of the contextual knowledgebase to data in other data stores in one embodiment according to the present invention. By linking this extended data into the context-network, the contextual knowledgebase is expanded with data that forms additional direct and relevant associations that describes entities, activities, and information be further explored or searched using the Contextual Search Engine and other knowledge representation or exploration tools in one embodiment according to the present invention. See FIGS. 24, 25, 26, 27 and 28.

The Contextual Search Engine can be further expanded to include derived links that are created within an automatically extracted and populated “knowledgebase-ontology” which is constructed from component level ontologies in one embodiment according to the present invention. The purpose of the component level ontologies is to provide the necessary data and meta-data to form a unitary and hierarchical semantic network, the knowledgebase-ontology, which is grounded, includes context, and represents the dynamical semantics of the entire semantic virtual community.

The knowledgebase-ontology is made automatically, or autonomously, in one embodiment according to the present invention. Automatic organization of the knowledgebase-ontology helps keep the semantic representations in the knowledgebase-ontology current and useful as information and knowledge changes and increases within a semantic virtual community. As described by Taylor, et al. in 2007: “Rather than relying on human knowledge engineers to carefully classify knowledge, it is becoming increasingly important for machine learning techniques to automate such a task. Automation is particularly important as the rate of ontology building via automatic knowledge acquisition techniques increases.” [Taylor, et al., 2007:72]

There are three component level ontologies which provide the basis for a hierarchical and unified semantic ontology for the semantic virtual community in one embodiment according to the present invention. Each component level contributes complementary and reinforcing information about the semantics of the semantic virtual community in one embodiment according to the present invention. The three component level ontologies are first, the “context-ontology,” second, the “communication ontology,” and third, the “information-ontology.” Each ontology represents data, meta-data, and unique attributes of the data and meta-data from the three main components; iControl, iBox, and iFolio in one embodiment according to the present invention.

The ontologies in the semantic virtual community may be stored in standard formats such as OWL, DAML, or RDF, or in proprietary formats in one embodiment according to the present invention.

Each of these component level ontologies are combined to form the unified, hierarchical knowledgebase-ontology in one embodiment according to the present invention. The knowledgebase-ontology is a context based, grounded, and multidimensional dynamical semantic network that can be used by the knowledge workers through the Contextual Search Engine, Knowledge Representation tools and cognitive user interface programming in one embodiment according to the present invention.

The first step to organize the knowledgebase-ontology in one embodiment according to the present invention is to make a context-ontology from the context-network to serve as a foundation and bootstrap ontology in one embodiment according to the present invention. The context-ontology is created by translating the context-network into an upper level ontology or taxonomy. The context-ontology is then used to bootstrap the communication-ontology and the information-ontology with grounded word definitions, context descriptions and context frames, and dynamical measurements of word use. This method eliminates the need for statistical pattern based extractions that are used for grounding in some automatic extraction methods which may be error prone as described by Gliozzo in 2007: “In most natural language processing applications such as learning ontologies, these relations are found in the text themselves by pattern-based approaches, yet these methods suffer from a number of limitations due to the natural complexity of language.” [Gliozzo, 2007:93]

Using the context-ontology to bootstrap the organization of the unified knowledgebase-ontology can preserve important dynamical and complex dimensions of the language used in the semantic virtual community in one embodiment according to the present invention. The context-ontology provide three significant attributes to the knowledgebase-ontology that can contribute to a definite description and measurement of semantic complexity in one embodiment according to the present invention. One, the context-ontology contains context-records which describe contexts which can be associated and inform semantic information in the knowledgebase-ontology. Two, in the context-ontology in one embodiment according to the present invention, the words used to describe context already have defined meanings because the knowledge workers have directly entered these words into the data structures in the semantic virtual community, or these words are recognized facts generated by the semantic virtual community such as date and time. Three, because the context-ontology is made from the context-network, it retains the dynamic sequential time measurement and order of the use of context words and context-metadata in one embodiment according to the present invention. These dynamic measurements can exhibit emergent properties and patterns which can be used to inform the derivation of the communication-ontology, the information ontology, and therefore the knowledgebase-ontology in one embodiment according to the present invention.

Using object symbols:

Knowledgebase-ontology=context-ontology->communication/activity-ontology->information-ontology.{grounded->dynamical->abstract}

The second step to organize the knowledgebase-ontology in one embodiment according to the present invention is to organize a communication-ontology. The communication-ontology is derived using context frames from the context-network, the message subject, message thread titles, and textual content of the messages in a hierarchical order, and by adapting explicit meanings for words that are contained and defined in the context-ontology. Conceptually, the communication-ontology is then merged back into the context-ontology so that the semantics of words used in communications can be situated in the context of the actual knowledge worker actions that produced the communications in one embodiment according to the present invention.

This process preserves the order and the patterns of word use in context and communications in one embodiment according to the present invention. In 2005, Styevers and Tenebaum experimentally verified that order (and therefore pattern) of word use are important in determining characteristics of a semantic network: “that the order in which words enter the network is crucial to determining their connectivity” in the semantic network. [Steyvers and Tenenbaum, 2005:101] The patterns of word use in the text of the communications may follow a nonlinear dynamic pattern, so dynamical analysis can be applied to find hidden dynamical patterns within word use in the communication text in one embodiment according to the present invention.

After the context-ontology and the communication-ontology have been combined, the resulting combined ontology is grounded by named entities, is-a relationships, facts, and dynamics from the context-ontology in one embodiment according to the present invention. The semantics of the words represented in the communication-ontology are grounded by co-occurring defined words in the context-ontology, and the dynamical pattern of word use in the communication directly represented by the temporal dynamics of word use in the context-ontology in one embodiment according to the present invention.

The third step to organize the knowledgebase-ontology in one embodiment according to the present invention is that the information-ontology is extracted and then added to the already combined context-ontology and the communication-ontology in the one embodiment of the current invention. The information-ontology inherits grounding by the definition of co-occurring words from the context-ontology as well as dynamics from the context-ontology in one embodiment according to the present invention. The information-ontology also inherits dynamical and contextual sequence patterns for words that co-occur in the communication-ontology in one embodiment according to the present invention.

Further organization of the information-ontology is achieved by using iFolio topic names to inform semantic characteristics of co-occurring words in the information-records in one embodiment according to the present invention. Information records can also be related by semantic association of topics in one embodiment according to the present invention. Further, remaining words within the information-records can be related to already defined words using any appropriate document semantic or knowledge extraction technique, including but not limited to any combination of techniques described in FIGS. 29 and 30, or automatic document knowledge or semantic extraction method to be developed. In current art there is no standard way to computing semantic relationships. As described by Wuch: “Modern pattern recognition textbooks [63, 174, 164] start from the Bayesian probabilistic foundations that may be used to justify both discriminate as well as the nearest neighbor type of learning methods. Supervised and unsupervised pre-processing techniques, classification, rule extraction, approximation and data modeling methods, cost functions and adaptive parameter optimization algorithms are used as components that may be combined in thousands of ways to create adaptive systems.” [Duch, 2007:104]

One embodiment according to the present invention makes many such existing techniques more effective because these methods can be seeded and executed with grounded context, contextual frames, and dynamical patterns and measurements taken into consideration, replacing the need for many ad hoc assumptions and tweaking parameter. The possible need for including context and dynamics in a natural language semantic knowledge and ontology extraction system is described by Mika in 2005: “As the original community evolves through members leaving and entering or their commitments changing, a new consensus may shape up in validating the knowledge codified in the ontology. To address the problem of ontology drift, several authors have suggested emergent semantics as a solution. The expectation is that the individual interactions of a large number of rational agents would lead to global effects that could be observed as semantics. Ontologies would thus become an emergent effect of the system as opposed to be a fixed, limited contract of the majority.” [Mika, 2005:50]

Semantic nets and spaces, and hyperspaces are used to represent changes in semantics in one embodiment according to the present invention. In one embodiment according to the present invention, semantic variations and relationships in the semantic virtual community are measured. Such measurements made systematically according to a specific Context-Model are likely to be more complete and more accurate than can be produced by a human expert knowledge engineer or produced using a folksonomy or by individual knowledge workers.

The dynamics of the context-ontology can be factored into the community-ontology for additional insights into emerging and shifting semantic patterns in one embodiment according to the present invention. Because large portions of these ontologies are the result of direct observation, differentials and other physics based analytical methods can be used to determine other extralinguistics properties, such as drift, attraction, force, trajectories, of the words (and their component phonemes and morphemes), symbols, concepts, facts, and organizational properties.

The semantic structures can be used for fractal and topological analysis to reveal aspects of the semantic virtual community's information inventory, which are not accessible or visible through other analytical methods. These semantic structures can also be used to introduce changes in semantic priming the context-ontology, communication-ontology, information-ontology, and resulting knowledgebase-ontology in one embodiment according to the present invention. The resulting knowledgebase-ontology semantically relates all data elements to every other data element in the semantic virtual community in one embodiment according to the present invention.

In one embodiment according to the present invention, the second group of subcomponents of the iFind main component are Knowledge Representations. The Knowledge Representations in one embodiment according to the present invention display the information in the contextual knowledgebase and the knowledgebase-ontology in various 2-dimensional (2D) and 3-dimensional (3D) visual presentations using various visuospatial presentation techniques.

Visual knowledge representation systems are needed for managing search through large amounts of unstructured and semi-structured data and documents as described by Miller et al. “Information visualization systems can enable users to quickly determine the general subject areas of hundreds to millions of documents. Users are then tasked with identifying which of these documents should be examined in greater detail. This kind of information analysis problem, which increasingly occurs, is not directly addressed by a system that retrieves relevant documents based on user-defined queries. Our approach is to create visualizations of document collections to help the user understand the collection as a whole, discover important hidden relationships, and formulate insights with a minimum of reading. One difficulty that we face is that the performance of these visualizations is not easily assessed using current information retrieval metrics.” [Miller, et al., 1997:53]

Visuospatial reasoning is basic to human cognition and reasoning. There is evidence that visuospatial reasoning is acquired early in human development. From Tversky, “ . . . People begin to acquire knowledge about space and the things in it probably before they enter the world. Indeed, spatial knowledge is critical to survival and spatial inference critical to effective survival. Perhaps because of the (literal) ubiquity of spatial reasoning, perhaps because of the naturalness of mapping abstract elements and relations to spatial ones, spatial reasoning serves as a basis for abstract knowledge and inference . . . ” [Tversky, 2005:75]

Visuospatial reasoning theory describes the cognitive processes that many animals, including humans, use to find places and information, and may also use to understand complex abstract relationships and associations in both physical and virtual environments. Consistent with this theory, there is scientific support that human memory processes for finding information in the “virtual” world are similar to the processes to the human brain uses to remember and find “places” in the real world. Therefore relative distances, orientations, sizes, and positions of information in the semantic virtual community are important for cognitive alignment between knowledge workers, and between an individual knowledge worker and the semantic virtual community.

Support for visuospatial reasoning can be found in the newer 3D user interfaces on some Personal Computers. These interfaces allow arrangements of searches that have been performed using typical search techniques, as well as new 3D arrangements of items on the user's monitor screen, many times referred to as a “desktop.”

Some of the most successful use of visuospatial techniques in human computer interaction (HCI) are 3D multiplayer games. As of this writing, there are an estimated 60 million gamers that play internet interactive games on a regular basis. In fact, a significant amount of internet traffic is from the gamer's digital interactions. Further, garners are able to enter their game environment, cooperate or compete with one another, and accomplish goals set in the games, quite intuitively—in other words—with cognitive alignment between a team of players within a 3D virtual world.

According to some visuospatial reasoning theories, in a 2D or 3D visual or abstract space, objects that are close together in space are perceived as also being close together in meaning, or close together conceptually. The relative sizes of the spatial representations of concepts can indicate relative importance of these concepts. Also, the relative directions of up, down, in front of, in back of, also have a universal relationship with cognitive reasoning about the relative relationships of concepts according to visuospatial reasoning theories.

Theories of visuospatiation describe two basic perspectives of visuospatiation used by most people. In one embodiment according to the present invention, these two perspectives can be interpreted into many representational forms to display and represent information to the knowledge worker. Tversky describes these two basic perspectives as “survey” or “route” perspective. The “route” perspective is similar to “a list of directions” to locate a place. In “survey” perspective, the thinking process creates a map-like conceptualization, where people take a “birds-eye” view of a real or virtual space. [Tversky, 2005:75]

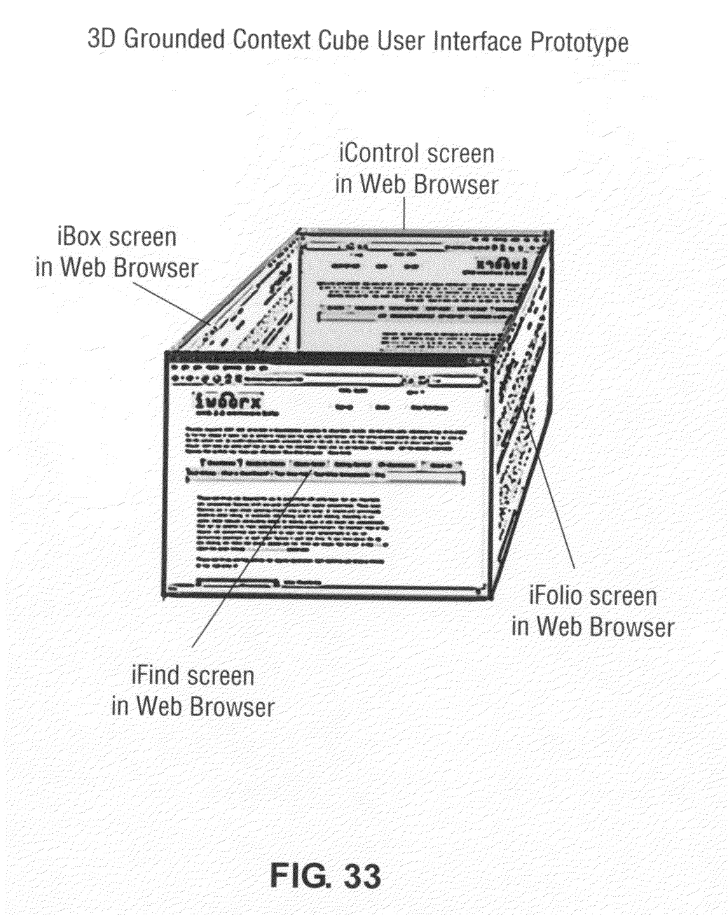

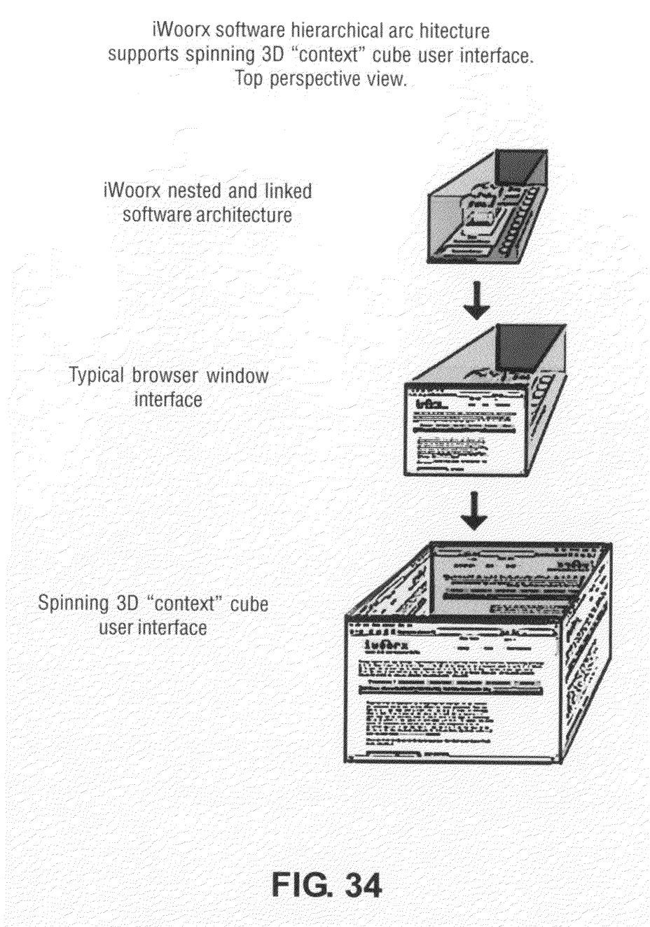

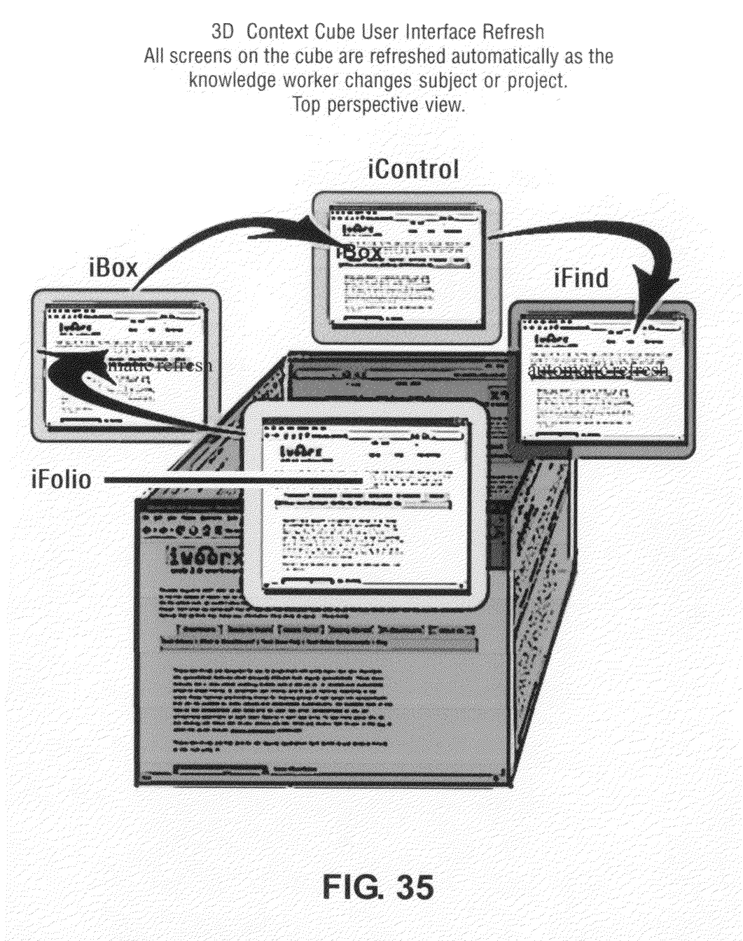

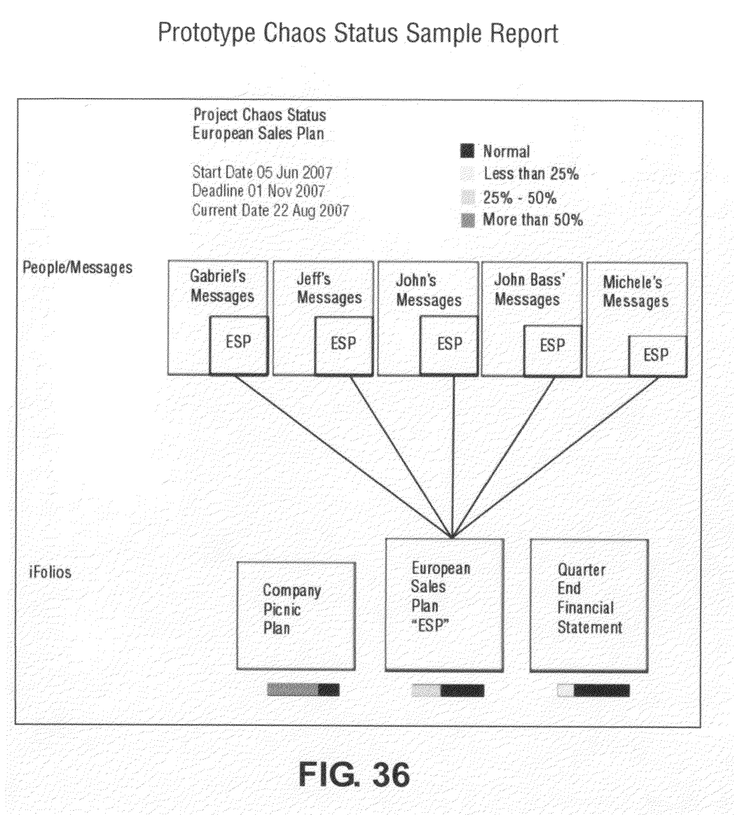

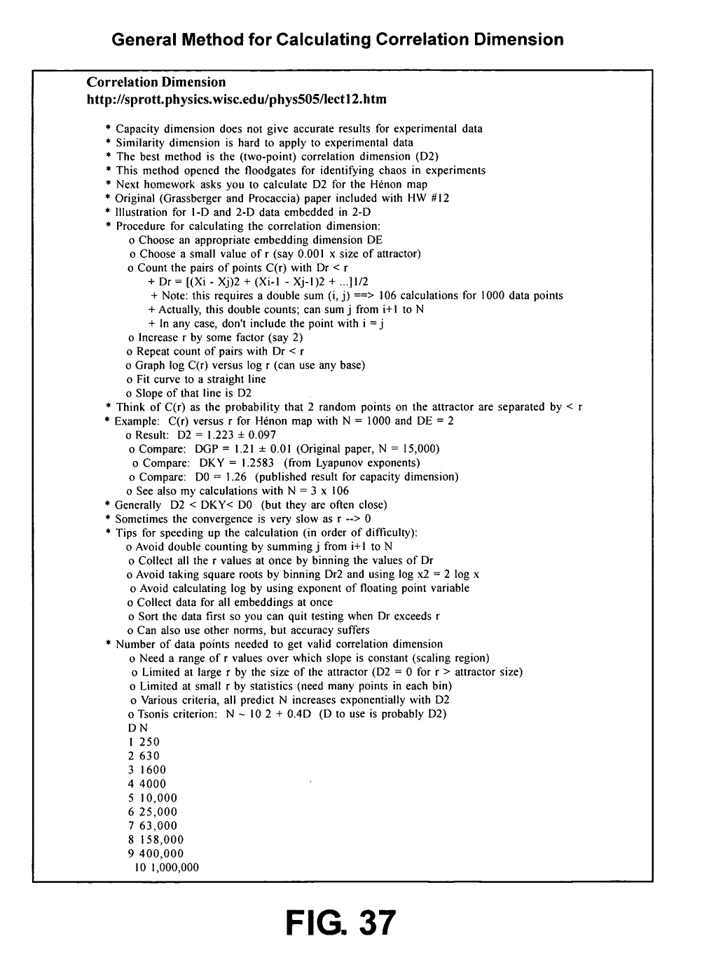

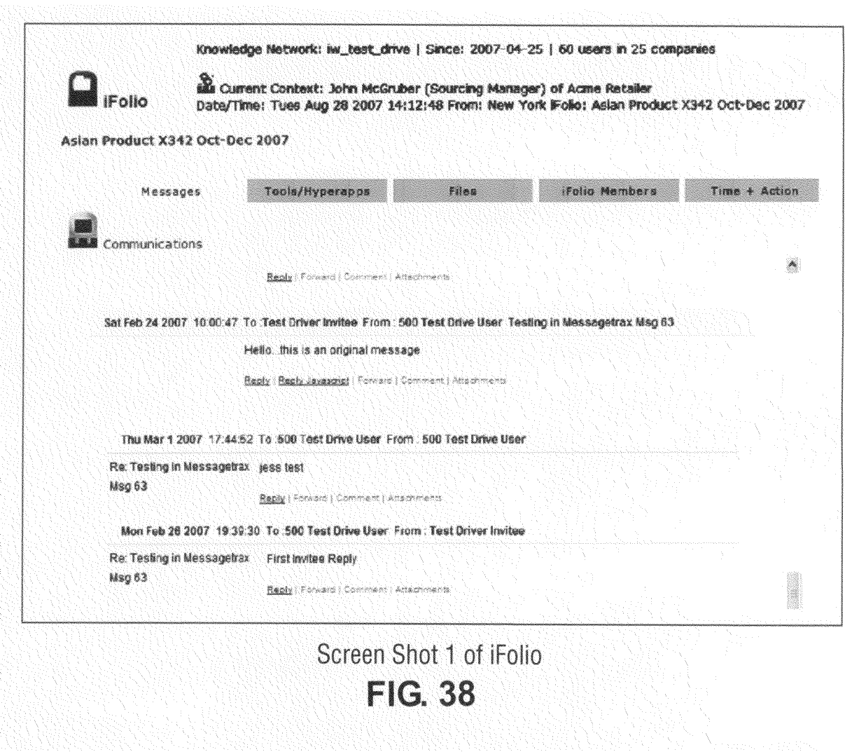

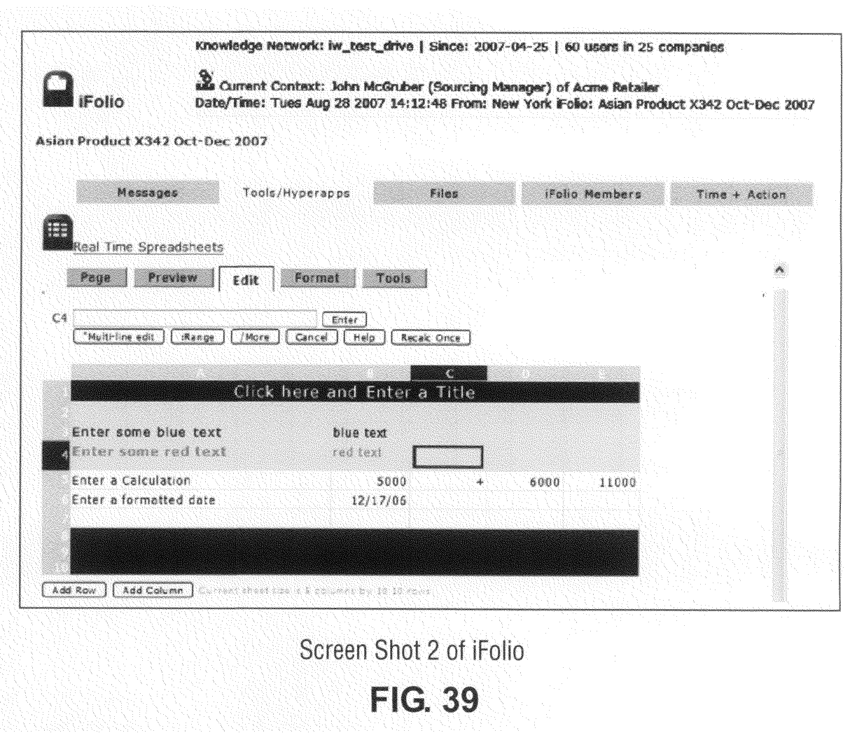

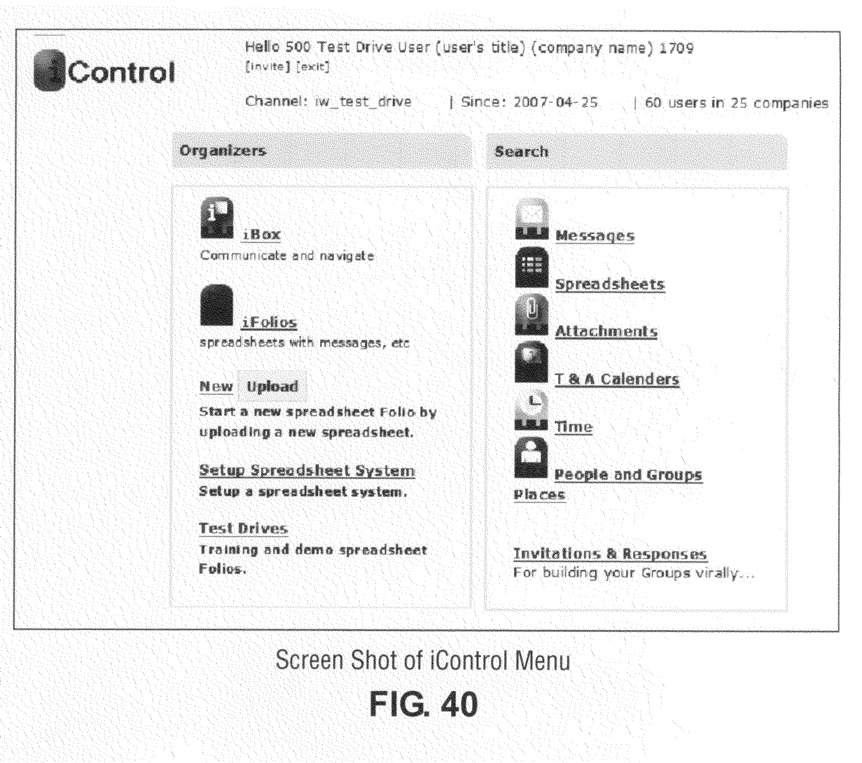

In embodiments according to the present invention, knowledge workers are provided with knowledge exploration display interfaces by the Knowledge Representation subcomponent. This subcomponent produces various computational spatial projections of the contextual knowledgebase or sections of the contextual knowledgebase. The resulting visuospatial knowledge representations help the knowledge workers understand both the knowledge and the dynamics of the semantic virtual community. See FIGS. 33, 34 and 35. In embodiments according to the present invention, knowledge representations can also contribute to distributed cognition in the semantic virtual community.

According to Montello: “Commonly, semantic similarity is mapped metaphorically onto distance (relative location) in the graphic information space, usually metric distance of the straight-line or direct Euclidean type. The widespread and uncritical application of this metaphor may be problematic when information spaces resemble geographic spaces, such as landscapes [14], natural terrain [15], or urban spaces [16]. Geometry in geographic space is not just Euclidean, and in fact, it is not just metric. In other words, similarity can be graphically suggested in terms of several types of ‘distance,’ especially when distance is understood broadly to include a variety of expressions of separation (temporal, topological, etc.). Information spaces will be more usable if they are based on a sound theoretical and empirical framework, including those concerning cognitive aspects of space and place.” [Montello, 2003:54]

“The majority of spatialization examples rely on a narrow subset of formal, and typically Euclidean, spatial properties where the locations are nothing more than points in space and the distances between items are limited to straight lines. Geographic space is more than just Euclidean geometry. Entities and their relationships in space carry experiential and socially constructed meanings. Usable information spaces need sound semantic abstraction frameworks. Sound semiotic practices must complement these semantic abstractions. Current information space depictions also lack coherent representational frameworks easily provided by cartographic design principles.” [Fabricant, 2001:19]

“Computational methods for creating semantic information spaces involve a two-step transformation process. First, a mathematical transformation creates a logically defined coordinate system to rearrange a set of data items based on their content and functional relationships (Fabrikant and Buttenfield, 2001). Most mathematical procedures to generate information spaces are a combination of vector space modeling techniques (Salton, 1989) coupled with a variant of ordination such as multidimensional scaling (MDS). Vector space modeling is often the method of choice for semantic generalization to condense a database into a semantic proximity matrix typically characterized by word co-occurrences. Second, the spatiated transformation is graphically represented for subsequent data exploration and knowledge extraction. A proximity matrix is then subjected to an ordination technique for visualization. A major drawback of ordination is that all semantic (intrinsic) properties of data objects are collapsed into the extrinsic property of spatial proximity, usually based on Euclidean distance. Topology (functional distance) and multiple levels of detail (hierarchy, functional regions) that are important aspects of the experiential world are not preserved. Visual exploration of the information space at different levels of granularity is therefore hindered.” [Fabricant, 2001:19]

Semantic subspaces based on subspaces of the context network can be made as needed as well. For example, . . . . ] To build the 2D and 3D knowledge representation displays, one embodiment according to the present invention uses the semantic networks and semantic spaces, which is a multidimensional semantic network space and maps the multidimensional space into a 2D or 3D representation to be displayed on the user's computer using dimensional reduction. In one embodiment according to the present invention, dimensional reduction is performed by an AI (Artificial Intelligence) technique referred to as “Self Organizing Maps” by Kohonen [Kohonen, 2000:36]. Topological info displays are common, but using fractal geometry to may describe them more understandably to the average knowledge worker.

Fractal views, based on Mandelbrot's fractal theory (1988), were first applied to the design of information displays by Hideki Koike (1993). They can be utilized to abstract displayed objects and to control the amount of displayed information based on semantic relevance by removing less important information automatically. The fractal dimension, a measure of complexity, is used to control the total number of displayed nodes. Fractal Views have been applied to visualize huge hierarchies (Koike & Yoshihara, 1993) and to control the amount of information displayed in ET-Maps [Yang et al., 2003:46.]

In embodiments according to the present invention knowledgebase representations can take several forms including but not limited to 3D Landscapes, 2D Animation, Topic Maps, Tag Clouds, Self-Organizing Maps (SOMS), Fractals, Multiway Directory Systems, Social Relationship Analysis, Cluster Analysis, Associative Directories, Entity-Relationship Maps, and Space/Time explorative interfaces.

### BRIEF DESCRIPTION OF DRAWINGS AND EXHIBITS

1 Knowledge Worker, PC Era Applications, and Context
2 Knowledge Worker, the Invention, and Context
3 Nested Hierarchy Architecture 3D Diagram
4 iControl Context Manager Architecture 3D Diagram
5 iBox Communication Manager Architecture 3D Diagram
6 iFolio Communication Manager Architecture 3D Diagram
7 iFind Retrieval Manager Architecture 3D Diagram
8 Screen Shot iWoorx Sign in Web Page
9 Community Manager User and Group Hierarchy
10 Screen Shot of Community Manager of User Invitation Form
11 Screen Shot of User Invitation Confirmation
12 Screen Shot of iWoorx invitation in User's Email Message
13 Context Model Overview
14 Context Model Diagram
15 wh-word Indexes Conceptual Diagram
16 Context Indexes Conceptual Diagram
17 Context Index Linkage to wh-word Indexes
18 Context Index form Semantic Process Network
19 Screen Shot of Context Index Report
20 Screen Shot of Test Data Fractal Sequence
21 iFolio Screen Shot
22 iFind Contextual Search Process Overview
23 Fractal Sequence Definition
24 Context Record Linkage
25 Example Context Index Records for Five (5) Events
26 Single Context Record with Extended Explicit Links
27 Example Context Record Index with Extended Explicit Links
28 Abbreviated Euclidean* Model of Linked Knowledgebase Structure
29 Pattern and Knowledge Extraction Methods, Part 1
30 Pattern and Knowledge Extraction Methods, Part 2
31 Statistically generated Virtual Landscape vs Fractully Generated Virtual Landscape
32 Contextual Search Engine Partial Screen Shots
33 3D Grounded Context Cube User Interface Prototype
34 Hierarchical Architecture Supports Spinning 3D Context Cube
35 3D Context Cube User Interface Refresh
36 Prototype Chaos Status Sample Report
37 General Method for Calculating Correlation Dimension
38 Screen Shot 1 of iFolio
39 Screen Shot 2 of iFolio
40 Screen Shot of iControl Menu

The invention claimed is:

1. A method for creation of a semantic information management environment, said method comprised of steps of: providing said semantic information management environment consisting of an architecture partitioned according to classification by information scale, dynamic properties, natural language, or semantic classifications; detection and storage of semantic and contextual information; said semantic and contextual information detected and stored by observation of events in said semantic information management environment; said interactions including use of information management applications embedded or linked to said architecture or separate from said architecture; said observations including the use of natural language parameters that have specific semantic properties; detection and storage of use of natural language in said semantic information management environment; representation of semantic processes containing said detected and stored contextual information and natural language use in said semantic information management environment; said representations of semantic processes used to link and associate natural language use with objects, entities, events, and facts in said semantic information management environment; providing said users of said semantic information management environment with information and knowledge management tools, reports, representations, and interfaces that utilize said semantic process representations.

2. A method as in claim 1, wherein said semantic information management environment is in the form of semantic virtual community.

3. A method as in claim 1, wherein said semantic information management environment is in the form of semantic information search engine.

4. A method as in claim 1, wherein said semantic information management environment is in the form of a contextual electronic communication and information mapping and analysis tool.

5. A method as in claim 1, wherein said semantic information management environment is in the form of a natural language electronic communication and information mapping and analysis tool.

6. A system for carrying out any of the methods of claim 1, 2, 3, 4 or 5.

7. A computer program product embodied in computer executable code on a computer-readable media for carrying out any of the methods of claim 1, 2, 3, 4 or 5.
